(19) United States
(12) Patent Application Publication
(10) Pub. No.: US 2024/0405308 A1
(43) Pub. Date: Dec. 5, 2024

(54) POWER STORAGE DEVICE AND VEHICLE

(71) Applicant: SEMICONDUCTOR ENERGY LABORATORY CO., LTD., Atsugi-shi, Kanagawa-ken (JP)

(72) Inventors: Yohei MOMMA, Isehara, Kanagawa (JP); Tetsuya KAKEHATA, Isehara, Kanagawa (JP); Tetsuji ISHITANI, Atsugi, Kanagawa (JP); Yuji IWAKI, Isehara, Kanagawa (JP); Ryota TAJIMA, Isehara, Kanagawa (JP); Shuhei YOSHITOMI, Ayase, Kanagawa (JP)

(21) Appl. No.: 18/695,496

(22) PCT Filed: Sep. 20, 2022
(86) PCT No.: PCT/IB2022/058853

§ 371 Date: Mar. 26, 2024

(30) Foreign Application Priority Data
Oct. 1, 2021 (JP) 2021-162880

(51) Int. Cl. H01M 10/615; B60L 58/27; H01M 10/44; H01M 10/48; H01M 10/625; H01M 10/63; H01M 10/653; H01M 50/136; H01M 50/213

(52) U.S. Cl. CPC H01M 10/615; B60L 58/27; H01M 10/443; H01M 10/486; H01M 10/625; H01M 10/63; H01M 10/653; H01M 50/136; H01M 50/213

(57) ABSTRACT

A power storage device that is less likely to be influenced by an ambient temperature is provided. The power storage device capable of being charged and discharged even in a low-temperature environment is provided. A first secondary battery capable of being charged and discharged even at low temperatures and a general second secondary battery are adjacent to each other in the power storage device. The power storage device having such a structure can use, as an internal heat source in a low-temperature environment, heat generated by charge and discharge of the secondary battery capable of being charged and discharged even at low temperatures. Specifically, the power storage device includes the first secondary battery and the second secondary battery adjacent to each other, the first secondary battery has flexibility, and a value of discharge capacity in discharge at −40° C. is higher than or equal to 50% of a value of discharge capacity in discharge at 25° C.

### TECHNICAL FIELD

One embodiment of the present invention relates to a power storage device and a fabrication method thereof. Alternatively, one embodiment of the present invention relates to a vehicle or the like including a power storage device.

One embodiment of the present invention relates to an object, a method, or a manufacturing method. Alternatively, the present invention relates to a process, a machine, manufacture, or a composition of matter. One embodiment of the present invention relates to a semiconductor device, a display device, a light-emitting device, a power storage device, a lighting device, an electronic device, or a manufacturing method thereof.

Note that an electronic device in this specification means all devices including power storage devices, and electro-optical devices including power storage devices, information terminal devices including power storage devices, and the like are all electronic devices.

Note that in this specification, a power storage device refers to all elements and devices each having a function of storing power. For example, a power storage device (also referred to as a secondary battery) such as a lithium-ion secondary battery, a lithium-ion capacitor, and an electric double layer capacitor are included.

### BACKGROUND ART

In recent years, a variety of power storage devices such as lithium-ion secondary batteries, lithium-ion capacitors, and air batteries have been actively developed. In particular, demands for lithium-ion secondary batteries with high output and high energy density have rapidly grown with the development of the semiconductor industry, for portable information terminals such as mobile phones, smartphones, and laptop computers, portable music players, digital cameras, medical equipment, next-generation clean energy vehicles such as hybrid electric vehicles (HVs), electric vehicles (EVs), and plug-in hybrid electric vehicles (PHVs), and the like, and the lithium-ion secondary batteries are essential as rechargeable energy supply sources for today's information society.

However, a general lithium-ion secondary battery has a problem in charge and discharge at low temperatures or high temperatures. At low temperatures especially below freezing, the viscosity of an organic solvent contained in a secondary battery increases, which makes it difficult to obtain good charge and discharge characteristics. However, a secondary battery is desired to exhibit stable performance regardless of the environment, and thus a heater has been provided around the secondary battery as a countermeasure (e.g., Patent Document 1).

### REFERENCE

### Patent Document

[Patent Document 1] Japanese Published Patent Application No. H08-138762

### SUMMARY OF THE INVENTION

### Problems to be Solved by the Invention

Providing an external heat source such as a heater increases the cost and the risk of malfunction. In view of this, an object of the present invention is to provide a power storage device that exhibits stable performance regardless of the environment by controlling the temperature of a secondary battery without an external heat source such as a heater. Another object is to provide a highly safe power storage device.

Another object of one embodiment of the present invention is to provide a fabricating method thereof.

Note that the description of these objects does not preclude the existence of other objects. One embodiment of the present invention does not have to achieve all of these objects. Other objects can be derived from the description of the specification, the drawings, and the claims.

### Means for Solving the Problems

To solve the above problems, in the power storage device of one embodiment of the present invention, a secondary battery capable of being charged and discharged even at low temperatures is provided adjacent to a general secondary battery. The power storage device having such a structure can use, as an internal heat source in a low temperature environment, heat generated by charge and discharge of the secondary battery capable of being charged and discharged even at low temperatures.

Here, the secondary battery capable of being charged even at low temperatures preferably has flexibility. When the secondary battery capable of being charged even at low temperatures has flexibility, the secondary battery is easily combined with a general secondary battery having any of a variety of shapes.

For the flexible secondary battery, an embossed exterior body can be used. The secondary battery including the embossed exterior body can include a space therein. In the case where the secondary battery capable of being charged even at low temperatures includes the space therein, heat generated by discharge is easily retained. Therefore, in the case where the secondary battery capable of being charged and discharged even at low temperatures and a general secondary battery are adjacent to each other, the secondary battery capable of being charged and discharged even at low temperatures preferably includes a large space therein on the side opposite to the side in contact with the general secondary battery.

One embodiment of the present invention is a power storage device including a first secondary battery and a second secondary battery; the first secondary battery is used in a first temperature range; the second secondary battery is used in a second temperature range; a lower limit of the first temperature range is lower than a lower limit of the second temperature range; an upper limit of the first temperature range is higher than the lower limit of the second temperature range; an upper limit of the second temperature range is higher than the upper limit of the first temperature range; the first temperature range and the second temperature range each include 25° C.; and a value of discharge capacity when the first secondary battery is discharged at the lower limit of the first temperature range is higher than or equal to 50% of a value of discharge capacity when the first secondary battery is discharged at 25° C.

The power storage device of one embodiment of the present invention further includes a temperature sensor and a control circuit; the temperature sensor has a function of detecting a temperature of the second secondary battery; and the control circuit has a function of setting the temperature of the second secondary battery within the second temperature range by heat generated by the first secondary battery in the case where a temperature detected by the temperature sensor is lower than the second temperature range.

The power storage device of one embodiment of the present invention preferably has a function of preheating the second secondary battery by the first secondary battery, and the second secondary battery preferably has a function of starting discharge to an outside after the temperature of the second secondary battery is set within the second temperature range.

In the power storage device of one embodiment of the present invention, the lower limit of the first temperature range can be lower than or equal to −20° C.

In the power storage device of one embodiment of the present invention, the first secondary battery preferably has flexibility.

In the power storage device of one embodiment of the present invention, it is preferable that the first secondary battery include a stack and an exterior body, and the exterior body have a film-like shape, be folded in half so as to sandwich the stack, and include a plane in contact with the stack and a plane in contact with the second secondary battery.

In the power storage device of one embodiment of the present invention, the second secondary battery can be a cylindrical secondary battery or an angular secondary battery.

In the power storage device described in any of the above, the number of the first secondary batteries is smaller than the number of the second secondary batteries.

In the power storage device of one embodiment of the present invention, it is preferable that the first secondary battery include a stack and an exterior body, and the exterior body have a film-like shape, be folded in half so as to sandwich the stack, and include a plane in contact with the stack and a plane in contact with the second secondary battery.

In the power storage device described in any of the above, a thermal conductive material is preferably contained between the first secondary battery and the second secondary battery.

Another embodiment of the present invention is a vehicle including the power storage device described in any of the above.

### Effect of the Invention

According to one embodiment of the present invention, a power storage device that exhibits stable performance regardless of the environment by controlling the temperature of a secondary battery without an external heat source can be provided. A power storage device with a lower cost can be provided. A power storage device with a lower risk of malfunction can be provided. In addition, a highly safe power storage device can be provided.

According to one embodiment of the present invention, a fabricating method thereof can be provided.

Note that the description of these effects does not preclude the existence of other effects. One embodiment of the present invention does not need to have all of these effects. Other effects will be apparent from the description of the specification, the drawings, the claims, and the like, and other effects can be derived from the description of the specification, the drawings, the claims, and the like.

### BRIEF DESCRIPTION OF THE DRAWINGS

FIG. 1A to FIG. 1F are diagrams illustrating a power storage device.

FIG. 2A to FIG. 2D are diagrams illustrating a power storage device.

FIG. 3A to FIG. 3C are diagrams illustrating a power storage device.

FIG. 4A to FIG. 4C are diagrams illustrating a power storage device.

FIG. 5A to FIG. 5D are diagrams showing a method for forming a positive electrode active material.

FIG. 6 is a diagram showing a method for forming a positive electrode active material.

FIG. 7A to FIG. 7C are diagrams showing a method for forming a positive electrode active material.

FIG. 8A to FIG. 8D are cross-sectional views illustrating examples of a positive electrode of a secondary battery.

FIG. 9A is a cross-sectional view of a positive electrode active material, and FIG. 9B1 to FIG. 9C2 are cross-sectional views of part of the positive electrode active material.

FIG. 10 is a diagram showing crystal structures of a positive electrode active material.

FIG. 11 is a diagram showing crystal structures of a conventional positive electrode active material.

FIG. 12 is a diagram showing XRD patterns calculated from crystal structures.

FIG. 13 is a diagram showing XRD patterns calculated from crystal structures.

FIG. 14A to FIG. 14C are diagrams showing a method for forming a positive electrode active material.

FIG. 15A is an exploded perspective view of a coin-type secondary battery, FIG. 15B is a perspective view of the coin-type secondary battery, and FIG. 15C is a cross-sectional perspective view thereof.

FIG. 16A illustrates an example of a cylindrical secondary battery. FIG. 16B illustrates the example of the cylindrical secondary battery.

FIG. 17A and FIG. 17B are diagrams illustrating examples of a secondary battery, and FIG. 17C is a diagram illustrating the internal state of the secondary battery.

FIG. 18A to FIG. 18C are diagrams illustrating an example of a secondary battery.

FIG. 19A and FIG. 19B are external views of a secondary battery.

FIG. 20A to FIG. 20C are diagrams illustrating a method for fabricating a secondary battery.

FIG. 21A to FIG. 21E are diagrams illustrating a structure example of a bendable secondary battery.

FIG. 22A to FIG. 22C are a structure example and a model diagram at the time of bending a secondary battery.

FIG. 23A and FIG. 23B are diagrams illustrating a method for fabricating a secondary battery.

FIG. 24A to FIG. 24E are diagrams illustrating a method for fabricating a secondary battery.

FIG. 25A to FIG. 25E are diagrams illustrating a method for fabricating a secondary battery.

FIG. 26A to FIG. 26F are diagrams illustrating a method for fabricating a secondary battery.

FIG. 27 is a diagram illustrating a structure example of a secondary battery.

FIG. 28 is a diagram illustrating a method for processing a film.

FIG. 29A to FIG. 29E are diagrams illustrating a method for processing a film.

FIG. 30A and FIG. 30B are diagrams illustrating a method for processing a film.

FIG. 31A to FIG. 31C are diagrams illustrating a method for processing a film.

FIG. 32A to FIG. 32E are top views, a cross-sectional view, and a schematic view illustrating one embodiment of the present invention.

FIG. 33A and FIG. 33B are cross-sectional views of a secondary battery of one embodiment of the present invention.

FIG. 34A to FIG. 34E are diagrams illustrating a method for fabricating a secondary battery.

FIG. 35A to FIG. 35E are diagrams illustrating a structure example of a secondary battery.

FIG. 36A to FIG. 36C are diagrams illustrating structure examples of a secondary battery.

FIG. 37A to FIG. 37C are diagrams illustrating structure examples of a secondary battery.

FIG. 38A to FIG. 38C are diagrams illustrating structure examples of a secondary battery.

FIG. 39A is a block diagram of a vehicle including a power storage device. FIG. 39B is a block diagram of a control circuit portion.

FIG. 40A is a diagram illustrating an example of an electric vehicle, FIG. 40B and FIG. 40C are diagrams illustrating examples of transport vehicles, and FIG. 40D is a diagram illustrating an example of an airplane. FIG. 40E is a diagram illustrating an example of an artificial satellite.

FIG. 41A is a diagram illustrating an example of a submarine. FIG. 41B is a diagram illustrating an example of an electronic device.

FIG. 42A is a diagram illustrating an example of a portable power storage device, FIG. 42B is a diagram illustrating an example of a stationary power storage device, and FIG. 42C is a diagram illustrating an example of a power storage device connected to a solar power generation device.

FIG. 43A and FIG. 43B are diagrams illustrating examples of a building provided with a power storage device.

### MODE FOR CARRYING OUT THE INVENTION

Embodiments of the present invention will be described in detail below with reference to the drawings. Note that the present invention is not limited to the following description, and it is readily understood by those skilled in the art that modes and details of the present invention can be modified in various ways. In addition, the present invention should not be construed as being limited to the description of the embodiments below.

### Embodiment 1

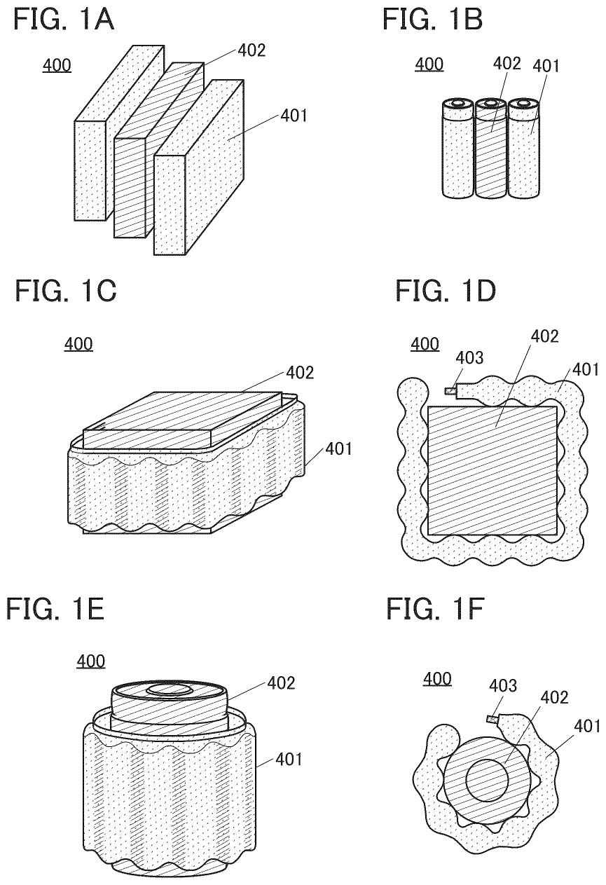

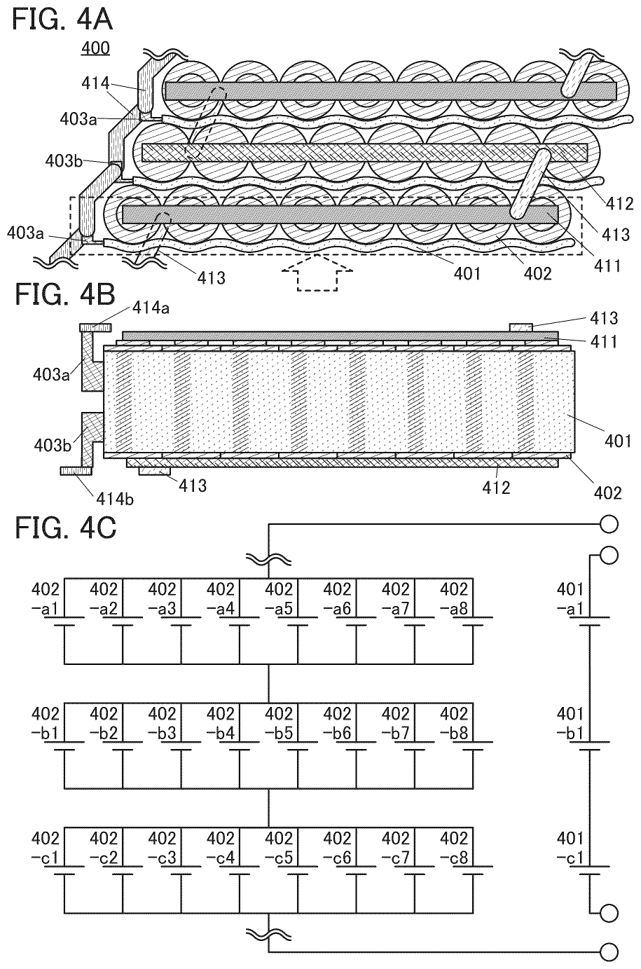

In this embodiment, an example of a power storage device of one embodiment of the present invention will be described with reference to FIG. 1 A to FIG. 4C.

FIG. 1A illustrates an example of a power storage device 400 of one embodiment of the present invention. The power storage device 400 includes a secondary battery 401 and a secondary battery 402 adjacent to each other. The secondary battery 401 and the secondary battery 402 is preferably in contact with each other.

The secondary battery 401 can be charged and discharged even at low temperatures.

The low temperature is, for example, lower than or equal to 0° C., preferably lower than or equal to −20° C., further preferably lower than or equal to −40° C. A secondary battery capable of being charged and discharged even at low temperatures is preferably a lithium ion battery with excellent charge and discharge characteristics at low temperatures (a favorable example will be shown in Embodiment 2). Alternatively, as the secondary battery 401, a sodium ion battery with excellent charge and discharge characteristics at low temperatures may be used.

Note that as the discharge characteristics of the secondary battery capable of being charged and discharged even at low temperatures, a value of the discharge capacity in the environment of lower than or equal to 0° C., preferably lower than or equal to −20° C., further preferably lower than or equal to −40° C. is preferably higher than or equal to 50%, further preferably higher than or equal to 60%, still further preferably higher than or equal to 70%, yet further preferably higher than or equal to 80%, yet still further preferably higher than or equal to 90%, yet still further preferably higher than or equal to 95% of a value of the discharge capacity in the environment of 25° C.

The secondary battery 402 has high charge and discharge characteristics and high cycle performance in a middle temperature range. The middle temperature range refers to, for example, higher than or equal to 0° C., and lower than or equal to 45° C., preferably higher than or equal to 0° C., and lower than or equal to 65° C., further preferably higher than or equal to 0° C., and lower than or equal to 85° C. A structure preferable for the secondary battery having high charge and discharge characteristics and high cycle performance in a middle temperature range will be described in Embodiment 3.

When the secondary battery 401 capable of being charged and discharged even at low temperatures and the secondary battery 402 having high charge and discharge characteristics and high cycle performance in a middle temperature range are combined, the secondary battery 402 can be heated using heat generated by charge and discharge of the secondary battery 401 as an internal heat source in a low temperature environment. When the secondary battery 402 is heated to reach or be close to a middle temperature range, high charge and discharge characteristics of the secondary battery 402 can be utilized.

The secondary battery 401 capable of being charged and discharged even at low temperatures is preferably a bendable secondary battery (also referred to as a flexible secondary battery). In the case where the secondary battery 401 capable of being charged and discharged even at low temperatures is a bendable battery, the area where the secondary battery 401 capable of being charged and discharged even at low temperatures is in contact with the secondary battery 402 having high charge and discharge characteristics and high cycle performance in a middle temperature range can be increased. Therefore, the secondary battery 402 can be effectively heated using heat generated by charge and discharge of the secondary battery 401 as an internal heat source in a low temperature environment. In the case where the secondary battery 401 capable of being charged and discharged even at low temperatures is a bendable battery, the layout flexibility of the secondary battery 401 capable of being charged and discharged even at low temperatures and the secondary battery 402 having high charge and discharge characteristics and high cycle performance in a middle temperature range can be increased. For example, the secondary battery 401 capable of being charged and discharged even at low temperatures is provided in a space (also referred to as a gap) generated when the secondary battery 402 having high charge and discharge characteristics and high cycle performance in a middle temperature range is provided, whereby a space where the secondary batteries are provided can be efficiently used. A structure preferable for the bendable battery will be described in Embodiment 5.

In this specification and the like, the expression “A and B are adjacent to each other” means that A and B are not necessarily in contact with each other but are at a distance close enough to allow thermal conduction. For example, when A and B are in the same container, box, or bundle, A and B can be regarded as being adjacent to each other.

As a mode of the secondary battery, which is different from the bendable secondary battery, any one or more modes of a coin-type secondary battery, a cylindrical secondary battery, an angular secondary battery, and a laminated secondary battery may be employed. Structures preferable for the coin-type secondary battery, the cylindrical secondary battery, the angular secondary battery, and the laminated secondary battery will be described in Embodiment 4.

As a combination of the secondary battery 401 capable of being charged and discharged even at low temperatures and the secondary battery 402 having high charge and discharge characteristics and high cycle performance in a middle temperature range, both the secondary battery 401 and the secondary battery 402 can be angular secondary batteries, for example. Alternatively, both the secondary battery 401 and the secondary battery 402 can be cylindrical secondary batteries. Alternatively, both the secondary battery 401 and the secondary battery 402 can be laminated secondary batteries. Alternatively, both the secondary battery 401 and the secondary battery 402 can be coin-type secondary batteries.

As a combination of the secondary battery 401 capable of being charged and discharged even at low temperatures and the secondary battery 402 having high charge and discharge characteristics and high cycle performance in a middle temperature range, the secondary battery 401 can be a bendable secondary battery and the secondary battery 402 can be an angular secondary battery, for example. Alternatively, the secondary battery 401 can be a bendable secondary battery and the secondary battery 402 can be a cylindrical secondary battery. Alternatively, the secondary battery 401 can be a bendable secondary battery and the secondary battery 402 can be a laminated secondary battery. Alternatively, the secondary battery 401 can be a bendable secondary battery and the secondary battery 402 can be a coin-type secondary battery.

Note that the combination of the secondary battery 401 capable of being charged and discharged even at low temperatures and the secondary battery 402 having high charge and discharge characteristics and high cycle performance in a middle temperature range is not limited to the above examples, and any one or more of the coin-type secondary battery, the cylindrical secondary battery, the angular secondary battery, the laminated secondary battery, and the bendable secondary battery may be combined.

FIG. 1A to FIG. 4C are diagrams illustrating favorable examples of the combination of the secondary battery 401 capable of being charged and discharged even at low temperatures and the secondary battery 402 having high charge and discharge characteristics and high cycle performance in a middle temperature range.

FIG. 1A illustrates an example in which the secondary battery 401 and the secondary battery 402 included in the power storage device 400 are angular secondary batteries placed such that their largest surfaces face each other. Such a placement can increase the efficiency of thermal conduction.

An angular secondary battery refers to a secondary battery including an exterior body (housing) having a rectangular solid shape. The term “rectangular solid” refers to a hexahedron whose surfaces are all rectangular. In this specification and the like, these rectangular surfaces are not necessarily strictly rectangular nor completely flat. For example, a certain surface may be provided with a positive electrode terminal and/or a negative electrode terminal, or may have unevenness for higher strength. Such a shape may be referred to as a substantially rectangular solid.

FIG. 1B illustrates an example in which the secondary battery 401 and the secondary battery 402 included in the power storage device 400 are cylindrical secondary batteries.

In this specification and the like, the cylindrical shape refers to a solid whose bottom and top surfaces are circular. These circular surfaces are not necessarily strictly circular nor completely flat. For example, the surface may be provided with a positive electrode terminal and/or a negative electrode terminal, or may have unevenness for higher strength. Such a shape may be referred to as a substantially cylindrical shape.

FIG. 1C and FIG. 1D illustrate an example in which the secondary battery 401 and the secondary battery 402 included in the power storage device 400 are a bendable secondary battery and an angular secondary battery, respectively. FIG. 1 C is a bird's eye view of the power storage device 400, and FIG. 1D is a top view of the power storage device 400. In FIG. 1D, a terminal 403 is a positive electrode terminal or a negative electrode terminal included in the secondary battery 401. The bendable secondary battery 401 preferably includes an exterior body having a wave shape as illustrated in FIG. 1C and FIG. 1D. In the case where the exterior body having a wave shape is included, the secondary battery 401 is easily bent. Thus, when the secondary battery 401 is a bendable secondary battery, the contact area between the secondary battery 401 and the secondary battery 402 can be increased as illustrated in FIG. 1C and FIG. 1D.

FIG. 1E and FIG. 1F illustrate an example in which the secondary battery 401 and the secondary battery 402 included in the power storage device 400 are a bendable secondary battery and a cylindrical secondary battery, respectively. FIG. 1E is a bird's eye view of the power storage device 400, and FIG. 1F is a top view of the power storage device 400. In FIG. 1F, the terminal 403 is a positive electrode terminal or a negative electrode terminal included in the secondary battery 401. The bendable secondary battery 401 preferably includes an exterior body having a wave shape as illustrated in FIG. 1E and FIG. 1F. In the case where the exterior body having a wave shape is included, the secondary battery 401 is easily bent. Thus, when the secondary battery 401 is a bendable secondary battery, the contact area between the secondary battery 401 and the secondary battery 402 can be increased as illustrated in FIG. 1E and FIG. 1F.

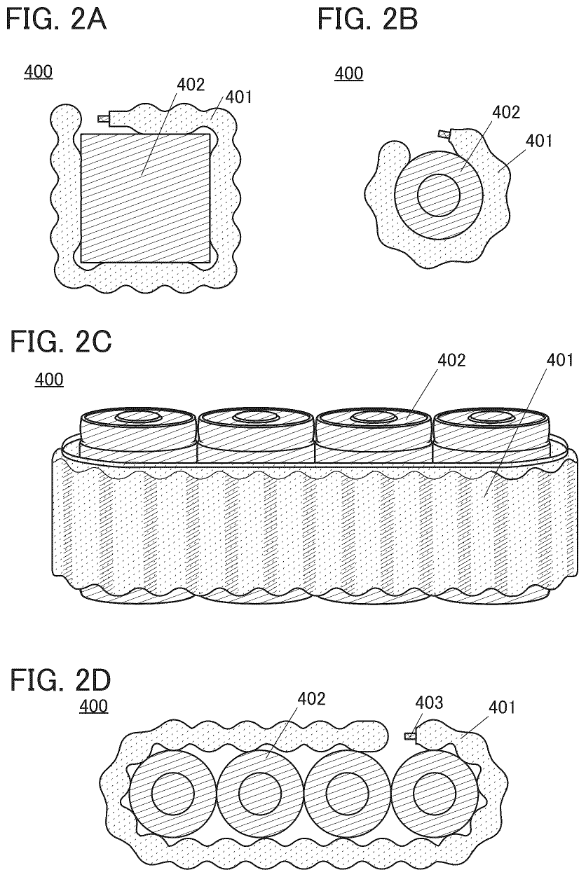

FIG. 2A and FIG. 2B respectively illustrate a modification example of the power storage device 400 illustrated in FIG. 1D and FIG. 1 F. As illustrated in FIG. 2A and FIG. 2B, a shape of the exterior body of the secondary battery 401 on the side in contact with the secondary battery 402 may be substantially flat. With such a structure, the contact area between the secondary battery 401 and the secondary battery 402 can be further increased.

Although FIG. 1C to FIG. 2B show examples of the power storage device 400 including one secondary battery 401 and one secondary battery 402, the power storage device 400 may include a plurality of secondary batteries 402 and one secondary battery 401 as illustrated in FIG. 2C and FIG. 2D. FIG. 2C is a bird's eye view of the power storage device 400, and FIG. 2D is a top view of the power storage device 400. In the power storage device 400 illustrated in FIG. 2C and FIG. 2D, one secondary battery 401 can heat the plurality of secondary batteries 402.

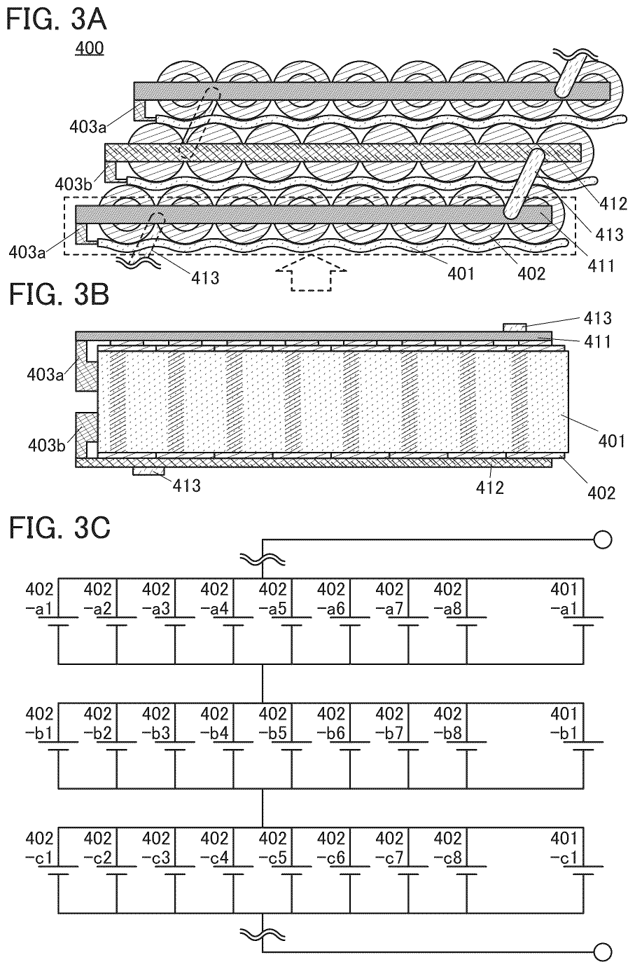

FIG. 3A to FIG. 3C are diagrams illustrating an example of the power storage device 400 including a plurality of secondary batteries 401 and a plurality of secondary batteries 402. FIG. 3A is a top view of the power storage device 400, FIG. 3B is a side view of a side surface of a dashed line portion in FIG. 3A seen from the arrow direction, and FIG. 3C is a diagram illustrating connection relations of the secondary batteries 401 and the secondary batteries 402 included in the power storage device 400.

In FIG. 3A, the secondary batteries 401 are bendable secondary batteries, and three secondary batteries 401 are illustrated in the drawing. The secondary batteries 402 are cylindrical secondary batteries, and twenty-four secondary batteries 402 are illustrated in the drawing. The secondary batteries 401 are bent and placed along the side surfaces of the secondary batteries 402.

FIG. 3A illustrates the three secondary batteries 401 and the twenty-four secondary batteries 402. In the drawing, the three secondary batteries 401 and the twenty-four secondary batteries 402 have connection relations in which three groups of parallel connected nine batteries (one secondary battery 401 and eight secondary batteries 402) are connected in series. Here, the state where the one secondary battery 401 is connected to the eight secondary batteries 402 in parallel is illustrated; these batteries are connected to each other in parallel through a parallel connection wiring 411 and a parallel connection wiring 412. The parallel connection wiring 411 and the parallel connection wiring 412 are connected to each other in series through a series connection wiring 413 as illustrated in FIG. 3A. FIG. 3C is a diagram illustrating connection relations thereof.

FIG. 3B is the side view of the dashed line portion in FIG. 3A seen from the arrow direction. The secondary battery 401 includes a positive electrode terminal 403a and a negative electrode terminal 403b. The positive electrode terminal 403a is electrically connected to the parallel connection wiring 411, and the negative electrode terminal 403b is electrically connected to the parallel connection wiring 412.

In the case where the power storage device 400 has the structure described with reference to FIG. 3A to FIG. 3C, the secondary battery 402 can be heated using heat generated by charge and discharge of the secondary battery 401 as an internal heat source in a low temperature environment. When the secondary battery 402 is heated to reach or be close to a middle temperature range, high charge and discharge characteristics of the secondary battery 402 can be utilized.

Although FIG. 3A to FIG. 3C illustrate the state where the three secondary batteries 401 and the eight secondary batteries 402 are connected in parallel and in series, the number of secondary batteries 401 and 402, the parallel number, and the series number are not limited to the above example.

FIG. 3A to FIG. 3C illustrate an example of the power storage device 400 in which the parallel connected secondary batteries 401 and 402 are connected in series. Next, FIG. 4A to FIG. 4C illustrate an example of the power storage device 400 that includes a series system including only the secondary batteries 401 and a series system including only the secondary batteries 402.

FIG. 4A to FIG. 4C are diagrams illustrating an example of the power storage device 400 including the plurality of secondary batteries 401 and the plurality of secondary batteries 402. FIG. 4A is a top view of the power storage device 400, FIG. 4B is a side view of a side surface of a dashed line portion in FIG. 4A seen from the arrow direction, and FIG. 4C is a diagram illustrating connection relations of the secondary batteries 401 and the secondary batteries 402 included in the power storage device 400.

In FIG. 4A, the secondary batteries 401 are bendable secondary batteries, and the three secondary batteries 401 are illustrated in the drawing. The secondary batteries 402 are cylindrical secondary batteries, and the twenty-four secondary batteries 402 are illustrated in the drawing. The secondary batteries 401 are bent and placed along the side surfaces of the secondary batteries 402.

FIG. 4A illustrates the three secondary batteries 401 and the twenty-four secondary batteries 402. The three secondary batteries 401 are connected in series. In addition, as for the twenty-four secondary batteries 402, three groups of parallel connected eight secondary batteries 402 are connected in series. Here, the series connected three secondary batteries 401 and the series connected three groups of the parallel connected eight secondary batteries 402 are systems independent from each other.

The three secondary batteries 401 are connected in series through a series connection wiring 414. As for the secondary batteries 402, the eight secondary batteries 402 are connected in parallel through the parallel connection wiring 411 and the parallel connection wiring 412, and the parallel connection wiring 411 and the parallel connection wiring 412 are connected in series through the series connection wiring 413. FIG. 4C is a diagram illustrating connection relations thereof.

FIG. 4B is the side view of the dashed line portion in FIG. 4A seen from the arrow direction. The secondary battery 401 includes the positive electrode terminal 403a and the negative electrode terminal 403b. In the range illustrated in FIG. 4B, the positive electrode terminal 403a is electrically connected to a first series connection wiring 414a, and the negative electrode terminal 403b is electrically connected to a second series connection wiring 414b.

In the case where the power storage device 400 has the structure described with reference to FIG. 4A to FIG. 4C, the secondary battery 402 can be heated using heat generated by charge and discharge of the secondary battery 401 as an internal heat source in a low temperature environment. When the secondary battery 402 is heated to reach or be close to a middle temperature range, high charge and discharge characteristics of the secondary battery 402 can be utilized.

The power storage device 400 described with reference to FIG. 4A to FIG. 4C preferably includes the series system including only the secondary batteries 401 and the series system including only the secondary batteries 402, in which case the systems can be independently controlled depending on the ambient temperature of the power storage device 400. For example, in a low-temperature environment, only the series system including only the secondary batteries 401 can be used or the series system including only the secondary batteries 401 can be preferentially used. In a high-temperature environment, only the series system including only the secondary batteries 402 can be used or the series system including only the secondary batteries 402 can be preferentially used.

For example, in the case where a sodium ion battery is used as the secondary battery 401 and a lithium ion battery is used as the secondary battery 402, the voltages of the secondary batteries are different from each other. In such a case, the power storage device 400 preferably includes the series system including only the secondary batteries 401 and the series system including only the secondary batteries 402.

Although FIG. 4A to FIG. 4C illustrate the state where the three secondary batteries 401 and the eight secondary batteries 402 are connected in parallel and in series, the number of secondary batteries 401 and 402, the parallel number, and the series number are not limited to the above example.

Although FIG. 1A to FIG. 4C illustrate examples in which two kinds of lithium ion secondary batteries that differ in the operating temperature range are included, one embodiment of the present invention is not limited thereto. Three or more kinds of lithium ion secondary batteries that differ in the operating temperature range may be included.

In the examples of combinations of the secondary battery 401 and the secondary battery 402 illustrated in FIG. 1 A to FIG. 4C, a thermal conductive material may be provided between the secondary battery 401 and the secondary battery 402. The thermal conductive material has higher thermal conductivity than the air. For example, a metal foil such as a copper foil, a metal wire, a graphite sheet, silicone oil, or an antifreeze solution such as ethylene glycol can be used. Alternatively, these materials may be used in combination. For example, a metal tube in which a liquid having high thermal conductivity is circulated may be used.

It is preferable that the power storage device 400 further include a temperature sensor and a control circuit. The temperature sensor has a function of detecting the temperature of at least the secondary battery 402. The control circuit preferably has a function of making the secondary battery 401 generate heat so that the secondary battery 402 is heated to the operating temperature range, when the temperature of the secondary battery 402 is lower than the operating temperature range. For example, such control is possible when the series system of the secondary batteries 401 and the series system of the secondary batteries 402 are independent from each other as in the power storage device 400 illustrated in FIG. 4A to FIG. 4C.

For example, in the case where the power storage device 400 includes the secondary battery 401 with an operating temperature range from −40° C. to 0° C., the secondary battery 402 with an operating temperature range from 0° C. to 65° C., the temperature sensor, and the control circuit, the control circuit preferably has a function of making the secondary battery 401 generate heat so that the secondary battery 402 is heated to the range from 0° C. to 65° C. when the temperature of the secondary battery 402 detected by the temperature sensor is lower than 0° C.

When the temperature of the secondary battery 402 is within the operating temperature range, the secondary battery 401 may be operated, i.e., charged or discharged, or is not necessarily operated. For example, the control circuit may have a function of making the secondary battery 401 operate when the temperature of the secondary battery 402 is lower than 25° C., and not making the secondary battery 401 operate when the temperature of the secondary battery 402 is higher than or equal to 25° C.

Note that a method for heating the secondary battery 402 is not limited to the method in which the secondary battery 401 is made to generate heat; the power storage device 400 may further include a heater. In the case where the power storage device 400 includes a heater, the secondary battery 402 can be heated using not only heat generated by the secondary battery 401 but also heat generated by the heater with electric power of the secondary battery 401.

The power storage device 400 may further include a plurality of secondary batteries 401 and an inverter. With such a structure, discharge current of one secondary battery 401 can be converted into AC current by the inverter, and another secondary battery 401 can be repeatedly charged and discharged using the AC current. This operation also makes the secondary battery 401 generate heat.

For example, in the case where the power storage device 400 includes two or more secondary batteries 401 with an operating temperature range from −40° C. to 0° C., the secondary battery 402 with an operating temperature range from 0° C. to 65° C., the temperature sensor, the control circuit, and the inverter, the control circuit preferably has a function of setting the temperature of the secondary battery 402 to the range from 0° C. to 65° C. when the temperature of the secondary battery 402 detected by the temperature sensor is lower than 0° C., in the following manner: discharge current of one secondary battery 401 is converted into AC current by the inverter, another secondary battery 401 is repeatedly charged and discharged using the AC current, and the secondary battery 402 is heated using the generated heat.

The control circuit further preferably has a function of sensing at least one of overcharge, overdischarge, and overcurrent to protect the secondary battery 401 and the secondary battery 402, in addition to the temperature controlling function.

The power storage device 400 may have a structure in which the secondary battery 402 does not perform discharge to the outside when the temperature is lower than the operating temperature range, and starts to perform discharge to the outside after heated to the operating temperature range by the secondary battery 401. In that case, the secondary battery 401 can be regarded as having a function of a preheating source of the secondary battery 402.

Although the power storage device including two kinds of lithium-ion secondary batteries is used as an example in the description of the temperature sensor and the control circuit, one embodiment of the present invention is not limited thereto. The functions of the temperature sensor and the control circuit can be set with reference to the above description, even in the case of a power storage device including three or more kinds of lithium-ion secondary batteries, the temperature sensor, and the control circuit.

This embodiment can be used in combination with the other embodiments.

### Embodiment 2

This embodiment describes a structure of a lithium ion battery which is needed to provide a lithium ion battery with excellent discharge characteristics even in a low-temperature environment (e.g., lower than or equal to 0° C., lower than or equal to −20° C., preferably lower than or equal to −30° C., further preferably lower than or equal to −40° C., still further preferably lower than or equal to −50° C., most preferably lower than or equal to −60° C.) and/or a lithium ion battery with excellent charge characteristics in a low-temperature environment. Specifically, a positive electrode active material that is included in a positive electrode and an electrolyte are mainly described.

[Lithium ion battery]A lithium ion battery of one embodiment of the present invention includes a positive electrode, a negative electrode, and an electrolyte. When the electrolyte includes an electrolyte solution, a separator is provided between the positive electrode and the negative electrode. An exterior body covering at least part of peripheries of the positive electrode, the negative electrode, and the electrolyte may be further provided.

[Positive electrode]A positive electrode includes a positive electrode active material layer and a positive electrode current collector. The positive electrode active material layer includes a positive electrode active material and may further include at least one of a conductive material and a binder.

Metal foil can be used as the current collector, for example. The positive electrode can be formed by applying slurry onto the metal foil and drying the slurry. Note that pressing may be performed after drying. The positive electrode is a component obtained by forming an active material layer over the current collector.

Slurry refers to a material solution that is used to form an active material layer over the current collector and includes an active material, a binder, and a solvent, preferably also a conductive material mixed therewith. Slurry may also be referred to as slurry for an electrode or active material slurry, in some cases, slurry for forming a positive electrode active material layer is referred to as slurry for a positive electrode, and slurry for forming a negative electrode active material layer is referred to as slurry for a negative electrode.

### <Positive Electrode Active Material>

A positive electrode active material applicable to a lithium ion battery capable of being charged and discharged even at low temperatures is described. As the positive electrode active material, lithium cobalt oxide and/or lithium nickel-cobalt-manganese oxide can be used. As the lithium cobalt oxide, it is preferable to use a lithium cobalt oxide to which magnesium and fluorine are added and a lithium cobalt oxide to which magnesium, fluorine, aluminum, and nickel are added, for example. As the lithium nickel-cobalt-manganese oxide, for example, lithium nickel-cobalt-manganese oxide with a ratio such as nickel:cobalt:manganese=1:1:1, nickel:cobalt:manganese=6:2:2, or the like can be used. As the above-described lithium nickel-cobalt-manganese oxide, for example, lithium nickel-cobalt-manganese oxide to which one or more of aluminum, calcium, barium, strontium, and gallium are added is preferably used.

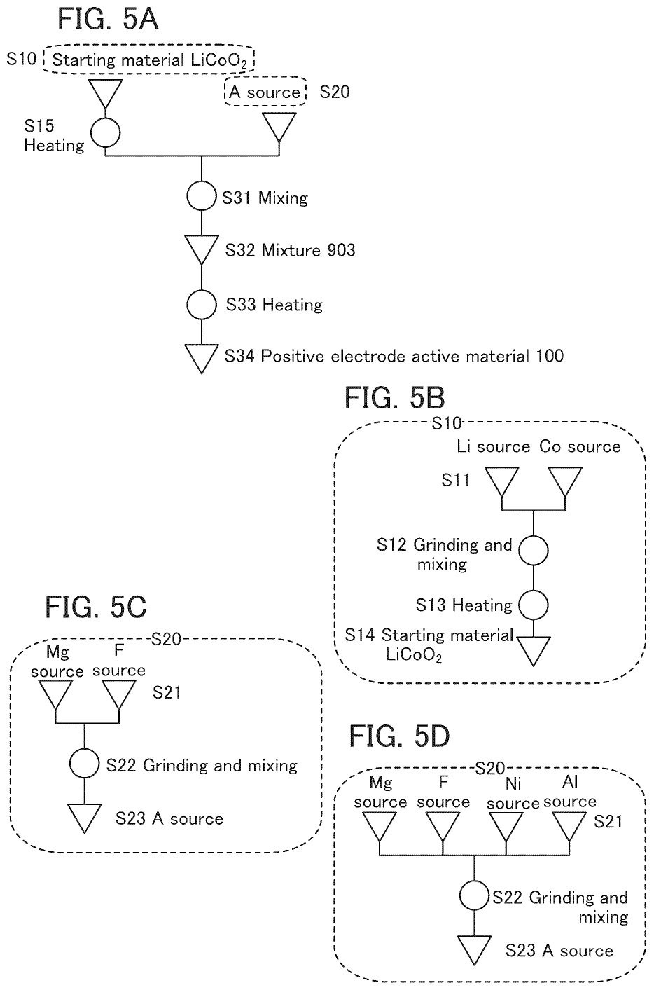

Next, a favorable example of the case where lithium cobalt oxide is used as a positive electrode active material is described. A method for forming a positive electrode active material applicable to a lithium ion battery having excellent discharge characteristics even in a low-temperature environment is described with reference to FIG. 5 to FIG. 7.

### <Example 1 of Method for Forming Positive Electrode Active Material>

An example of a method for forming the positive electrode active material that can be used as one embodiment of the present invention (Example 1 of method for forming positive electrode active material) will be described with reference to FIG. 5A to FIG. 5D.

First, lithium cobalt oxide is prepared as a starting material in Step S10. The particle diameter (strictly, median diameter (D50)) of the lithium cobalt oxide that is a starting material can be less than or equal to 10 μm (preferably less than or equal to 8 μm). Note that unless otherwise specified, in this specification and the like, the median diameter refers to D50 (a particle diameter at which cumulative frequency is 50%). Lithium cobalt oxide with a median diameter (D50) of less than or equal to 10 μm may be known or official (in short, commercially available) lithium cobalt oxide or lithium cobalt oxide formed through Step S11 to Step S14 shown FIG. 5B. As a typical example of the commercially available lithium cobalt oxide with a median diameter (D50) of less than or equal to 10 μm, lithium cobalt oxide produced by NIPPON CHEMICAL INDUSTRIAL CO., LTD. (product name: CELLSEED C-5H) can be given. The lithium cobalt oxide produced by NIPPON CHEMICAL INDUSTRIAL CO., LTD. (product name: CELLSEED C-5H) has a median diameter (D50) of approximately 7 μm. A method for forming lithium cobalt oxide with a median diameter (D50) of less than or equal to 10 μm through Step S11 to Step S14 is described below.

### <Step S11>

In Step S11 shown in FIG. 5B, a lithium source (Li source) and a cobalt source (Co source) are prepared as materials for lithium and a transition metal which are starting materials.

As the lithium source, a lithium-containing compound is preferably used and for example, lithium carbonate, lithium hydroxide, lithium nitrate, lithium fluoride, or the like can be used. The lithium source preferably has a high purity and is preferably a material having a purity higher than or equal to 99.99%, for example.

As the cobalt source, a cobalt-containing compound is preferably used, and for example, cobalt oxide, cobalt hydroxide, cobalt carbonate, or the like can be used. The cobalt source preferably has a high purity and is preferably a material having a purity of higher than or equal to 3N (99.9%), further preferably higher than or equal to 4N (99.99%), still further preferably higher than or equal to 4N5 (99.995%), yet further preferably higher than or equal to 5N (99.999%), for example. Impurities of the positive electrode active material can be controlled by using such a high-purity material. As a result, a secondary battery with an increased capacity and increased reliability can be obtained.

Furthermore, the cobalt source preferably has high crystallinity, and preferably includes single crystal particles, for example. To evaluate the crystallinity of the transition metal source, the crystallinity can be judged by a TEM (transmission electron microscope) image, a STEM (scanning transmission electron microscope) image, a HAADF-STEM (high-angle annular dark field scanning transmission electron microscope) image, an ABF-STEM (annular bright-field scanning transmission electron microscope) image, or the like, or can be judged by X-ray diffraction (XRD), electron diffraction, neutron diffraction, or the like. Note that the above methods for evaluating crystallinity can also be employed to evaluate the crystallinity of other materials in addition to the transition metal source.

### <Step S12>

Next, in Step S12 shown in FIG. 5B, the lithium source and the cobalt source are ground and mixed to form a mixed material. The grinding and mixing can be performed by a dry method or a wet method. To obtain lithium cobalt oxide with a median diameter (D50) of less than or equal to 10 μm as a starting material, the grinding and mixing by a wet method are preferred because a material can be crushed into a smaller size. When the grinding and mixing are performed by a wet method, a solvent is prepared. As the solvent, ketone such as acetone, alcohol such as ethanol or isopropanol, ether, dioxane, acetonitrile, N-methyl-2-pyrrolidone (NMP), or the like can be used. An aprotic solvent, which is unlikely to react with lithium, is preferably used. In this embodiment, dehydrated acetone with a purity higher than or equal to 99.5% is used. It is preferable that the lithium source and the transition metal source be mixed into dehydrated acetone whose moisture content is less than or equal to 10 ppm and which has a purity of higher than or equal to 99.5% in the grinding and mixing. With the use of dehydrated acetone with the above-described purity, impurities that might be mixed can be reduced.

A ball mill, a bead mill, or the like can be used as a means for the grinding and mixing, for example. When a ball mill is used, aluminum oxide balls or zirconium oxide balls are preferably used as a grinding medium. Zirconium oxide balls are preferable because they release fewer impurities. When a ball mill, a bead mill, or the like is used, the peripheral speed is preferably higher than or equal to 100 mm/s and lower than or equal to 2000 mm/s in order to inhibit contamination from the medium. In this embodiment, the peripheral speed is set to 838 mm/s (the rotational frequency is 400 rpm, and the diameter of the ball mill is 40 mm).

### <Step S13>

Next, the materials mixed in the above manner are heated in Step S13 shown in FIG. 5B. The heating is preferably performed at higher than or equal to 800° C., and lower than or equal to 1100° C., further preferably at higher than or equal to 900° C., and lower than or equal to 1000° C., still further preferably at approximately 950° C., and lower than or equal to 1000° C. An excessively low temperature might lead to insufficient decomposition and melting of the lithium source and the transition metal source. An excessively high temperature might lead to a defect due to evaporation of lithium from the lithium source and/or excessive reduction of cobalt, for example. For example, an oxygen defect which could be induced by a change of trivalent cobalt into divalent cobalt.

When the heating time is too short, lithium cobalt oxide is not synthesized, but when the heating time is too long, the productivity is lowered. Accordingly, the heating time is preferably longer than or equal to 1 hour and shorter than or equal to 100 hours, further preferably longer than or equal to 2 hours and shorter than or equal to 20 hours, still further preferably longer than or equal to 2 hours and shorter than or equal to 10 hours.

A temperature rising rate is preferably higher than or equal to 80° C./h and lower than or equal to 250° C./h, although depending on the end-point temperature of the heating. For example, in the case of heating at 1000° C. for 10 hours, the temperature rising rate is preferably 200° C./h.

The heating is preferably performed in an atmosphere with little water such as a dry-air atmosphere and for example, the dew point of the atmosphere is preferably lower than or equal to −50° C., further preferably lower than or equal to −80° C. In this embodiment, the heating is performed in an atmosphere with a dew point of −93° C. To reduce impurities that might enter the material, the concentrations of impurities such as CH₄, CO, CO₂, and H₂ in the heating atmosphere are each preferably lower than or equal to 5 ppb (parts per billion).

The heating atmosphere is preferably an oxygen-containing atmosphere. For example, one method, a dry air is continuously introduced into a reaction chamber. The flow rate of a dry air in this case is preferably 10 L/min. Continuously introducing oxygen into a reaction chamber to make oxygen flow therein is referred to as flowing.

In the case where the heating atmosphere is an oxygen-containing atmosphere, flowing is not necessarily performed. For example, the following method may be employed; the pressure in the reaction chamber is reduced, then the reaction chamber is filled with oxygen, and the oxygen is prevented from entering or exiting from the reaction chamber. Such a method is referred to as purging. For example, the pressure in the reaction chamber may be reduced to −970 hPa, and then, the reaction chamber may be filled with oxygen until the pressure becomes 50 hPa.

Cooling after the heating can be performed by letting the mixed material stand to cool, and the time it takes for the temperature to decrease to room temperature from a predetermined temperature is preferably longer than or equal to 10 hours and shorter than or equal to 50 hours. Note that the temperature does not necessarily need to decrease to room temperature as long as it decreases to a temperature acceptable to the next step.

The heating in this step may be performed with a rotary kiln or a roller hearth kiln. Heating with stirring can be performed in either case of a sequential rotary kiln or a batch-type rotary kiln.

A container used at the time of the heating is preferably a crucible or a sagger made of aluminum oxide. The crucible made of aluminum oxide has a material property that hardly allows the entry of impurities. In this embodiment, a sagger made of aluminum oxide with a purity of 99.9% is used. Note that the heating is preferably performed with the crucible or the sagger covered with a lid, in which case volatilization of a material can be prevented.

The heated material is ground as needed and may be made to pass through a sieve. Before collection of the heated material, the material may be moved from the crucible to a mortar. As the mortar, a mortar made of zirconium oxide or agate is suitably used. Note that heating conditions equivalent to those in Step S13 can be employed in a later-described heating step other than Step S13.

### <Step S14>

Through the above steps, lithium cobalt oxide (LiCoO₂) can be synthesized as Step S14 in FIG. 5B. The lithium cobalt oxide (LiCoO₂) in Step S14 is an oxide containing a plurality of metal elements in its structure and thus can be referred to as a composite oxide. Note that the lithium cobalt oxide (LiCoO₂) shown in Step S14 may be obtained after adjusting particle size distribution by performing a grinding step and a classification step after Step S13.

Although the example is described in which the composite oxide is formed by a solid phase method as in Step S11 to Step S14, the composite oxide may be formed by a coprecipitation method. Alternatively, the composite oxide may be formed by a hydrothermal method.

Through Step S11 to Step S14, lithium cobalt oxide that is a starting material for a positive electrode active material applicable to a lithium ion battery having excellent discharge characteristics even in a low-temperature environment can be obtained. Specifically, as the lithium cobalt oxide that is a starting material, lithium cobalt oxide with a median diameter (D50) of less than or equal to 10 μm can be obtained.

### <Step S15>

Next, as Step S15 shown in FIG. 5A, the lithium cobalt oxide that is a starting material is heated. The heating in Step S15 is the first heating performed on the lithium cobalt oxide and thus is sometimes referred to as the initial heating in this specification and the like. The heating is performed before Step S31 described below, and thus is sometimes referred to as preheating or pretreatment.

First, by the initial heating, a lithium compound or the like unintentionally remaining on a surface of lithium cobalt oxide is extracted. In addition, an effect of increasing the crystallinity of the inner portion can be expected. Although the lithium source and/or the cobalt source prepared in Step S11 and the like might contain impurities, impurities in the lithium cobalt oxide that is a starting material can be reduced by the initial heating. Note that the effect of increasing the crystallinity of the inner portion is, for example, an effect of reducing distortion, a shift, or the like derived from differential shrinkage or the like of the lithium cobalt oxide formed in Step S14.

Through the initial heating, an effect of smoothing the surface of the lithium cobalt oxide is obtained. Furthermore, through the initial heating, an effect of reducing a crack, a crystal defect, or the like included in the lithium cobalt oxide is obtained. In this specification and the like, a smooth surface refers to a state of having little unevenness and being rounded as a whole, and its corner portion is rounded. A smooth surface also refers to a surface to which few foreign matters are attached. Foreign matters are deemed to cause unevenness and are preferably not attached to a surface.

For the initial heating, a lithium compound source, an additive element A source, or a material functioning as a fusing agent is not necessarily separately prepared.

When the heating time in this step is too short, a sufficient effect is not obtained, but when the heating time in this step is too long, the productivity is lowered. For example, as an appropriate range of the heating time, any of the heating conditions described for Step S13 can be selected. The heating temperature in Step S15 is preferably lower than that in Step S13 so that the crystal structure of the composite oxide is maintained. The heating time in Step S15 is preferably shorter than that in Step S13 so that the crystal structure of the composite oxide is maintained. For example, the heating is preferably performed at higher than or equal to 700° C. and lower than or equal to 1000° C. (further preferably higher than or equal to 800° C., and lower than or equal to 900° C.) for longer than or equal to 1 hour and shorter than or equal to 20 hours (further preferably longer than or equal to 1 hour and shorter than or equal to 5 hours).

The heating in Step S13 might cause a temperature difference between the surface and an inner portion of the above lithium cobalt oxide. The temperature difference sometimes induces differential shrinkage. It can also be deemed that the temperature difference leads to a fluidity difference between the surface and the inner portion, thereby causing differential shrinkage. The energy involved in differential shrinkage causes a difference in internal stress in the lithium cobalt oxide. The difference in internal stress is also called distortion, and the above energy is sometimes referred to as distortion energy. The internal stress is eliminated by the initial heating in Step S15 and in other words, the distortion energy is probably equalized by the initial heating in Step S15. When the distortion energy is equalized, the distortion in the lithium cobalt oxide is relieved. Accordingly, the surface of the lithium cobalt oxide may become smooth. This is also rephrased as modification of the surface. In other words, Step S15 can reduce the differential shrinkage caused in the lithium cobalt oxide and make the surface of the composite oxide smooth.

Such differential shrinkage might cause a micro shift in the lithium cobalt oxide such as a shift in a crystal. To reduce this shift, Step S15 is preferably performed. Performing Step S15 can distribute a shift uniformly in the composite oxide (reduce the shift in a crystal or the like which is caused in the composite oxide or align crystal grains). As a result, the surface of the composite oxide becomes smooth.

In a secondary battery including lithium cobalt oxide with a smooth surface as a positive electrode active material, deterioration by charge and discharge is suppressed and a crack in the positive electrode active material can be prevented.

Note that pre-synthesized lithium cobalt oxide with a median diameter (D50) of less than or equal to 10 μm may be used in Step S10 as described above. In that case, Step S11 to Step S13 can be omitted. When Step S15 is performed on the pre-synthesized lithium cobalt oxide, lithium cobalt oxide with a smooth surface can be obtained.

Note that Step S15 is not essential in one embodiment of the present invention; thus, an embodiment in which Step S15 is skipped is also included in one embodiment of the present invention.

### <Step S20>

Next, details of Step S20 of preparing the additive element A as the A source are described with reference to FIG. 5C and FIG. 5D.

### <Step S21>

Step S20 shown in FIG. 5C includes Step S21 to Step S23. In Step S21, the additive element A is prepared. As specific examples of the additive element A, one or more selected from magnesium, fluorine, nickel, aluminum, titanium, zirconium, vanadium, iron, manganese, chromium, niobium, arsenic, zinc, silicon, sulfur, phosphorus, and boron can be used.

Alternatively, one or more selected from bromine and beryllium can be used. FIG. 5C shows an example of the case where a magnesium source (Mg source) and a fluorine source (F source) are prepared. Note that in Step S21, a lithium source may be separately prepared in addition to the additive element A.

When magnesium is selected as the additive element A, the additive element A source can be referred to as a magnesium source. As the magnesium source, magnesium fluoride (MgF₂), magnesium oxide (MgO), magnesium hydroxide (Mg(OH)₂), magnesium carbonate (MgCO₃), or the like can be used. Two or more of these magnesium sources may be used.

When fluorine is selected as the additive element A, the additive element A source can be referred to as a fluorine source. As the fluorine source, for example, lithium fluoride (LiF), magnesium fluoride (MgF₂), aluminum fluoride (AlF₃), titanium fluoride (TiF₄), cobalt fluoride (CoF₂ and CoF₃), nickel fluoride (NiF₂), zirconium fluoride (ZrF₄), vanadium fluoride (VF₅), manganese fluoride, iron fluoride, chromium fluoride, niobium fluoride, zinc fluoride (ZnF₂), calcium fluoride (CaF₂), sodium fluoride (NaF), potassium fluoride (KF), barium fluoride (BaF₂), cerium fluoride (CeF₃ and CeF₄), lanthanum fluoride (LaF₃), sodium aluminum hexafluoride (Na₃AlF₆), or the like can be used. In particular, lithium fluoride is preferable because it is easily melted in a heating step described later owing to its relatively low melting point of 848° C.

Magnesium fluoride can be used as both the fluorine source and the magnesium source.

Lithium fluoride can also be used as the lithium source. Another example of the lithium source that can be used in Step S21 is lithium carbonate.

The fluorine source may be a gas, for example, fluorine (F₂), carbon fluoride, sulfur fluoride, oxygen fluoride (OF₂, O₂F₂, O₃F₂, O₄F₂, O₅F₂, O₆F₂, and O₂F), or the like may be used and mixed in the atmosphere in a heating step described later. Two or more of these fluorine sources may be used.

In this embodiment, lithium fluoride (LiF) is prepared as the fluorine source, and magnesium fluoride (MgF₂) is prepared as the fluorine source and the magnesium source. When lithium fluoride and magnesium fluoride are mixed such that LiF:MgF₂ is approximately 65:35 (molar ratio), the effect of lowering the melting point is maximized. When the proportion of lithium fluoride is too high, cycle performance might deteriorate because of an excessive amount of lithium. Therefore, the molar ratio of lithium fluoride to magnesium fluoride is preferably LiF:MgF₂=x:1 (0≤x≤1.9), further preferably LiF:MgF₂=x:1 (0.1≤x≤0.5), still further preferably LiF:MgF₂=x:1 (x=0.33 and the neighborhood thereof). Note that in this specification and the like, the expression “an approximate value of a given value” means greater than 0.9 times and less than 1.1 times the given value, unless otherwise specified.

### <Step S22>

Next, in Step S22 shown in FIG. 5C, the magnesium source and the fluorine source are ground and mixed. Any of the conditions for grinding and mixing that are described for Step S12 can be selected to perform this step.

### <Step S23>

Next, in Step S23 shown in FIG. 5C, the materials ground and mixed in the above step are collected to give the additive element A source (A source). Note that the additive element A source in Step S23 contains a plurality of starting materials and can be referred to as a mixture.

As for the particle diameter of the mixture, the median diameter (D50) is preferably greater than or equal to 100 nm and less than or equal to 10 μm, further preferably greater than or equal to 300 nm and less than or equal to 5 μm. Also when one kind of material is used as the additive element A source, the median diameter (D50) is preferably greater than or equal to 100 nm and less than or equal to 10 μm, further preferably greater than or equal to 300 nm and less than or equal to 5 μm.

A mixture pulverized in Step S22 (which may contain only one kind of the additive element) is easily attached to the surface of lithium cobalt oxide uniformly when mixed with the lithium cobalt oxide in a later step. The mixture is preferably attached uniformly to the surface of the lithium cobalt oxide, in which case the additive element is easily distributed or dispersed uniformly in the surface portion of the composite oxide after heating.

### <Step S21>

A process different from that in FIG. 5C is described with reference to FIG. 5D. Step S20 shown in FIG. 5D includes Step S21 to Step S23.

In Step S21 shown in FIG. 5D, four kinds of additive element A sources to be added to the lithium cobalt oxide are prepared. In other words, FIG. 5D is different from FIG. 5C in the kinds of the additive element A sources. A lithium source may be separately prepared in addition to the additive element A sources.

As the four kinds of additive element A sources, a magnesium source (Mg source), a fluorine source (F source), a nickel source (Ni source), and an aluminum source (Al source) are prepared. The magnesium source and the fluorine source can be selected from the compounds and the like described with reference to FIG. 5C. As a nickel source, nickel oxide, nickel hydroxide, or the like can be used. As an aluminum source, aluminum oxide, aluminum hydroxide, or the like can be used.

### <Step S22 and Step S23>

Next, Step S22 and Step S23 shown in FIG. 5D are similar to Step S22 and Step S23 shown in FIG. 5C.

### <Step S31>

Next, in Step S31 shown in FIG. 5A, the lithium cobalt oxide that has been subjected to Step S15 (initial heating) and the additive element A source (Mg source) are mixed. Here, the atomic ratio of cobalt Co in the lithium cobalt oxide that has been subjected to Step S15 to magnesium Mg contained in the additive element A is preferably Co:Mg=100:y (0.1≤y≤6), further preferably Co:Mg=100:y (0.3≤y≤3). When the additive element A is added to the lithium cobalt oxide that has been subjected to the initial heating, the additive element A can be uniformly added. Thus, the initial heating (Step S15) is preferably performed not after the addition of the additive element A but before the addition of the additive element A.

When nickel is selected as the additive element A, the mixing in Step S31 is preferably performed such that the number of nickel atoms in the nickel source is greater than or equal to 0.05% and less than or equal to 4% of the number of cobalt atoms in the lithium cobalt oxide that has been subjected to Step S15. When aluminum is selected as the additive element A, the mixing in Step S31 is preferably performed such that the number of aluminum atoms in the aluminum source is greater than or equal to 0.05% and less than or equal to 4% of the number of cobalt atoms in the lithium cobalt oxide that has been subjected to Step S15.

The condition of the mixing in Step S31 is preferably milder than that of the grinding and mixing in Step S12 not to damage the lithium cobalt oxide shape. For example, a condition with a smaller number of rotations or a shorter time than that of the mixing in Step S12 is preferable. Moreover, a dry method is regarded as a milder condition than a wet method. For example, a ball mill or a bead mill can be used for the mixing. When a ball mill is used, zirconium oxide balls are preferably used as a medium, for example.

In this embodiment, the mixing is performed with a ball mill using zirconium oxide balls with a diameter of 1 mm by a dry method at 150 rpm for 1 hour. The mixing is performed in a dry room the dew point of which is higher than or equal to −100° C., and lower than or equal to −10° C.

### <Step S32>

Next, in Step S32 in FIG. 5A, the materials mixed in the above manner are collected, whereby a mixture 903 is obtained. At the time of the collection, the materials may be crushed as needed and made to pass through a sieve.

### <Step S33>

Then, in Step S33 shown in FIG. 5A, the mixture 903 is heated. The heating in Step S33 is preferably performed at higher than or equal to 800° C., and lower than or equal to 1100° C., further preferably higher than or equal to 800° C., and lower than or equal to 950° C., still further preferably higher than or equal to 850° C., and lower than or equal to 900° C. The heating time in Step S33 is longer than or equal to 1 hour and shorter than or equal to 100 hours and is preferably longer than or equal to 1 hour and shorter than or equal to 10 hours. The lower limit of the heating temperature in Step S33 needs to be higher than or equal to the temperature at which a reaction between the lithium cobalt oxide and the additive element A source proceeds. The temperature at which the reaction proceeds is the temperature at which interdiffusion of the elements included in lithium cobalt oxide and the additive element A source occurs, and may be lower than the melting temperatures of these materials. In the case where an oxide is described as an example, solid phase diffusion occurs at the Tamman temperature Td (0.757 times the melting temperature Tₘ); thus, the heating temperature in Step S33 is higher than or equal to 500° C.

Note that the reaction more easily proceeds at a temperature higher than or equal to the temperature at which one or more selected from the materials contained in the mixture 903 are melted. For example, in the case where LiF and MgF₂ are included in the additive element A source, the lower limit of the heating temperature in Step S33 is preferably higher than or equal to 742° C. because the eutectic point of LiF and MgF₂ is around 742° C.

The mixture 903 obtained by mixing such that LiCoO₂:LiF:MgF₂=100:0.33:1 (molar ratio) exhibits an endothermic peak at around 830° C. in differential scanning calorimetry (DSC). Thus, the lower limit of the heating temperature is further preferably higher than or equal to 830° C.

A higher heating temperature is preferable because it facilitates the reaction, shortens the heating time, and enables high productivity.

The upper limit of the heating temperature is lower than the decomposition temperature of the lithium cobalt oxide (1130° C.). At around the decomposition temperature, a slight amount of lithium cobalt oxide might be decomposed. Thus, the upper limit of the heating temperature is preferably lower than or equal to 1000° C., further preferably lower than or equal to 950° C., still further preferably lower than or equal to 900° C.

In addition, at the time of heating the mixture 903, the partial pressure of fluorine or a fluoride originating from the fluorine source or the like is preferably controlled to be within an appropriate range.

In the fabrication method described in this embodiment, some of the materials, e.g., LiF as the fluorine source, function as a fusing agent in some cases. Owing to this function, the heating temperature can be lower than the decomposition temperature of the lithium cobalt oxide, e.g., a temperature higher than or equal to 742° C., and lower than or equal to 950° C., which allows distribution of the additive element such as magnesium in the surface portion and fabrication of the positive electrode active material having favorable characteristics.

Since LiF in a gas phase has a specific gravity less than that of oxygen, heating might volatilize or sublimate LiF and in that case, LiF in the mixture 903 decreases. In this case, the function of a fusing agent deteriorates. Therefore, heating is preferably performed while volatilization of LiF is inhibited. Note that even when LiF is not used as the fluorine source or the like, Li at the surface of LiCoO₂ and F of the fluorine source might react to produce LiF, which might be volatilized. Thus, such inhibition of volatilization is needed also when a fluoride having a higher melting point than LiF is used.

In view of this, the mixture 903 is preferably heated in an atmosphere containing LiF, i.e., the mixture 903 is preferably heated in a state where the partial pressure of LiF in the heating furnace is high. Such heating can inhibit volatilization of LiF in the mixture 903.

The heating in this step is preferably performed such that the particles of the mixture 903 are not adhered to each other. Adhesion of the particles of the mixture 903 during the heating might decrease the area of contact with oxygen in the atmosphere and inhibit a path of diffusion of the added element (e.g., fluorine), thereby hindering distribution of the added element (e.g., magnesium and fluorine) in the surface portion.

Uniform distribution of the additive element (e.g., fluorine) in the surface portion leads to a smooth positive electrode active material with little unevenness. Thus, it is preferable that the particles of the mixture 903 not be adhered to each other in order to allow the smooth surface obtained through the heating in Step S15 to be maintained or to be smoother in this step.

In the case of using a rotary kiln for the heating, the heating is preferably performed while the flow rate of an oxygen-containing atmosphere in the kiln is preferably controlled. For example, the flow rate of an oxygen-containing atmosphere is preferably set low, or no flowing of an atmosphere is preferably performed after an atmosphere is purged first and an oxygen atmosphere is introduced into the kiln. Flowing of oxygen is not preferable because it might cause evaporation of the fluorine source, which prevents maintaining the smoothness of the surface.

In the case of using a roller hearth kiln for the heating, the mixture 903 can be heated in an atmosphere containing LiF with the container containing the mixture 903 covered with a lid, for example.

### <Step S34>

Next, the heated material is collected in Step S34 shown in FIG. 5A, in which crushing is performed as needed; thus, a positive electrode active material 100 is obtained. Here, the collected positive electrode active material 100 is preferably made to pass through a sieve. Through the above process, the positive electrode active material 100 (composite oxide) with a median diameter (D50) of less than or equal to 12 μm (preferably less than or equal to 10.5 μm, further preferably less than or equal to 8 μm) can be formed. Note that the positive electrode active material 100 contains the additive element A.

### Example 2 of Method for Forming Positive Electrode Active Material

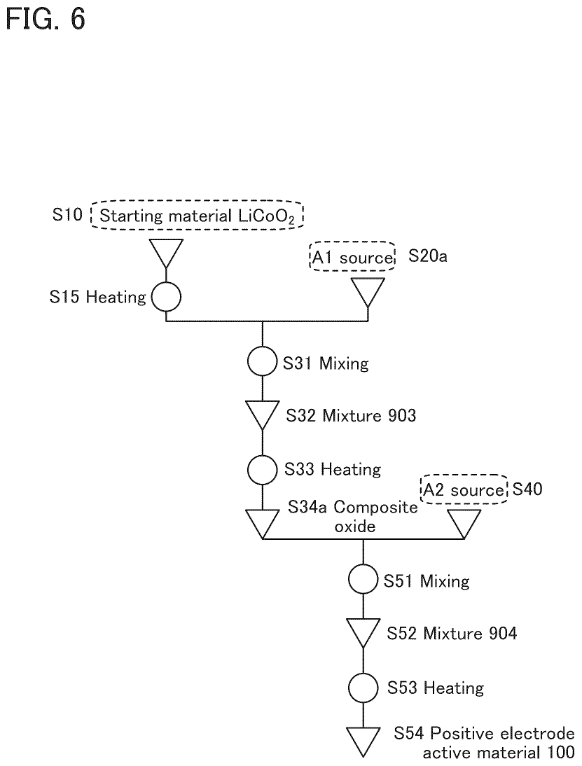

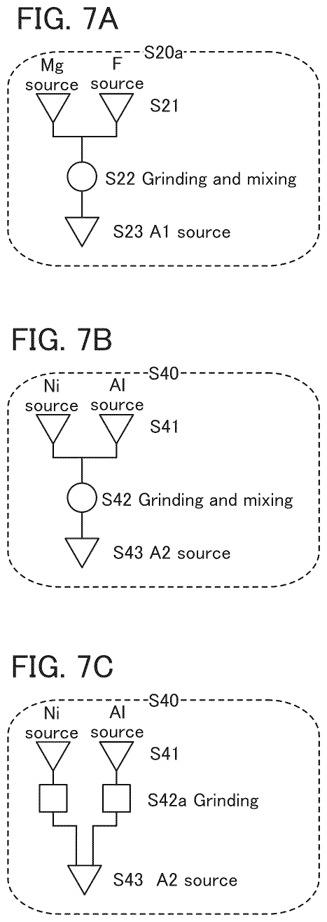

Another example of a method for forming the positive electrode active material that can be used as one embodiment of the present invention (Example 2 of method for forming positive electrode active material) is described with reference to FIG. 6 and FIG. 7. Although Example 2 of method for forming positive electrode active material is different from Example 1 of method for forming positive electrode active material described above in the number of times of adding the additive element and a mixing method, for the description except for the above, the description of Example 1 of method for forming positive electrode active material can be referred to.

Step S10 to Step S15 in FIG. 6 are performed as in FIG. 5A to prepare lithium cobalt oxide that has been subjected to the initial heating. Note that Step S15 is not essential in one embodiment of the present invention, thus, an embodiment in which Step S15 is skipped is also included in one embodiment of the present invention.

### <Step S20a>

Next, as shown in Step S20a, a first additive element A1 source (A1 source) is prepared. Step S20a is described in detail with reference to FIG. 7A.

### <Step S21>

In Step S21 shown in FIG. 7A, the first additive element A1 source (A1 source) is prepared. The A1 source can be selected from the additive elements A described for Step S21 shown in FIG. 5C to be used. For example, one or more selected from magnesium, fluorine, and calcium can be used as the additive element A1. FIG. 7A shows an example of the case where a magnesium source (Mg source) and a fluorine source (F source) are used as the additive element A1.

Step S21 to Step S23 shown in FIG. 7A can be performed under the same conditions as those in Step S21 to Step S23 shown in FIG. 5C. As a result, the first additive element A1 source (A1 source) can be obtained in Step S23.

Steps S31 to S33 shown in FIG. 6 can be performed under the same conditions as those in Steps S31 to S33 shown in FIG. 5A.

### <Step S34a>

Next, the material heated in Step S33 is collected to obtain lithium cobalt oxide containing the additive element A1. Here, the composite oxide is called a second composite oxide to be distinguished from the lithium cobalt oxide that has been subjected to Step S15 (first composite oxide).

### <Step S40>

In Step S40 shown in FIG. 6, a second additive element A2 source (A2 source) is prepared. Step S40 is described with reference to FIG. 7B and FIG. 7C.

### <Step S41>

In Step S40 shown in FIG. 7B, the second additive element A2 source (A2 source) is prepared. The A2 source can be selected from the additive elements A described for Step S20 shown in FIG. 5C. For example, one or more selected from nickel, titanium, boron, zirconium, and aluminum can be suitably used as the additive element A2. FIG. 7B shows an example of the case where a nickel source and an aluminum source are used as the additive element A2.

Step S41 to Step S43 shown in FIG. 7B can be performed under the same conditions as those in Step S21 to Step S23 shown in FIG. 5C. As a result, the second additive element A2 source (A2 source) can be obtained in Step S43.

FIG. 7C showing Step S41 to Step S43 is a modification example of FIG. 7B. A nickel source (Ni source) and an aluminum source (Al source) are prepared in Step S41 shown in FIG. 7C and are separately ground in Step S42a. Accordingly, a plurality of the second additive element A2 sources (A2 sources) are prepared in Step S43. As described above, Step S40 in FIG. 7C is different from Step S40 in FIG. 7B in that the additive elements are separately ground in Step S42a.

### <Step S51 to Step S53>

Next, Step S51 to Step S53 shown in FIG. 6 can be performed under the same conditions as those in Step S31 to Step S33 shown in FIG. 5A. The heating in Step S53 is preferably performed at a lower temperature and/or in a shorter time than the heating in Step S33 shown in FIG. 6. Specifically, the heating temperature is preferably higher than or equal to 800° C. and lower than or equal to 950° C., further preferably at higher than or equal to 820° C., and lower than or equal to 870° C., still further preferably at 850° C.±10° C. The heating time is preferably longer than or equal to 0.5 hours and shorter than or equal to 8 hours, further preferably longer than or equal to 1 hour and shorter than or equal to 5 hours.

When nickel is selected as the second additive element A2, the mixing in Step S51 is preferably performed such that the number of nickel atoms in the nickel source is greater than or equal to 0.05% and less than or equal to 4% of the number of cobalt atoms in the lithium cobalt oxide that has been subjected to Step S15. When aluminum is selected as the additive element A2, the mixing in Step S51 is preferably performed such that the number of aluminum atoms in the aluminum source is greater than or equal to 0.05% and less than or equal to 4% of the number of cobalt atoms in the lithium cobalt oxide that has been subjected to Step S15.

### <Step S54>

Next, the heated material is collected in Step S54 shown in FIG. 6, in which crushing is performed as needed; thus, the positive electrode active material 100 is obtained. Through the above process, the positive electrode active material 100 (composite oxide) with a median diameter of less than or equal to 12 μm (preferably less than or equal to 10.5 μm, further preferably less than or equal to 8 μm) can be formed. Alternatively, the positive electrode active material 100 applicable to a lithium ion battery having excellent discharge characteristics even in a low-temperature environment can be formed. Note that the positive electrode active material 100 contains the first additive element A1 and the second additive element A2.

In the example 2 of a formation method described above, as shown in FIG. 6 and FIG. 7, introduction of the additive element to the lithium cobalt oxide is divided into introduction of the first additive element A1 and that of the second additive element A2. When the elements are separately introduced, the additive elements can have different profiles in the depth direction. For example, the first additive element can have a profile such that the concentration is higher in the surface portion than in the inner portion, and the second additive element can have a profile such that the concentration is higher in the inner portion than in the surface portion. The positive electrode active material 100 formed through the steps in FIG. 5A and FIG. 5D has an advantage of being formed at low cost since a plurality of kinds of additive elements A are added at the same time. Meanwhile, although the formation cost of the positive electrode active material 100 formed through FIG. 6 and FIG. 7 is relatively high since a plurality of kinds of additive elements A are added in a plurality of steps, a profile of each of the additive elements A in the depth direction can be accurately controlled, which is preferable.

### <Conductive Material>

A conductive material is also referred to as a conductivity-imparting agent or a conductive additive, and a carbon material can be used as the conductive material. A conductive material is attached between a plurality of active materials, whereby the plurality of active materials are electrically connected to each other, and the conductivity increases. Note that in this specification and the like, the term “attach” refers not only to a state where an active material and a conductive material are physically in close contact with each other, and includes, for example, the following concepts, the case where covalent bonding occurs, the case where bonding with the Van der Waals force occurs, the case where a conductive material covers part of the surface of an active material, the case where a conductive material is embedded in surface roughness of an active material, and the case where an active material and a conductive additive are electrically connected to each other without being in contact with each other.

Specific examples of carbon materials that can be used as the conductive material include carbon black (e.g., furnace black, acetylene black, or graphite).

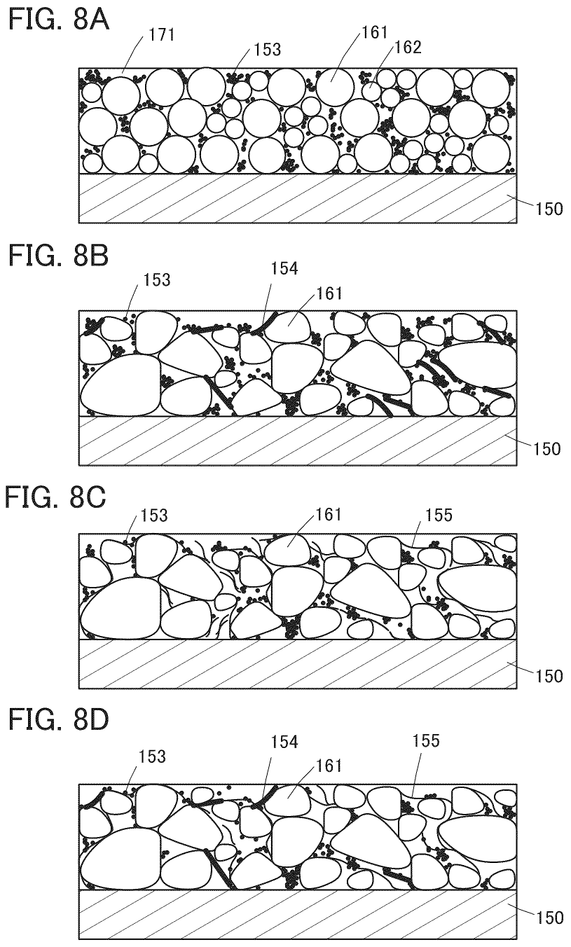

FIG. 8A illustrates a carbon black 153, which is an example of a conductive material, and an electrolyte 171, which is included in a space portion positioned between active materials 161.

In the positive electrode of the secondary battery, a binder (a resin) may be mixed in order to fix a current collector 150 such as metal foil and the active material. The binder is also referred to as a binding agent. Since the binder is a high molecular material, a large amount of the binder lowers the proportion of the active material in the positive electrode, thereby reducing the discharge capacity of the secondary battery. Therefore, the amount of binder mixed is preferably reduced to a minimum. In FIG. 8A, the region not filled with the active material 161, a second active material 162, or the carbon black 153 indicates a space or a binder.

Although FIG. 8A shows an example in which the active material 161 has a spherical shape, there is no particular limitation and other various shapes can be employed. The cross-sectional shape of the active material 161 may be an ellipse, a rectangle, a trapezoid, a triangle, a quadrilateral with rounded corners, or an asymmetrical shape, for example. For example, FIG. 8B illustrates an example in which the active material 161 has a polygon shape with rounded corners.

In the positive electrode in FIG. 8B, graphene 154 is used as a carbon material used as the conductive material. In FIG. 8B, a positive electrode active material layer including the active material 161, the graphene 154, and the carbon black 153 is formed over the current collector 150.

In the step of mixing the graphene 154 and the carbon black 153 to obtain an electrode slurry, the weight of mixed carbon black is preferably 1.5 times to 20 times, further preferably 2 times to 9.5 times the weight of graphene.

When the graphene 154 and the carbon black 153 are mixed in the above range, the carbon black 153 is excellent in dispersion stability and an aggregated portion is unlikely to be generated at the time of preparing a slurry. Furthermore, when the graphene 154 and the carbon black 153 are mixed in the above range, the electrode density can be higher than that of a positive electrode using only the carbon black 153 as a conductive material. As the electrode density is higher, the capacity per unit weight can be higher. Specifically, the density of the positive electrode active material layer measured by gravimetry can be higher than or equal to 3.5 g/cc.

The electrode density is lower than that of a positive electrode containing only graphene as a conductive material, but when a first carbon material (graphene) and a second carbon material (acetylene black) are mixed in the above range, fast charge can be achieved. Thus, use of such a mixed conductive additive for secondary batteries for vehicles is particularly effective.

FIG. 8C shows an example of a positive electrode in which carbon fiber 155 is used instead of graphene. FIG. 8C illustrates an example different from FIG. 8B. With use of the carbon fiber 155, aggregation of carbon black 153 can be prevented and the dispersibility can be increased.

In FIG. 8C, the region that is not filled with the active material 161, the carbon fiber 155, or the carbon black 153 represents a space or a binder.

FIG. 8D illustrates another example of a positive electrode. FIG. 8C shows an example in which the carbon fiber 155 is used in addition to the graphene 154. With use of both the graphene 154 and the carbon fiber 155, aggregation of carbon black such as the carbon black 153 can be prevented and the dispersibility can be further increased.

In FIG. 8D, the region that is not filled with the active material 161, the carbon fiber 155, the graphene 154, or the carbon black 153 indicates a space or a binder.

### <Binder>

As the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Fluororubber can also be used as the binder.

As the binder, for example, water-soluble polymers are preferably used. As the water-soluble polymers, a polysaccharide can be used, for example. As the polysaccharide, starch, a cellulose derivative such as carboxymethyl cellulose (CMC), methyl cellulose, ethyl cellulose, hydroxypropyl cellulose, diacetyl cellulose, or regenerated cellulose, or the like can be used. It is further preferable that such a water-soluble polymer be used in combination with any of the above rubber materials.

Alternatively, as the binder, a material such as polystyrene, poly(methyl acrylate), poly(methyl methacrylate)(PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, polyvinylidene fluoride (PVDF), polyacrylonitrile (PAN), ethylene-propylene-diene polymer, polyvinyl acetate, or nitrocellulose is preferably used.

Two or more of the above materials may be used in combination for the binder.

For example, a material having a significant viscosity modifying effect and another material may be used in combination. For example, a rubber material or the like has high adhesion and high elasticity but may have difficulty in viscosity modification when mixed in a solvent. In such a case, a rubber material or the like is preferably mixed with a material having a significant viscosity modifying effect, for example. As a material having a significant viscosity modifying effect, for instance, a water-soluble polymer is preferably used. As a water-soluble polymer having a significant viscosity modifying effect, the above-mentioned polysaccharide or, for instance, a cellulose derivative such as carboxymethyl cellulose (CMC), methyl cellulose, ethyl cellulose, hydroxypropyl cellulose, diacetyl cellulose, or regenerated cellulose and starch can be used.

Note that a cellulose derivative such as carboxymethyl cellulose obtains a higher solubility when converted into a salt such as a sodium salt or an ammonium salt of carboxymethyl cellulose, and thus easily exerts an effect as a viscosity modifier. A high solubility can also increase the dispersibility of an active material or other components in the formation of slurry for an electrode. In this specification and the like, cellulose and a cellulose derivative used as a binder of an electrode include salts thereof.

A water-soluble polymer stabilizes the viscosity by being dissolved in water and allows stable dispersion of the active material and another material combined as a binder, such as styrene-butadiene rubber, in an aqueous solution. Furthermore, a water-soluble polymer is expected to be easily and stably adsorbed onto an active material surface because it has a functional group. Many cellulose derivatives, such as carboxymethyl cellulose, have a functional group such as a hydroxyl group or a carboxyl group. Because of functional groups, polymers are expected to interact with each other and cover an active material surface in a large area.

In the case where the binder that covers or is in contact with the active material surface forms a film, the film is expected to serve also as a passivation film to suppress the decomposition of the electrolyte solution. Here, a passivation film refers to a film without electric conductivity or a film with extremely low electric conductivity, and can inhibit the decomposition of an electrolyte solution at a potential at which a battery reaction occurs when the passivation film is formed on the active material surface, for example. It is further desirable that the passivation film can conduct lithium ions while inhibiting electrical conduction.

### <Positive Electrode Current Collector>

The positive electrode current collector can be formed using a material that has high conductivity, such as a metal like stainless steel, gold, platinum, aluminum, or titanium, or an alloy thereof. It is preferable that a material used for the positive electrode current collector not be eluted at the potential of the positive electrode. Alternatively, it is possible to use an aluminum alloy to which an element that improves heat resistance, such as silicon, titanium, neodymium, scandium, or molybdenum, is added. A metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The positive electrode current collector can have a foil-like shape, a plate-like shape, a sheet-like shape, a net-like shape, a punching-metal shape, an expanded-metal shape, or the like as appropriate. The positive electrode current collector preferably has a thickness greater than or equal to 5 μm and less than or equal to 30 μm.

### [Negative Electrode]

The negative electrode includes a negative electrode active material layer and a negative electrode current collector. The negative electrode active material layer includes a negative electrode active material, and may further contain a conductive material and a binder.

### <Negative Electrode>

As a negative electrode active material, for example, an alloy-based material or a carbon material can be used.

As the negative electrode active material, an element that enables charge and discharge reaction by alloying reaction and dealloying reaction with lithium can be used. For example, a material containing at least one of silicon, tin, gallium, aluminum, germanium, lead, antimony, bismuth, silver, zinc, cadmium, indium, and the like can be used. Such elements have higher capacity than carbon, and especially, silicon has a high theoretical capacity of 4200 mAh/g. For this reason, silicon is preferably used as the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by an alloying and a dealloying reaction with lithium and a compound containing the element, for example, are referred to as alloy-based materials in some cases.

In this specification and the like, SiO refers, for example, to silicon monoxide. Alternatively. SiO can be expressed as SiOₓ. Here, it is preferable that x be 1 or have an approximate value of 1. For example, x is preferably greater than or equal to 0.2 and less than or equal to 1.5, or preferably greater than or equal to 0.3 and less than or equal to 1.2.

As the carbon material, graphite, graphitizing carbon (soft carbon), non-graphitizing carbon (hard carbon), carbon fiber (carbon nanotube), graphene, carbon black, or the like is used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it can relatively easily have a small surface area. Examples of natural graphite include flake graphite and spherical natural graphite.

Graphite has a low potential substantially equal to that of a lithium metal (higher than or equal to 0.05 V and lower than or equal to 0.3 V vs. Li/Li⁺) when lithium ions are inserted into graphite (while a lithium-graphite intercalation compound is formed). For this reason, a lithium ion battery using graphite can have a high operating voltage. In addition, graphite is preferred because of its advantages such as a relatively high capacity per unit volume, relatively small volume expansion, low cost, and a higher level of safety than that of a lithium metal.

As the negative electrode active material, an oxide such as titanium dioxide (TiO₂), lithium titanium oxide (Li₄TisO₁₂), a lithium-graphite intercalation compound (LiₓC₆), niobium pentoxide (Nb₂O₅), tungsten oxide (WO₂), or molybdenum oxide (MoO₂) can be used.

Alternatively, as the negative electrode active material, Li₃₋ₓMₓN (M=Co, Ni, or Cu) with a Li₃N structure, which is a composite nitride of lithium and a transition metal, can be used. For example, Li_{2.6}Co_{0.4}N₃ is preferable because of its high charge and discharge capacity (900 mAh/g and 1890 mAh/cm³).

A composite nitride of lithium and a transition metal is preferably used, in which case lithium ions are contained in the negative electrode active material and thus the negative electrode active material can be used in combination with a material for a positive electrode active material that does not contain lithium ions, such as V₂O₅ or Cr₃O₈. Note that even in the case of using a material containing lithium ions as a positive electrode active material, the composite nitride of lithium and a transition metal can be used as the negative electrode active material by extracting the lithium ions contained in the positive electrode active material in advance.

Alternatively, a material that causes a conversion reaction can be used for the negative electrode active material. For example, a transition metal oxide that does not form an alloy with lithium, such as cobalt oxide (CoO), nickel oxide (NiO), or iron oxide (FeO), may be used as the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF and BiF₃.

For the conductive material and the binder that can be contained in the negative electrode active material layer, materials similar to those of the conductive material and the binder that can be contained in the positive electrode active material layer can be used.

### <Negative Electrode Current Collector>

For the negative electrode current collector, copper or the like can be used in addition to a material similar to that of the positive electrode current collector. Note that a material that is not alloyed with carrier ions of lithium or the like is preferably used for the negative electrode current collector.

### <Electrolyte>

For the electrolyte used as one embodiment of the present invention, a material with high lithium ion conductivity in charge and/or discharge (charge and discharge) even in a low-temperature environment (e.g., 0° C., −20° C., preferably −30° C., further preferably −40° C., still further preferably −50° C., most preferably −60° C.) can be used.

An example of an electrolyte is described below. Note that although the electrolyte described as an example in this embodiment is an organic solvent in which a lithium salt is dissolved and can be referred to as an electrolyte solution, the electrolyte is not limited to a liquid electrolyte (an electrolyte solution) that is liquid at room temperature and can be a solid electrolyte. Alternatively, an electrolyte including both a liquid electrolyte that is liquid at room temperature and a liquid electrolyte that is a solid at room temperature (such an electrolyte is referred to as a semi-solid electrolyte) can also be used.

For example, an organic solvent described in this embodiment contains ethylene carbonate (EC), ethyl methyl carbonate (EMC), and dimethyl carbonate (DMC). When a total content of the ethylene carbonate, the ethyl methyl carbonate, and the dimethyl carbonate is set to 100 vol %, an organic solvent in which the volume ratio between the ethylene carbonate, the ethyl methyl carbonate, and the dimethyl carbonate is x:y 100-x-y (where 5≤x≤35 and 0<y<65) can be used. More specifically, an organic solvent containing EC, EMC, and DMC at EC:EMC:DMC=30:35:35 (volume ratio) can be used. Note that the volume ratio may be a volume ratio of the organic solvent before mixing, and the organic solvent may be mixed at room temperature (typically 25° C.).

EC is cyclic carbonate and has high dielectric constant, and thus has an effect of promoting dissociation of a lithium salt. Meanwhile, the EC has high viscosity and has a high freezing point (melting point) of 38° C.; thus, it is difficult to use in a low-temperature environment when EC is used alone as the organic solvent. Then, the organic solvent specifically described in one embodiment of the present invention includes not only EC but also EMC and DMC. EMC is a chain-like carbonate and has an effect of decreasing the viscosity of the electrolyte solution, and the freezing point is −54° C. In addition, DMC is also a chain-like carbonate and has an effect of decreasing the viscosity of the electrolyte solution, and the freezing point is −43° C. An electrolyte formed using a mixed organic solvent in a volume ratio of x:yL100-x-y (note that 5≤x≤35 and 0<y<65) with a total content of these three organic solvents of EC, EMC, and DMC having such physical properties of 100 vol % has a characteristic in which the freezing point is lower than or equal to −40° C.

A general electrolyte used for a lithium ion battery is solidified at approximately −20° C.; thus, it is difficult to fabricate a battery that can be charged and discharged at −40° C. Since the electrolyte described as an example in this embodiment has a freezing point lower than or equal to −40° C., a lithium ion battery that can be charged and discharged even in an extremely low-temperature environment such as at −40° C. can be obtained.

As the electrolyte dissolved in the solvent, a lithium salt can be used. For example, one of lithium salts such as LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(C₄F₃SO₂)₃, LiC(C₂F₅SO₂)₃, LiN(CF₃SO₂)₂, LiN(C₄F₉SO₂) (CF₃SO₂), LiN(C₂F₅SO₂)₂, and lithium bis(oxalate)borate (LiBOB) can be used, or two or more of these lithium salts can be used in an appropriate combination with an appropriate ratio.

The electrolyte solution is preferably highly purified and contains a small amount of dust particles and elements other than the constituent elements of the electrolyte solution (hereinafter, also simply referred to as “impurities”). Specifically, the weight ratio of impurities to the electrolyte solution is preferably less than or equal to 1%, further preferably less than or equal to 0.1%, still further preferably less than or equal to 0.01%.

In order to form a coating film (Solid Electrolyte Interphase) at the interface between an electrode (active material layer) and the electrolyte solution for the purpose of improvement of the safety or the like, an additive agent such as vinylene carbonate (VC), propane sultone (PS), tert-butylbenzene (TBB), fluoroethylene carbonate (FEC), lithium bis(oxalate)borate (LiBOB), or a dinitrile compound such as succinonitrile or adiponitrile may be added to the electrolyte solution. The concentration of such an additive agent in the solvent is, for example, higher than or equal to 0.1 wt % and lower than or equal to 5 wt %.

Although an example of an electrolyte that can be used for the lithium ion battery of one embodiment of the present invention is described above, the electrolyte that can be used for the lithium ion battery of one embodiment of the present invention should not be construed as being limited to the example. Another material can be used as long as it has high lithium ion conductivity even when charge and discharge are performed in a low-temperature environment.

### [Separator]

When the electrolyte includes an electrolyte solution, a separator is positioned between the positive electrode and the negative electrode. The separator can be formed using, for example, a fiber containing cellulose, such as paper, nonwoven fabric, glass fiber, ceramics, or synthetic fiber containing nylon (polyamide), vinylon (polyvinyl alcohol-based fiber), polyester, acrylic, polyolefin, or polyurethane. The separator is preferably processed into a bag-like shape to enclose one of the positive electrode and the negative electrode.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramic-based material, the oxidation resistance is improved; hence, degradation of the separator during high-voltage charging and discharging can be inhibited and thus the reliability of the secondary battery can be improved. When the separator is coated with the fluorine-based material, the separator is easily brought into close contact with an electrode, resulting in high output characteristics. When the separator is coated with the polyamide-based material, in particular, aramid, the heat resistance is improved; thus, the safety of the secondary battery can be improved.

For example, both surfaces of a polypropylene film may be coated with a mixed material of aluminum oxide and aramid. Alternatively, a surface of a polypropylene film that is to be in contact with the positive electrode may be coated with the mixed material of aluminum oxide and aramid, and a surface of the polypropylene film that is to be in contact with the negative electrode may be coated with the fluorine-based material.

With use of a separator having a multilayer structure, the capacity per volume of the secondary battery can be increased because the safety of the secondary battery can be maintained even when the total thickness of the separator is small.

### [Exterior Body]

For an exterior body included in the secondary battery, a metal material such as aluminum or a resin material can be used, for example. A film-like exterior body can also be used. As the film, for example, it is possible to use a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

The lithium ion battery of one embodiment of the present invention includes at least the above positive electrode active material and the above electrolyte, thereby achieving excellent discharge characteristics and/or excellent charge characteristics even in a low-temperature environment. More specifically, the following lithium ion battery can be achieved. At least the above positive electrode active material and the above electrolyte are included; and when a test battery is formed using a lithium metal as a negative electrode, a discharge capacity value of the test battery obtained by, after performing constant current charge at a charge rate of 0. 1 C or 0.2 C (where 1 C=200 mA/g) until a voltage reaches 4.6 V in an environment of 25° C., performing constant current discharge at a discharge rate of 0.1 C until a voltage reaches 2.5 V in an environment of −40° C. is higher than or equal to 50% of a discharge capacity value of the test battery obtained by, after performing constant current charge at a charge rate of 0.1 C or 0.2 C (where 1 C=200 mA/g) until a voltage reaches 4.6 V in an environment of 25° C., performing constant current discharge at a discharge rate of 0.1 C until a voltage reaches 2.5 V in an environment of 25° C. In this specification and the like, when the discharge capacity at T ° C. (T is given temperature (° C.)) can be higher than or equal to 50% of the discharge capacity in an environment of 25° C., it can be said that the lithium ion battery can be operated at T ° C.

The contents of this embodiment can be freely combined with the contents of the other embodiments.

### Embodiment 3

In this embodiment, a secondary battery structure that is required to achieve a secondary battery having high charge and discharge characteristics and high cycle performance in a middle temperature range is described. A positive electrode active material that is included in a positive electrode and an electrolyte are mainly described. Note that the middle temperature range refers to, for example, higher than or equal to 0° C., and lower than or equal to 45° C., preferably higher than or equal to 0° C., and lower than or equal to 65° C., further preferably higher than or equal to 0° C., and lower than or equal to 85° C.

### [Lithium Ion Battery]

A lithium ion battery of one embodiment of the present invention includes a positive electrode, a negative electrode, and an electrolyte. When the electrolyte includes an electrolyte solution, a separator is provided between the positive electrode and the negative electrode. An exterior body covering at least part of peripheries of the positive electrode, the negative electrode, and the electrolyte may be further provided.

### [Positive Electrode]

A positive electrode includes a positive electrode active material layer and a positive electrode current collector. The positive electrode active material layer includes a positive electrode active material and may further include at least one of a conductive material and a binder. Note that the positive electrode current collector, the conductive material, and the binder described in Embodiment 2 can be used.

### <Positive Electrode Active Material>

A positive electrode active material applicable to a lithium ion battery having high charge and discharge characteristics and high cycle performance in a middle temperature range is described. As the positive electrode active material, lithium cobalt oxide, lithium nickel-cobalt-manganese oxide, and/or lithium iron phosphate can be used. As the lithium cobalt oxide, it is preferable to use a lithium cobalt oxide to which magnesium and fluorine are added and a lithium cobalt oxide to which magnesium, fluorine, aluminum, and nickel are added, for example. As the lithium nickel-cobalt-manganese oxide, for example, lithium nickel-cobalt-manganese oxide with a ratio such as nickel:cobalt:manganese=8:1:1, nickel:cobalt:manganese=9:0.5:0.5, or the like can be used. As the above-described lithium nickel-cobalt-manganese oxide, for example, lithium nickel-cobalt-manganese oxide to which one or more of aluminum, calcium, barium, strontium, and gallium are added is preferably used. As the lithium iron phosphate, it is possible to use, in addition to lithium iron phosphate represented by LiFePO₄, for example, LiFeₐNi_{b}PO₄, LiFeₐCo_{b}PO₄, LiFeₐMn_{b}PO₄ (a+b is 1 or less, 0<a<1, and 0<b<1), LiFe_{c}Ni_{d}CoₑPO₄, LiFe_{c}Ni_{d}MnₑPO₄ (c+d+e is 1 or less, 0<c<1, 0<d<1, and 0<e<1), and LiFe₁Ni_{g}CoₕMnᵢPO₄ (f+g+h+i is 1 or less, 0<f<1, 0<g<1, 0<h<1, and 0<i<1), in each of which part of Fe is replaced with Mn, Ni, Co, or the like.

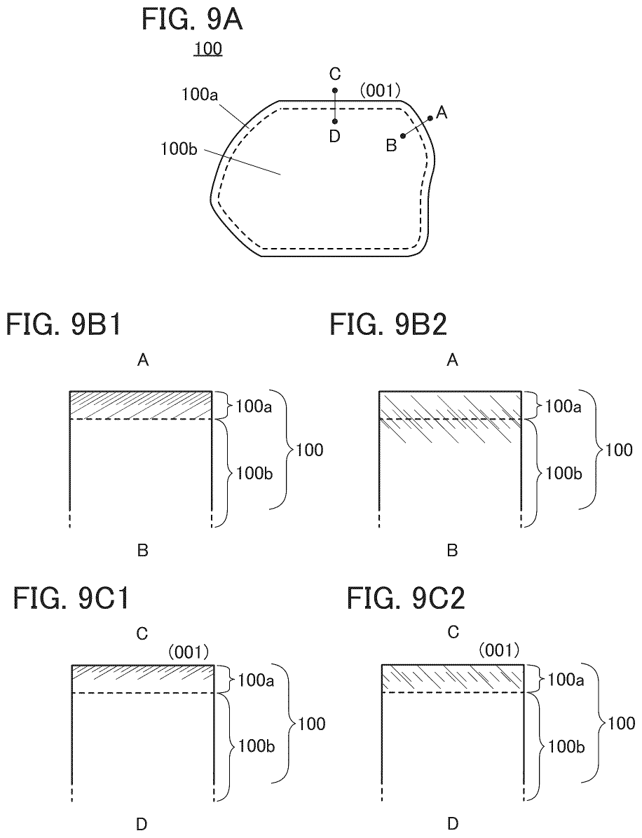

Next, a favorable example of the case where lithium cobalt oxide is used as a positive electrode active material is described with reference to FIG. 9A to FIG. 14.

FIG. 9A is a cross-sectional view of the positive electrode active material 100 that can be used for a secondary battery of one embodiment of the present invention. FIG. 9B1 and FIG. 9B2 illustrate enlarged views of a portion near A-B in FIG. 9A. FIG. 9C1 and FIG. 9C2 illustrate enlarged views of a portion near the line C-D in FIG. 9A.

As illustrated in FIG. 9A to FIG. 9C2, the positive electrode active material 100 includes a surface portion 100a and an inner portion 100b. In each drawing, a dashed line denotes a boundary between the surface portion 100a and the inner portion 100b.

In this specification and the like, the surface portion 100a of the positive electrode active material 100 refers to a region that is within 50 nm, preferably within 35 nm, further preferably within 20 nm in depth from the surface toward the inner portion, and most preferably a region positioned within 10 nm in depth from the surface toward the inner portion. A plane generated by a split and/or a crack can be regarded as a surface. The surface portion 100a can be rephrased as the vicinity of a surface, a region in the vicinity of a surface, or a shell.

The inner portion 100b refers to a region deeper than the surface portion 100a of the positive electrode active material. The inner portion 100b can be rephrased as an inner region or a core.

A surface of the positive electrode active material 100 refers to a surface of a composite oxide including the surface portion 100a, the inner portion 100b, a convex portion, and the like. Thus, the positive electrode active material 100 does not include a carbonate, a hydroxy group, or the like which is chemically adsorbed after formation of the positive electrode active material 100. Furthermore, an electrolyte, a binder, a conductive material, and a compound originating from any of these that are attached to the positive electrode active material 100 are not included either. The surface of the positive electrode active material 100 in, for example, a cross-sectional STEM (scanning transmission electron microscope) image is a boundary between a region where a bonding image of an electron is observed and a region where the image is not observed, and is determined as the outermost surface of a region where a bright spot derived from an atomic nucleus of a metal element that has a larger atomic number than lithium is observed. The surface in a cross-sectional STEM image or the like may be determined also on the basis of higher spatial-resolution analysis results, e.g., electron energy loss spectroscopy (EELS).

The crystal grain boundary refers to, for example, a portion where particles of the positive electrode active material 100 adhere to each other or a portion where a crystal orientation changes inside the positive electrode active material 100, i.e., a portion where repetition of bright lines and dark lines is discontinuous in a STEM image or the like, a portion including a large number of crystal defects, a portion with a disordered crystal structure, or the like. A crystal defect refers to a defect that can be observed in a cross-sectional TEM (transmission electron microscope) image, a cross-sectional STEM image, or the like, i.e., a structure containing another atom between lattices, a hollow, or the like. The crystal grain boundary is one of plane defects. The vicinity of the crystal grain boundary refers to a region positioned within 10 nm from the crystal grain boundary.

### <Contained Element>

The positive electrode active material 100 contains lithium, a transition metal M, oxygen, and the additive element A. Alternatively, the positive electrode active material 100 can contain a composite oxide (LiMO₂) containing lithium and the transition metal M to which the additive element A is added. Note that the composition of the composite oxide is not strictly limited to Li:M:O=1:1:2. In some cases, a positive electrode active material to which the additive element A is added is referred to as a composite oxide.

A positive electrode active material of a lithium-ion secondary battery needs to contain a transition metal which can take part in an oxidation-reduction reaction in order to maintain a neutrally charged state even when lithium ions are inserted and extracted. It is preferable that the positive electrode active material 100 of one embodiment of the present invention mainly contain cobalt as the transition metal M taking part in an oxidation-reduction reaction. In addition to cobalt, at least one or two selected from nickel and manganese may be used. Using cobalt at greater than or equal to 75 at %, preferably higher than or equal to 90 at %, further preferably higher than or equal to 95 at % as the transition metal M contained in the positive electrode active material 100 brings many advantages such as relatively easy synthesis, easy handling, and excellent cycle performance, which is preferable.

When cobalt is used as the transition metal M contained in the positive electrode active material 100 at greater than or equal to 75 at %, preferably greater than or equal to 90 at %, further preferably greater than or equal to 95 at %, LiₓCoO₂ with small x is more stable than a composite oxide in which nickel accounts for the majority of the transition metal M, such as lithium nickel oxide (LiNiO₂). This is probably because the influence of distortion by the Jahn-Teller effect is smaller in the case of using cobalt than in the case of using nickel. The Jahn-Teller effect in a transition metal compound varies in degree according to the number of electrons in the d orbital of the transition metal. The influence of the Jahn-Teller effect is large in a composite oxide having a layered rock-salt crystal structure, such as lithium nickel oxide, in which octahedral coordinated low-spin nickel(III) accounts for the majority of the transition metal, and a layer having an octahedral structure formed of nickel and oxygen is likely to be distorted. Thus, there is a concern that the crystal structure might break in charge and discharge cycles. The size of a nickel ion is larger than the size of a cobalt ion and close to that of a lithium ion. Thus, there is a problem in that cation mixing between nickel and lithium is likely to occur in a composite oxide having a layered rock-salt crystal structure in which nickel accounts for the majority of the transition metal, such as lithium nickel oxide.

Using nickel at greater than or equal to 33 at %, preferably greater than or equal to 60 at %, further preferably greater than or equal to 80 at % as the transition metal M contained in the positive electrode active material 100 is preferable because in that case, the cost of the raw materials might be lower than that in the case of using a large amount of cobalt and charge and discharge capacity per weight might be increased.

As the additive element A contained in the positive electrode active material 100, one or two or more selected from magnesium, fluorine, nickel, aluminum, barium, titanium, zirconium, vanadium, iron, manganese, chromium, niobium, arsenic, zinc, silicon, sulfur, phosphorus, boron, bromine, and beryllium is preferably used. The total percentage of the transition metal among the additive elements A is preferably less than 25 at %, further preferably less than 10 at %, still further preferably less than 5 at %.

That is, the positive electrode active material 100 can contain lithium cobalt oxide to which magnesium and fluorine are added, lithium cobalt oxide to which magnesium, fluorine, and titanium are added, lithium cobalt oxide to which magnesium, fluorine, and aluminum are added, lithium cobalt oxide to which magnesium, fluorine, and nickel are added, lithium cobalt oxide to which magnesium, fluorine, nickel, and aluminum are added, or the like.

These additive elements A further stabilize the crystal structure of the positive electrode active material 100 as described later. In this specification and the like, the additive element A can be rephrased as part of a raw material or a mixture.

Note that as the additive element A, magnesium, fluorine, nickel, aluminum, barium, titanium, zirconium, vanadium, iron, manganese, chromium, niobium, arsenic, zinc, silicon, sulfur, phosphorus, boron, bromine, or beryllium is not necessarily contained.

For example, when the positive electrode active material 100 is substantially free from manganese, the above advantages such as relatively easy synthesis, easy handling, and excellent cycle performance are sometimes enhanced. The weight of manganese contained in the positive electrode active material 100 is preferably less than or equal to 600 ppm, further preferably less than or equal to 100 ppm, for example. The weight of manganese can be analyzed by GD-MS, for example.

### <Crystal Structure>

<x in LiₓCoO₂ being 1>

The positive electrode active material 100 of one embodiment of the present invention preferably has a layered rock-salt crystal structure belonging to the space group R-3m in a discharged state, i.e., a state where x in LiₓCoO₂ is 1. A composite oxide having a layered rock-salt structure excels as a positive electrode active material of a secondary battery because it has high discharge capacity and a two-dimensional diffusion path for lithium ions and is thus suitable for an insertion/extraction reaction of lithium ions. For this reason, it is particularly preferable that an inner portion 100b, which accounts for the majority of the volume of the positive electrode active material 100, have a layered rock-salt crystal structure.

Meanwhile, the surface portion 100a of the positive electrode active material 100 of one embodiment of the present invention preferably has a function of reinforcing the layered structure, which is formed of octahedrons of the transition metal M and oxygen, of the inner portion 100b so that the layered structure does not break even when lithium is extracted from the positive electrode active material 100 by charge. Alternatively, the surface portion 100a preferably functions as a barrier film of the positive electrode active material 10). Alternatively, the surface portion 100a, which is the outer portion of the positive electrode active material 100, preferably reinforces the positive electrode active material 100. Here, the term “reinforce” means inhibition of a change in the structures of the surface portion 100a and the inner portion 100b of the positive electrode active material 100 such as extraction of oxygen and/or inhibition of oxidative decomposition of an electrolyte on the surface of the positive electrode active material 100.

Accordingly, the surface portion 100a preferably has a crystal structure different from that of the inner portion 100b. The surface portion 100a preferably has a more stable composition and a more stable crystal structure than those of the inner portion 100b at room temperature (25° C.). For example, at least part of the surface portion 100a of the positive electrode active material 100 of one embodiment of the present invention preferably has the rock-salt crystal structure. Alternatively, the surface portion 100a preferably has both a layered rock-salt crystal structure and a rock-salt crystal structure. Alternatively, the surface portion 100a preferably has features of both a layered rock-salt crystal structure and a rock-salt crystal structure.

The surface portion 100a is a region from which lithium ions are extracted initially in charge, and is a region that tends to have a lower concentration of lithium than the inner portion 100b. Bonds between atoms are regarded as being partly cut on the surface of the positive electrode active material 100 included in the surface portion 100a. Thus, the surface portion 100a is regarded as a region that tends to be unstable and easily starts deterioration of the crystal structure. Meanwhile, when the surface portion 100a can be made sufficiently stable, the layered structure, which is formed of octahedrons of the transition metal M and oxygen, of the inner portion 100b is unlikely to be broken even with small x in LiₓCoO₂, e.g., with x of less than or equal to 0.24. Furthermore, a shift in layers, which are formed of octahedrons of the transition metal M and oxygen, of the inner portion 100b can be inhibited.

In order that the surface portion 100a can have a stable composition and a stable crystal structure, the surface portion 100a preferably contains the additive element A, further preferably contains a plurality of kinds of additive elements A. The surface portion 100a preferably has a higher concentration of one or more selected from the additive elements A than the inner portion 100b. The one or more selected from the additive elements A contained in the positive electrode active material 100 preferably have a concentration gradient. In the case where the positive electrode active material 100 contains a plurality of kinds of additive elements A, the concentration distributions of the additive elements A are preferably different from each other. For example, it is further preferable that the additive elements A exhibit concentration peaks at different depths from the surface. The concentration peak here refers to the local maximum value of the concentration in the surface portion 100a or the concentration in a region from the surface to a depth of 50 nm or less.

For example, as illustrated in FIG. 9B1 by gradation, some of the additive elements A such as magnesium, barium, fluorine, nickel, titanium, silicon, phosphorus, boron, and calcium preferably have a concentration gradient in which the concentration increases from the inner portion 100b toward the surface. An element having such a concentration gradient is referred to as an additive element X.

Another additive element A such as aluminum or manganese preferably has a concentration gradient as illustrated in FIG. 9B2 by hatching density and exhibits a concentration peak in a deeper region than the additive element in FIG. 9B1. The concentration peak may be located in the surface portion 100a or located deeper than the surface portion 100a. For example, the concentration peak is preferably located in a region extending, toward the inner portion, from a depth from the surface of 5 nm to a depth from the surface of 30 nm. An element having such a concentration gradient is referred to as an additive element Y.

When the transition metal M is Co, a magnesium ion, which is one of the additive elements X, for example is divalent, and the magnesium ion is more stable in lithium sites than in cobalt sites in the layered rock-salt crystal structure and thus is likely to enter the lithium sites. An appropriate concentration of magnesium in the lithium sites of the surface portion 100a can facilitate maintenance of the layered rock-salt crystal structure. This is probably because magnesium in the lithium sites serves as a column supporting the CoO₂ layers. Moreover, magnesium can inhibit extraction of oxygen therearound in a state where x in LiₓCoO₂ is, for example, 0.24 or less. Magnesium is also expected to increase the density of the positive electrode active material 100. In addition, a high concentration of magnesium in the surface portion 100a probably increases the corrosion resistance to hydrofluoric acid generated by the decomposition of the electrolyte solution.

An appropriate concentration of magnesium can bring the above-described advantages without an adverse effect on insertion and extraction of lithium in charge and discharge. However, excess magnesium might adversely affect insertion and extraction of lithium. Furthermore, the effect of stabilizing the crystal structure might be reduced. This is probably because magnesium enters the transition metal M sites in addition to the lithium sites. Moreover, an undesired magnesium compound (e.g., an oxide or a fluoride) which is substituted for neither the lithium site nor the transition metal M site might segregate at the surface of the positive electrode active material or the like to serve as a resistance component of a secondary battery. As the concentration of magnesium in the positive electrode active material increases, the discharge capacity of the positive electrode active material decreases in some cases. This is probably because excess magnesium enters the lithium sites and the amount of lithium contributing to charge and discharge decreases.

Thus, the entire positive electrode active material 100 preferably contains an appropriate amount of magnesium. For example, the number of magnesium atoms is preferably greater than or equal to 0.001 times and less than or equal to 0.1 times, further preferably greater than 0.01 times and less than 0.04 times, still further preferably approximately 0.02 times the number of cobalt atoms. The amount of magnesium contained in the entire positive electrode active material 100 here may be a value obtained by element analysis on the entire positive electrode active material 100 using GD-MS, ICP-MS, or the like, or may be a value based on the ratio of the raw materials mixed in the formation process of the positive electrode active material 100, for example.

Nickel, which is one of the additive elements X, can exist in both the cobalt site and the lithium site. Nickel preferably exists in the cobalt site because an oxidation-reduction potential is lower than the case of cobalt, leading to an increase in discharge capacity.

In addition, when nickel is present in lithium sites, a shift in the layered structure formed of octahedrons of cobalt and oxygen can be inhibited. Moreover, a change in volume in charge and discharge is inhibited. Furthermore, an elastic modulus becomes large, i.e., hardness increases. This is probably because nickel in the lithium sites serves as a column supporting the CoO₂ layers. Thus, in particular, the crystal structure is expected to be more stable in a charged state at high temperatures, e.g., 45° C., or higher, which is preferable.

Meanwhile, excess nickel might increase the influence of distortion due to the Jahn-Teller effect. Moreover, excess nickel might adversely affect insertion and extraction of lithium.

Thus, the entire positive electrode active material 100 preferably contains an appropriate amount of nickel. For example, in the positive electrode active material 100, the number of nickel atoms is preferably greater than 0% and less than or equal to 7.5%, further preferably greater than or equal to 0.05% and less than or equal to 4%, still further preferably greater than or equal to 0.1% and less than or equal to 2%, yet still further preferably greater than or equal to 0.2% and less than or equal to 1% of the number of cobalt atoms. Alternatively, it is preferably greater than 0% and less than or equal to 4%. Alternatively, it is preferably greater than 0% and less than or equal to 2%. Alternatively, it is preferably greater than or equal to 0.05% and less than or equal to 7.5%. Alternatively, it is preferably greater than or equal to 0.05% and less than or equal to 2%. Alternatively, it is preferably greater than or equal to 0.1% and less than or equal to 7.5%. Alternatively, it is preferably greater than or equal to 0.1% and less than or equal to 4%. The amount of nickel described here may be a value obtained by element analysis on the entire positive electrode active material by GD-MS, ICP-MS, or the like, or may be a value based on the ratio of the raw materials mixed in the process of forming the positive electrode active material, for example.

Aluminum, which is one of additive elements Y, can exist in the transition metal M site in a layered rock-salt crystal structure. Since aluminum is a trivalent representative element and its valence does not change, lithium around aluminum is unlikely to move even in charge and discharge. Thus, aluminum and lithium therearound serve as columns to inhibit a change in the crystal structure. Furthermore, aluminum has effects of inhibiting elution of the transition metal M around aluminum and improving continuous charge tolerance. Moreover, an Al—O bond is stronger than a Co—O bond, thus, extraction of oxygen around aluminum can be inhibited. These effects improve thermal stability. Hence, a secondary battery containing aluminum as the additive element Y can have improved safety. Furthermore, the positive electrode active material 100 can have a crystal structure that is unlikely to be broken by repeated charge and discharge.

Meanwhile, excess aluminum might adversely affect insertion and extraction of lithium.

Thus, the entire positive electrode active material 100 preferably contains an appropriate amount of aluminum. For example, in the entire positive electrode active material 100, the number of aluminum atoms is preferably greater than or equal to 0.05% and less than or equal to 4%, further preferably greater than or equal to 0.1% and less than or equal to 2%, still further preferably greater than or equal to 0.3% and less than or equal to 1.5% of the number of cobalt atoms. Alternatively, it is preferably greater than or equal to 0.05% and less than or equal to 2%. Alternatively, it is preferably greater than or equal to 0.1% and less than or equal to 4%. Here, the amount of aluminum contained in the entire positive electrode active material 100 may be a value obtained by element analysis on the entire positive electrode active material 100 with GD-MS, ICP-MS, or the like or may be a value based on the ratio of the raw materials mixed in the process of forming the positive electrode active material 100, for example.

Fluorine, which is an example of the additive element X, is a monovalent anion, when fluorine is substituted for part of oxygen in the surface portion 100a, the lithium extraction energy is lowered. This is because the change in the valence of cobalt ions associated with lithium extraction differs depending on the presence or absence of fluorine; for example, the change in the valence of cobalt ions is trivalent to tetravalent in the case of not containing fluorine and divalent to trivalent in the case of containing fluorine, and the oxidation-reduction potential of cobalt ions differs therebetween. It can thus be said that when fluorine is substituted for part of oxygen in the surface portion 100a of the positive electrode active material 100, lithium ions near fluorine are likely to be extracted and inserted smoothly. Thus, a secondary battery including such a positive electrode active material 100 can have improved charge and discharge characteristics, improved output characteristics, or the like. When fluorine is present in the surface portion 100a, which has a surface in contact with the electrolyte solution, the corrosion resistance to hydrofluoric acid can be effectively increased. As will be described in the following embodiment, a fluoride such as lithium fluoride that has a lower melting point than another additive element A source can serve as a fusing agent (also referred to as a flux) for lowering the melting point of the another additive element A source.

In the case where the surface portion 100a contains both magnesium and nickel, divalent magnesium might be able to be present more stably in the vicinity of divalent nickel. Thus, elution of magnesium might be inhibited even when x in LiₓCoO₂ is small. This can contribute to stabilization of the surface portion 100a.

Additive elements A that are differently distributed, such as the additive element X and the additive element Y, are preferably contained at a time, in which case the crystal structure of a wider region can be stabilized. For example, in the case where the positive electrode active material 100 contains magnesium and nickel, which are examples of the additive elements X, and contains aluminum, which is one of the additive elements Y, the crystal structure of a wider region can be stabilized as compared with the case where only the additive element X or the additive element Y is contained. In the case where the positive electrode active material 100 contains both the additive element X and the additive element Y as described above, the surface can be sufficiently stabilized by the additive element X such as magnesium and nickel; thus, the additive element Y such as aluminum is not necessary for the surface. On the contrary, aluminum is preferably widely distributed in a deep region, e.g., in a region that is 5 nm to 50 nm inclusive in depth from the surface, in which case the crystal structure in a wider region can be stabilized.

When a plurality of the additive elements A are contained as described above, the effects of the additive elements A contribute synergistically to further stabilization of the surface portion 100a. In particular, magnesium, nickel, and aluminum are preferably contained, in which case a high effect of stabilizing the composition and the crystal structure can be obtained.

Note that the surface portion 100a occupied by only a compound of an additive element A and oxygen is not preferred because this surface portion 100a would make insertion and extraction of lithium difficult. For example, it is not preferable that the surface portion 100a be occupied by only MgO, a structure in which MgO and NiO(II) form a solid solution, and/or a structure in which MgO and CoO(II) form a solid solution. Thus, the surface portion 100a should contain at least cobalt, also contain lithium in a discharged state, and have the path through which lithium is inserted and extracted.

To ensure the sufficient path through which lithium is inserted and extracted, the concentration of cobalt is preferably higher than that of magnesium in the surface portion 100a. For example, the ratio Mg/Co of the number of magnesium atoms Mg to the number of cobalt atoms Co is preferably greater than or equal to 0.62. Alternatively, the concentration of cobalt is preferably higher than that of nickel in the surface portion 100a. Alternatively, the concentration of cobalt is preferably higher than that of aluminum in the surface portion 100a. Alternatively, the concentration of cobalt is higher than that of fluorine in the surface portion 100a.

Moreover, excess nickel might hinder diffusion of lithium; thus, the concentration of magnesium is preferably higher than that of nickel in the surface portion 100a. For example, the number of nickel atoms is preferably less than or equal to one sixth that of magnesium atoms.

It is preferable that some additive elements A, in particular, magnesium, nickel, and aluminum have higher concentrations in the surface portion 100a than in the inner portion 100b and exist randomly also in the inner portion 100b to have low concentrations. When magnesium and aluminum exist in the lithium sites of the inner portion 100b at appropriate concentrations, an effect of facilitating maintenance of the layered rock-salt crystal structure can be obtained in a manner similar to the above. When nickel exists in the inner portion 100b at an appropriate concentration, a shift in the layered structure formed of octahedrons of the transition metal M and oxygen can be inhibited in a manner similar to the above. Also in the case where both magnesium and nickel are contained, a synergistic effect of inhibiting elution of magnesium can be expected since divalent magnesium can be present more stably in the vicinity of divalent nickel.

It is preferable that the crystal structure continuously change from the inner portion 100b toward the surface owing to the above-described concentration gradient of the additive element A. Alternatively, the crystal orientations of the surface portion 100a and the inner portion 100b are preferably substantially aligned with each other.

For example, a crystal structure preferably changes continuously from the layered rock-salt inner portion 100b toward the surface and the surface portion 100a that have a rock-salt structure or have features of both a rock-salt structure and a layered rock-salt structure. Alternatively, the crystal orientations of the surface portion 100a with a rock-salt structure or features of both a rock-salt structure and a layered rock-salt structure are preferably substantially aligned with that of the layered rock-salt inner portion 100b.

In this specification and the like, a layered rock-salt crystal structure, which belongs to the space group R-3m, of a composite oxide containing lithium and the transition metal M such as cobalt refers to a crystal structure in which a rock-salt ion arrangement where cations and anions are alternately arranged is included and lithium and the transition metal M are regularly arranged to form a two-dimensional plane, so that lithium can be diffused two-dimensionally. Note that a defect such as a cation or anion vacancy may exist. Moreover, in the layered rock-salt crystal structure, strictly, a lattice of a rock-salt crystal is distorted in some cases.

A rock-salt crystal structure refers to a structure in which a cubic crystal structure with the space group Fm-3m or the like is included and cations and anions are alternately arranged. Note that a cation or anion vacancy may be included.

Having features of both a layered rock-salt crystal structure and a rock-salt crystal structure can be judged by electron diffraction, a TEM image, a cross-sectional STEM image, and the like.

There is no distinction among cation sites in a rock-salt structure. Meanwhile, a layered rock-salt crystal structure has two types of cation sites: one type is mostly occupied by lithium, and the other is occupied by the transition metal M. A stacked-layer structure where two-dimensional planes of cations and two-dimensional planes of anions are alternately arranged is the same in a rock-salt structure and a layered rock-salt structure. Given that the center spot (transmission spot) among bright spots in an electron diffraction pattern corresponding to crystal planes that form the two-dimensional planes is at the origin point 000, the bright spot nearest to the center spot is on the (111) plane in an ideal rock-salt structure, for example, and on the (003) plane in a layered rock-salt structure, for example. For example, when electron diffraction patterns of rock-salt MgO and layered rock-salt LiCoO₂ are compared to each other, the distance between the bright spots on the (003) plane of LiCoO₂ is observed at a distance approximately half the distance between the bright spots on the (111) plane of MgO. Thus, when two phases of rock-salt MgO and layered rock-salt LiCoO₂ are included in a region to be analyzed, a plane orientation in which bright spots with high luminance and bright spots with low luminance are alternately arranged exists in an electron diffraction pattern. A bright spot common between the rock-salt structure and the layered rock-salt structure has high luminance, whereas a bright spot caused only in the layered rock-salt structure has low luminance.

When a layered rock-salt crystal structure is observed from a direction perpendicular to the c-axis in a cross-sectional STEM image and the like, layers observed with high luminance and layers observed with low luminance are alternately observed. Such a feature is not observed in a rock-salt crystal structure because there is no distinction among cation sites therein. When a crystal structure having the features of both a rock-salt crystal structure and a layered rock-salt crystal structure is observed from a given crystal orientation, layers observed with high luminance and layers observed with low luminance are alternately observed in a cross-sectional STEM image and the like, and a metal that has a larger atomic number than lithium is present in part of the layers with low luminance, i.e., the lithium layers.

Anions of a layered rock-salt crystal and anions of a rock-salt crystal form a cubic close-packed structure (face-centered cubic lattice structure). Anions of an O3′ crystal described later are presumed to form a cubic close-packed structure. Thus, when a layered rock-salt crystal and a rock-salt crystal are in contact with each other, there is a crystal plane at which orientations of cubic close-packed structures composed of anions are aligned with each other.

The description can also be made as follows. Anions on the {111} plane of a cubic crystal structure have a triangle lattice. A layered rock-salt structure, which belongs to the space group R-3m and is a rhombohedral structure, is generally represented by a composite hexagonal lattice for easy understanding of the structure, and the (0001) plane of the layered rock-salt structure has a hexagonal lattice. The triangle lattice on the {111} plane of the cubic crystal has atomic arrangement similar to that of the hexagonal lattice on the (0001) plane of the layered rock-salt structure. These lattices being consistent with each other can be expressed as “orientations of the cubic close-packed structures are aligned with each other”.

Note that a space group of the layered rock-salt crystal and the O3′ crystal is R-3m, which is different from the space group Fm-3m of a rock-salt crystal (the space group of a general rock-salt crystal); thus, the Miller index of the crystal plane satisfying the above conditions in the layered rock-salt crystal and the O3′ crystal is different from that in the rock-salt crystal. In this specification, a state where the orientations of the cubic close-packed structures composed of anions in the layered rock-salt crystal, the O3′ type crystal, and the rock-salt crystal are aligned with each other is referred to as a state where crystal orientations are substantially aligned with each other in some cases.

The orientations of crystals in two regions being substantially aligned with each other can be judged, for example, from a TEM (Transmission Electron Microscope) image, a STEM (Scanning Transmission Electron Microscope) image, a HAADF-STEM (High-Angle Annular Dark Field Scanning TEM) image, an ABF-STEM (Annular Bright-Field Scanning Transmission Electron Microscope) image, or the like. It can be judged also from an FFT pattern of a TEM image or an FFT pattern of a STEM image or the like. XRD (X-ray Diffraction), neutron diffraction, and the like can also be used for judging.

<State where x in LiₓCoO₂ is Small>

The crystal structure in a state where x in LiₓCoO₂ is small of the positive electrode active material 100 of one embodiment of the present invention is different from that of a conventional positive electrode active material because the positive electrode active material 100 has the above-described additive element A distribution and/or crystal structure in a discharged state. Here, “x is small” means 0.1<x≤0.24.

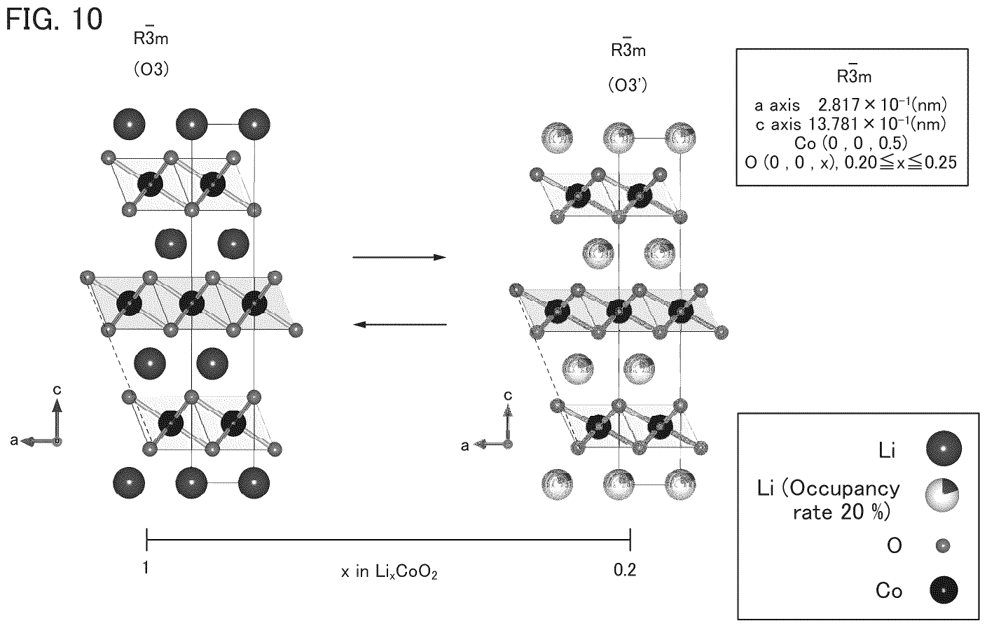

A conventional positive electrode active material and the positive electrode active material 100 of one embodiment of the present invention are compared and changes in crystal structures owing to a change in x in LiₓCoO₂ will be described with reference to FIG. 10 to FIG. 13.

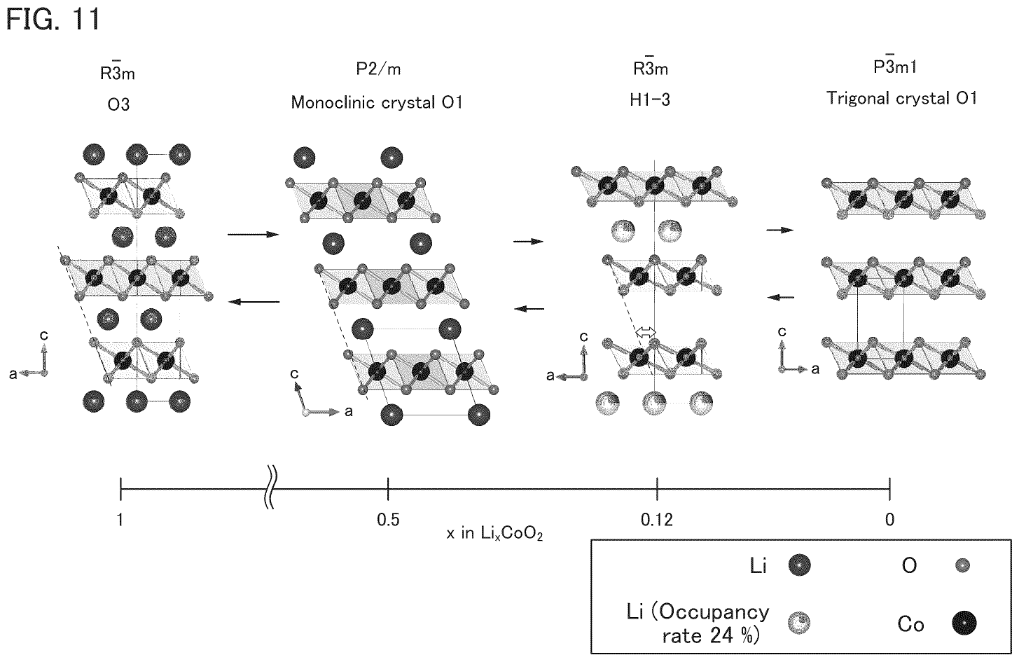

A change in the crystal structure of the conventional positive electrode active material is illustrated in FIG. 11. The conventional positive electrode active material illustrated in FIG. 11 is lithium cobalt oxide (LiCoO₂) not containing the additive element A in particular.

In FIG. 11, the crystal structure of lithium cobalt oxide with x in LiₓCoO₂ of 1 is denoted by R-3m O3. In this crystal structure, lithium occupies octahedral sites and a unit cell includes three CoO₂ layers. Thus, this crystal structure is referred to as an O3 type crystal structure in some cases. Note that the CoO₂ layer has a structure in which an octahedral structure with cobalt coordinated to six oxygen atoms continues on a plane in an edge-shared state. Such a layer is sometimes referred to as a layer formed of octahedrons of cobalt and oxygen.

Conventional lithium cobalt oxide with x being approximately 0.5 is known to have an improved symmetry of lithium and have a monoclinic crystal structure belonging to the space group P2/m. This structure includes one CoO₂ layer in a unit cell. Thus, this crystal structure is referred to as an O1 type structure or a monoclinic O1 type structure in some cases.

A positive electrode active material with x of 0 has the trigonal crystal structure belonging to the space group P-3 ml and includes one CoO₂ layer in a unit cell. Thus, this crystal structure is referred to as an O1 type structure or a trigonal O1 type structure in some cases. Moreover, in some cases, this crystal structure is referred to as a hexagonal O1 type structure when the trigonal crystal is converted into a composite hexagonal lattice.

Conventional lithium cobalt oxide with x being approximately 0.12 has the crystal structure belonging to the space group R-3m. This structure can also be regarded as a structure in which CoO₂ structures such as trigonal O1 type structures and LiCoO₂ structures such as R-3m O3 are alternately stacked. Thus, this crystal structure is referred to as an H1-3 type crystal structure in some cases. The number of cobalt atoms per unit cell in the actual H1-3 type crystal structure is twice that in other structures. However, in this specification including FIG. 11, the c-axis of the H1-3 type crystal structure is half that of the unit cell for easy comparison with the other crystal structures.

For the H1-3 type crystal structure, the coordinates of cobalt and oxygen in the unit cell can be expressed as follows, for example: Co (0, 0, 0.42150±0.00016), O1 (0, 0, 0.27671±0.00045), and O2 (0, 0, 0.11535±0.00045). O1 and O2 are each an oxygen atom. A unit cell that should be used for representing a crystal structure in a positive electrode active material can be judged by the Rietveld analysis of XRD patterns, for example. In this case, a unit cell is selected such that the value of GOF (goodness of fit) is small.

When charge that makes x in LiₓCoO₂ be 0.24 or less and discharge are repeated, the crystal structure of conventional lithium cobalt oxide repeatedly changes between the R-3m O3 type crystal structure in a discharged state and the HI-3 type crystal structure (i.e., an unbalanced phase change).

However, there is a large shift in the CoO₂ layers between these two crystal structures. As denoted by the dotted lines and the arrow in FIG. 11, the CoO₂ layer in the H1-3 type crystal structure largely shifts from R-3m O3 in a discharged state. Such a dynamic structural change can adversely affect the stability of the crystal structure.

A difference in volume between these two crystal structures is also large. The difference in volume per the same number of cobalt atoms between the R-3m O3 type crystal structure in a discharged state and the H1-3 type crystal structure is greater than 3.5%, typically greater than or equal to 3.9%.

In addition, a structure in which CoO₂ layers are arranged continuously, such as the trigonal O1 type structure, included in the H1-3 type crystal structure is highly likely to be unstable.

Accordingly, when charge that makes x be 0.24 or less and discharge are repeated, the crystal structure of conventional lithium cobalt oxide is gradually broken. The broken crystal structure triggers deterioration of the cycle performance. This is because the broken crystal structure has a smaller number of sites where lithium can exist stably and makes it difficult to insert and extract lithium.

On the other hand, in the positive electrode active material 100 of one embodiment of the present invention shown in FIG. 10, a change in the crystal structure between a discharged state with x in LiₓCoO₂ being 1 and a state with x being 0.24 or less is smaller than that in a conventional positive electrode active material. Specifically, a shift in the CoO₂ layers between the state with x being 1 and the state with x being 0.24 or less can be small. Furthermore, a change in the volume can be small in the case where the positive electrode active materials have the same number of cobalt atoms. Thus, the positive electrode active material 100 of one embodiment of the present invention can have a crystal structure that is difficult to break even when charge that makes x be 0.24 or less and discharge are repeated, and enables excellent cycle performance. In addition, the positive electrode active material 100 of one embodiment of the present invention with x in LiₓCoO₂ being 0.24 or less can have a more stable crystal structure than a conventional positive electrode active material. Thus, the positive electrode active material 100 of one embodiment of the present invention with x in LiₓCoO₂ being kept at 0.24 or less inhibits a short circuit. This is preferable because the safety of the secondary battery is improved.

FIG. 10 shows crystal structures of the inner portion 100b of the positive electrode active material 100 in a state where x in LiₓCoO₂ is 1 and in a state where x in LiₓCoO₂ is approximately 0.2. The inner portion 100b, accounting for the majority of the volume of the positive electrode active material 100, largely contributes to charge and discharge and is accordingly a portion where a shift in CoO₂ layers and a volume change matter most.

The positive electrode active material 100 with x being 1 has the R-3m O3 type crystal structure, which is the same as that of conventional lithium cobalt oxide.

However, the positive electrode active material 100 has a crystal structure different from the H1-3 type crystal structure in a state where x is 0.24 or less, e.g., approximately 0.2 or approximately 0.12, with which conventional lithium cobalt oxide has the H1-3 type crystal structure.

The positive electrode active material 100 of one embodiment of the present invention with x being approximately 0.2 has a trigonal crystal structure belonging to the space group R-3m. The symmetry of the CoO₂ layers of this structure is the same as that of O3. Thus, this crystal structure is called an O3′ type crystal structure. In FIG. 10, this crystal structure is denoted by R-3m O3′.

In the unit cell of the O3′ type crystal structure, the coordinates of cobalt and oxygen can be represented as follows: Co (0, 0, 0.5) and O (0, 0, x) within the range of 0.20≤x≤0.25. In the unit cell, the lattice constant of the a-axis is preferably 2.797≤a≤2.837 (×10⁻¹ nm), further preferably 2.807≤a≤2.827 (×10⁻¹ nm), typically a=2.817(×10⁻¹ nm). The lattice constant of the c-axis is preferably 13.681≤c≤13.881 (×10⁻¹ nm), further preferably 13.751≤c≤13.811, typically c=13.781 (×10⁻¹ nm).

In the O3′ type crystal structure, an ion of cobalt, nickel, magnesium, or the like occupies a site coordinated to six oxygen atoms. Note that a light element such as lithium sometimes occupies a site coordinated to four oxygen atoms.

As denoted by the dotted lines in FIG. 10, the CoO₂layers hardly shift between the R-3m (O3) type crystal structure in a discharged state and the O3′ type crystal structure.

The R-3m (03) type crystal structure in a discharged state and the O3′ type crystal structure which contain the same number of cobalt atoms have a difference in volume of 2.5% or less, specifically 2.2% or less, typically 1.8%.

As described above, in the positive electrode active material 100 of one embodiment of the present invention, a change in the crystal structure caused when x in LiₓCoO₂ is small, i.e., when a large amount of lithium is extracted, is smaller than that in a conventional positive electrode active material. In addition, a change in the volume between the compared structures having the same number of cobalt atoms is inhibited. Thus, the crystal structure of the positive electrode active material 100 is less likely to break even when charge that makes x be 0.24 or less and discharge are repeated. Thus, a decrease in charge and discharge capacity of the positive electrode active material 100 in charge and discharge cycles is inhibited. Furthermore, the positive electrode active material 100 can stably use a larger amount of lithium than a conventional positive electrode active material and thus has high discharge capacity per weight and per volume. Thus, with the use of the positive electrode active material 100, a secondary battery with high discharge capacity per weight and per volume can be fabricated.

Note that the positive electrode active material 100 is confirmed to have the O3′ type crystal structure in some cases when x in LiₓCoO₂ is greater than or equal to 0.15 and less than or equal to 0.24, and is assumed to have the O3′ type crystal structure even when x is greater than 0.24 and less than or equal to 0.27. However, the crystal structure is influenced by not only x in LiₓCoO₂ but also the number of charge and discharge cycles, a charge current and a discharge current, temperature, an electrolyte, and the like, so that the range of x is not limited to the above.

Hence, when x in LiₓCoO₂ in the positive electrode active material 100 is greater than 0.1 and less than or equal to 0.24, not all of the inner portion 100b of the positive electrode active material 100 has to have the O3′ type crystal structure. The particles may have another crystal structure or may be partly amorphous.

In order to make x in LiₓCoO₂ small, charge at a high charge voltage is necessary in general. Thus, the state where x in LiₓCoO₂ is small can be rephrased as a state where charge at a high charge voltage has been performed. For example, when CC/CV charge is performed at 25° C., and 4.6 V or higher with reference to the potential of a lithium metal, the H1-3 type crystal structure appears in a conventional positive electrode active material. Thus, a charge voltage of 4.6 V or higher can be regarded as a high charge voltage with reference to the potential of a lithium metal. In this specification and the like, unless otherwise specified, a charge voltage is shown with reference to the potential of a lithium metal.

Thus, the positive electrode active material 100 of one embodiment of the present invention is preferable because the crystal structure with the symmetry of R-3m O3 can be maintained even when charge at a high charge voltage of 4.6 V or higher is performed at 25° C., for example. Moreover, the positive electrode active material 100 of one embodiment of the present invention is preferable because the O3′ type crystal structure can be obtained when charge at a higher charge voltage, e.g., a voltage higher than or equal to 4.65 V and lower than or equal to 4.7 V is performed at 25° C.

In the positive electrode active material 100, when the charge voltage is increased, the H1-3 type crystal structure is eventually observed in some cases. As described above, the crystal structure is influenced by the number of charge and discharge cycles, a charge current and a discharge current, temperature, an electrolyte, and the like, so that the positive electrode active material 100 of one embodiment of the present invention sometimes has the O3′ type crystal structure even at a lower charge voltage, e.g., a charge voltage of higher than or equal to 4.5 V and lower than 4.6 V at 25° C.

Note that in the case where graphite is used as a negative electrode active material in a secondary battery, for example, the voltage of the secondary battery is lower than the above-mentioned voltage by the potential of graphite. The potential of graphite is approximately 0.05 V to 0.2 V with reference to the potential of a lithium metal. Thus, for a secondary battery using graphite as a negative electrode active material, a similar crystal structure is obtained at a voltage corresponding to a difference between the above-described voltage and the potential of the graphite.

Although a chance of the existence of lithium is the same in all lithium sites in O3′ in FIG. 10, one embodiment of the present invention is not limited thereto. Lithium may exist unevenly in only some of the lithium sites; for example, lithium may symmetrically exist as in the monoclinic O1 (Li_{0.5}CoO₂) shown in FIG. 11. Distribution of lithium can be analyzed by neutron diffraction, for example.

The O3′ type crystal structure can be regarded as a crystal structure that contains lithium between layers randomly but is similar to a CdCl₂ type crystal structure. The crystal structure similar to the CdCl₂ type crystal structure is close to a crystal structure of lithium nickel oxide when charged up to a charge depth of Li_{0.06}NiO₂; however, pure lithium cobalt oxide or a layered rock-salt positive electrode active material containing a large amount of cobalt is known not to have the CdCl₂ type crystal structure in general.

The additive-element A concentration gradient is preferably similar in a plurality of portions of the surface portion 100a of the positive electrode active material 100. In other words, it is preferable that the reinforcement derived from the additive element A uniformly occurs in the surface portion 100a. When the surface portion 100a partly has reinforcement, stress might be concentrated on parts that do not have reinforcement. The concentration of stress on part of the positive electrode active material 100 might cause defects such as cracks from that part, leading to breakage of the positive electrode active material and a decrease in discharge capacity.

Note that the additive elements A do not necessarily have similar concentration gradients throughout the surface portion 100a of the positive electrode active material 100. For example, FIG. 9C1 illustrates an example of distribution of the additive element X in the portion in the vicinity of C-D in FIG. 9A and FIG. 9C2 illustrates an example of distribution of the additive element Y in the portion in the vicinity of the line C-D.

Here, the portion near the line C-D has a layered rock-salt crystal structure belonging to R-3m and the surface of the portion has a (001) orientation. The distribution of the additive element A at the surface having a (001) orientation may be different from that at other surfaces. For example, the surface having a (001) orientation and the surface portion 100a thereof may have limited distribution of concentration peaks, which are one or two or more selected from the additive elements X and the additive elements Y, in a shallow portion from the surface as compared to the surface having an orientation other than a (001) orientation. Alternatively, the surface with a (001) orientation and the surface portion 100a thereof may have a lower concentration of one or two or more selected from the additive elements X and the additive elements Y than a surface having another orientation. Further alternatively, at the surface with a (001) orientation and the surface portion 100a thereof, one or two or more elements selected from the additive elements X and the additive element Y may be below the lower detection limit.

In a layered rock-salt crystal structure belonging to R-3m, cations are arranged parallel to the (001) plane. In other words, a CoO₂ layer and a lithium layer are alternately stacked parallel to the (001) plane. Accordingly, a diffusion path of lithium ions also exists parallel to a (001) plane.

The CoO₂ layer is relatively stable and thus, the surface of the positive electrode active material 100 is more stable when having a (001) orientation. A main diffusion path of lithium ions in charge and discharge is not exposed at the (001) plane.

By contrast, a diffusion path of lithium ions is exposed at a surface having an orientation other than a (001) orientation. Thus, the surface with an orientation other than a (001) orientation and the surface portion 100a thereof easily lose stability because they are regions where extraction of lithium ions starts as well as important regions for maintaining a diffusion path of lithium ions. It is thus extremely important to reinforce the surface having an orientation other than a (001) orientation and the surface portion 100a thereof so that the crystal structure of the whole positive electrode active material 100 is maintained.

Accordingly, in the positive electrode active material 100 of another embodiment of the present invention, it is important to distribute the additive element A in the surface having an orientation other than a (001) orientation and the surface portion 100a thereof as illustrated in FIG. 9B1 and FIG. 9B2. By contrast, in the surface with a (001) orientation and the surface portion 100a thereof, the concentration of the additive element A may be low as described above or the additive element A may be absent.

In the formation method as described in the following embodiment, in which high-purity LiCoO₂ is formed, the additive element A is mixed afterwards, and heating is performed, the additive element A spreads mainly through a diffusion path of lithium ions. Thus, distribution of the additive element A at the plane other than (001) and the surface portion 100a thereof can easily fall within a preferred range.

### <Crystal Grain Boundary>

It is further preferable that the additive element A contained in the positive electrode active material 100 of one embodiment of the present invention have the above-described distribution and be at least partly unevenly distributed at the crystal grain boundary and the vicinity thereof.

Note that in this specification and the like, uneven distribution means that the concentration of an element in a certain region differs from those in other regions. This may be rephrased as segregation, precipitation, unevenness, deviation, or a mixture of a high-concentration portion and a low-concentration portion.

For example, the concentration of magnesium at the crystal grain boundary and the vicinity thereof in the positive electrode active material 100 is preferably higher than that in the other regions in the inner portion 100b. In addition, the concentration of fluorine at the crystal grain boundary and the vicinity thereof is preferably higher than that in the other regions in the inner portion 100b. In addition, the concentration of nickel at the crystal grain boundary and the vicinity thereof is preferably higher than that in the other regions in the inner portion 100b. In addition, the concentration of aluminum at the crystal grain boundary and the vicinity thereof is preferably higher than that in the other regions in the inner portion 100b.

The crystal grain boundary is a type of plane defect. Thus, the crystal grain boundary tends to be unstable and the crystal structure easily starts to change like the surface of the particle. Thus, the higher the concentration of the additive element A in the crystal grain boundary and its vicinity is, the more effectively the change in the crystal structure can be inhibited.

When the concentration of magnesium and the concentration of fluorine are high at the crystal grain boundary and the vicinity thereof, the concentration of magnesium and the concentration of fluorine in the vicinity of a surface generated by a crack are also high even when the crack is generated along the crystal grain boundary of the positive electrode active material 100 of one embodiment of the present invention. Thus, the positive electrode active material including a crack can also have an increased corrosion resistance to hydrofluoric acid.

### <Analysis Method>

Whether or not a given positive electrode active material is the positive electrode active material 100 of one embodiment of the present invention, which has the O3′ type crystal structure when x in LiₓCoO₂ is small, can be judged by analyzing a positive electrode including the positive electrode active material with small x in LiₓCoO₂ by XRD, electron diffraction, neutron diffraction, electron spin resonance (ESR), nuclear magnetic resonance (NMR), or the like.

XRD is particularly preferable because the symmetry of the transition metal M such as cobalt contained in the positive electrode active material can be analyzed with high resolution, the degrees of crystallinity and the crystal orientations can be compared, the distortion of lattice periodicity and the crystallite size can be analyzed, and a positive electrode obtained by disassembling a secondary battery can be measured without any change with sufficient accuracy, for example. A diffraction peak reflecting the crystal structure of the inner portion 100b of the positive electrode active material 100, which accounts for the majority of the volume of the positive electrode active material 100, is obtained through XRD, in particular, powder XRD.

As described above, the positive electrode active material 100 of one embodiment of the present invention has a feature of a small change in the crystal structure between when x in LiₓCoO₂ is 1 and when x is less than or equal to 0.24. A material where 50% or more of the crystal structure largely changes in high-voltage charge is not preferable because the material cannot withstand high-voltage charge and discharge.

It should be noted that the O3′ type crystal structure is not obtained in some cases only by addition of the additive element A. For example, when x in LiₓCoO₂ is less than or equal to 0.24, lithium cobalt oxide containing magnesium and fluorine or lithium cobalt oxide containing magnesium and aluminum has the O3′ type crystal structure at 60% or more in some cases, and has the H1-3 type crystal structure at 50% or more in other cases, depending on the concentration and distribution of the additive element A.

In addition, in the case where x is too small, e.g., 0.1 or less, or under the condition where charge voltage is higher than 4.9 V, the positive electrode active material 100 of one embodiment of the present invention sometimes has the H1-3 type crystal structure or the trigonal O1 type crystal structure. Thus, determining whether or not a positive electrode active material is the positive electrode active material 100 of one embodiment of the present invention requires analysis of the crystal structure by XRD and other methods and data such as charge capacity or charge voltage.

Note that a positive electrode active material with small x sometimes causes a change in the crystal structure when exposed to the air. For example, the O3′ type crystal structure changes into the H1-3 type crystal structure in some cases. For that reason, all samples subjected to analysis of crystal structures are preferably handled in an inert atmosphere such as an argon atmosphere.

Whether the additive element A contained in a positive electrode active material in the above-described state can be judged by, for example, analysis using XPS, energy dispersive X-ray spectroscopy (EDX), EPMA (electron probe microanalysis), or the like.

The crystal structure of the surface portion 100a, the crystal grain boundary, or the like can be analyzed by electron diffraction of a cross section of the positive electrode active material 100, for example.

### <Charge Method>

High-voltage charge for determining whether or not a composite oxide is the positive electrode active material 100 of one embodiment of the present invention can be performed on a coin cell (CR2032 type with a diameter of 20 mm and a height of 3.2 mm) with a lithium counter electrode, for example.

More specifically, a positive electrode can be formed by application of slurry in which the positive electrode active material, a conductive material, and a binder are mixed to a positive electrode current collector made of aluminum foil.

A lithium metal can be used for a counter electrode. Note that when the counter electrode is formed using a material other than the lithium metal, the potential of a secondary battery differs from the potential of the positive electrode. Unless otherwise specified, the voltage and the potential in this specification and the like refer to the potential of a positive electrode.

As an electrolyte contained in the electrolyte solution, 1 mol/L lithium hexafluorophosphate (LiPF₆) can be used. As the electrolyte solution, an electrolyte solution in which ethylene carbonate (EC) and diethyl carbonate (DEC) at EC:DEC=3:7 (volume ratio) and vinylene carbonate (VC) at 2 wt % are mixed can be used.

As a separator, a 25-μm-thick polypropylene porous film can be used.

Stainless steel (SUS) can be used for a positive electrode can and a negative electrode can.

Constant current charge at a current value of 10 mA/g is performed on the coin cell fabricated with the above conditions to a freely selected voltage (e.g., 4.5 V, 4.55 V, 4.6 V, 4.65 V, 4.7 V, 4.75 V, or 4.8 V). To observe a phase change of the positive electrode active material, charge with such a small current value is preferably performed. The temperature is set to 25° C. or 45° C. After charge is performed in this manner, the coin cell is disassembled in a glove box with an argon atmosphere to take out the positive electrode, whereby the positive electrode active material with predetermined charge capacity can be obtained. In order to inhibit a reaction with components in the external environment, the taken positive electrode is preferably enclosed in an argon atmosphere in performing various analyses later. For example, XRD can be performed on the positive electrode enclosed in an airtight container with an argon atmosphere. After charge is completed, the positive electrode is preferably taken out immediately and subjected to the analysis. Specifically, the positive electrode is preferably subjected to the analysis within an hour after the completion of charge, further preferably within 30 minutes after the completion of charge.

In the case where the crystal structure in a charged state after charge and discharge are performed multiple times is analyzed, the conditions of the charge and discharge performed multiple times may be different from the above-described charge conditions. For example, the charge can be performed in the following manner: constant current charge is performed at a current value of 100 mA/g to a freely selected voltage (e.g., 4.6 V, 4.65 V, 4.7 V, 4.75 V, or 4.8 V) and then, constant voltage charge is performed until the current value becomes 10 mA/g. As the discharge, constant current discharge can be performed at 100 mA/g to 2.5 V.

Also in the case where the crystal structure in a discharged state after the charge and discharge are performed multiple times is analyzed, constant current discharge can be performed at a current value of 100 mA/g to 2.5 V, for example.

### <XRD>

The apparatus and conditions for the XRD measurement are not particularly limited. The measurement can be performed with the apparatus and conditions as described below, for example. XRD apparatus: D8 ADVANCE produced by Bruker AXS, X-ray source: CuKα₁ radiation, output: 40 kV, 40 mA, slit width: Div. Slit, 0.5°, detector: LynxEye, scanning method: 2θ/θ continuous scanning, measurement range (2θ): from 15° to 90°, step width (2θ): 0.01°, counting time: 1 second/step, rotation of sample stage: 15 rpm.

In the case where the measurement sample is a powder, the sample can be set by, for example, being put in a glass sample holder or being sprinkled on a reflection-free silicon plate to which grease is applied. In the case where the measurement sample is a positive electrode, the sample can be set in such a manner that the positive electrode is attached to a substrate with a double-sided adhesive tape so that the position of the positive electrode active material laver can be adjusted to the measurement plane required by the apparatus.

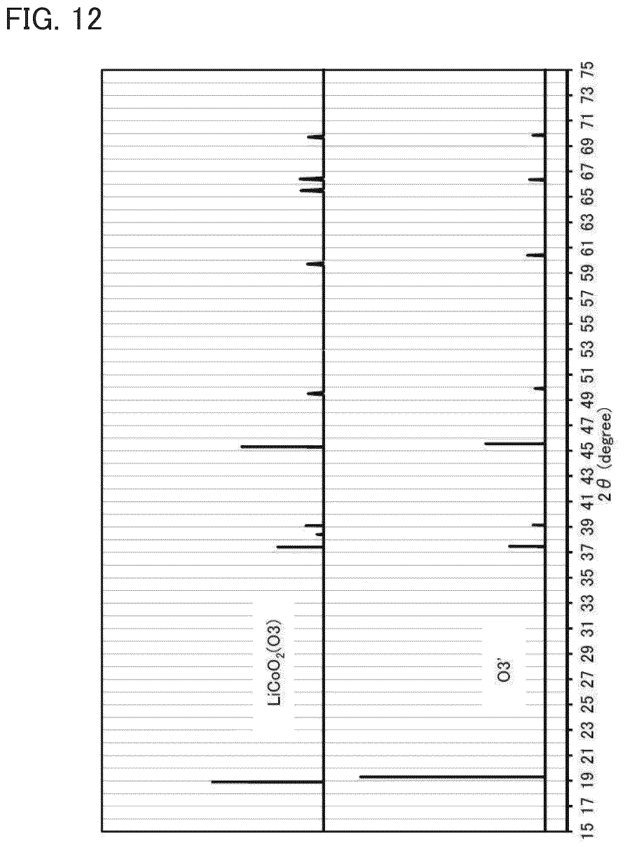

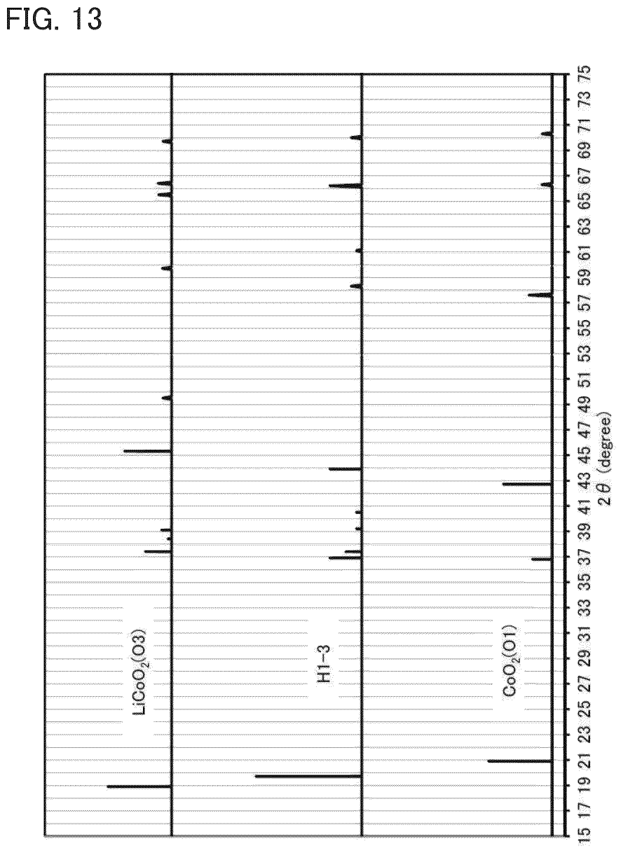

FIG. 12 and FIG. 13 show ideal powder XRD patterns with CuKα1 radiation that are calculated from models of the O3′ type crystal structure and the H1-3 type crystal structure. For comparison, ideal XRD patterns calculated from the crystal structure of LiCoO₂ O3 with x in LixCoO₂ of 1 and the crystal structure of the trigonal O1 with x of 0 are also shown in FIG. 13. Note that the patterns of LiCoO₂(O3) and CoO₂ (O1) are made from crystal structure data obtained from ICSD (Inorganic Crystal Structure Database) using Reflex Powder Diffraction, which is a module of Materials Studio (BIOVIA). The 20 range is from 15° to 75°, the step size is 0.01, the wavelength λ1 is 1.540562×10⁻¹⁰ m, the wavelength λ2 is not set, and a single monochromator is used. XRD patterns of the H1-3 type crystal structure are made from crystal structure data of the H1-3 type crystal structure illustrated in FIG. 11 in a manner similar to the above-described method. The O3′ type crystal structure is estimated from the XRD pattern of the positive electrode active material of one embodiment of the present invention, the crystal structure is fitted with TOPAS Ver. 3 (crystal structure analysis software produced by Bruker Corporation), and the XRD pattern of the O3′ type crystal structure is made in a manner similar to that for other structures.

As shown in FIG. 12, the O3′ type crystal structure exhibits diffraction peaks at 2θ of 19.25±0.12° (greater than or equal to 19.130 and less than or equal to 19.37°) and 2θ of 45.47±0.100 (greater than or equal to 45.370 and less than or equal to 45.57°).

However, as shown in FIG. 13, the H1-3 type crystal structure and trigonal O1 do not exhibit peaks at these positions. Thus, the diffraction peaks at 2θ of 19.25±0.12° (greater than or equal to 19.13° and less than or equal to 19.37°) and 2θ of 45.47-0.10° (greater than or equal to 45.37° and less than or equal to 45.57°) in a state where x in LiₓCoO₂ is small can be the features of the positive electrode active material 100 of one embodiment of the present invention.

It can be said that the positions of the XRD diffraction peaks exhibited by the crystal structure with x being 1 and the crystal structure with x being 0.24 or less are close to each other. More specifically, it can be said that a difference in 2θ between the main diffraction peak exhibited by the crystal structure with x being 1 and the main diffraction peak exhibited by the crystal structure with x being 0.24 or less, which are exhibited at 2θ of greater than or equal to 42° and less than or equal to 46°, is 0.7° or less, preferably 0.5° or less.

Although the positive electrode active material 100 of one embodiment of the present invention has the O3′ type crystal structure when x in LiₓCoO₂ is small, not all of the positive electrode active material 100 necessarily has the O3′ type crystal structure. The particles may have another crystal structure or may be partly amorphous. Note that when the XRD patterns are subjected to the Rietveld analysis, the O3′ type crystal structure preferably accounts for greater than or equal to 50%, further preferably greater than or equal to 60%, still further preferably greater than or equal to 66%. The positive electrode active material in which the O3′ type crystal structure accounts for greater than or equal to 50%, preferably greater than or equal to 60%, further preferably greater than or equal to 66% can have sufficiently good cycle performance.

Furthermore, even after 100 or more cycles of charge and discharge after the measurement starts, the O3′ type crystal structure preferably accounts for more than or equal to 35%, further preferably more than or equal to 40%, still further preferably more than or equal to 43% when the Rietveld analysis is performed.

Sharpness of a diffraction peak in an XRD pattern indicates the degree of crystallinity. It is thus preferable that the diffraction peaks after charge be sharp, in other words, have a small half width. Even peaks that are derived from the same crystal phase have different half widths depending on the XRD measurement conditions or the 2θ value. In the case of the above-described measurement conditions, the peak observed at 2θ of greater than or equal to 43° and less than or equal to 46° preferably has a small half width of less than or equal to 0.2°, further preferably less than or equal to 0.15°, still further preferably less than or equal to 0.12°. Note that not all peaks need to fulfill the requirement. A crystal phase can be regarded as having high crystallinity when one or more peaks derived from the crystal phase fulfill the requirement. Such high crystallinity contributes to stability of the crystal structure after sufficient charge.

The crystallite size of the O3′ type crystal structure included in the positive electrode active material 100 does not decrease to less than approximately one-twentieth that of LiCoO₂ (O3) in a discharged state. Thus, a clear peak of the O3′ type crystal structure can be observed when x in LiₓCoO₂ is small, even under the same XRD measurement conditions as those of a positive electrode before the charge and discharge. By contrast, conventional LiCoO₂ has a small crystallite size and a broad and small peak even when it can have a structure part of which is similar to the O3′ type crystal structure. The crystallite size can be calculated from the half width of the XRD peak.

### <XPS>

In an inorganic oxide, a region that is approximately 2 nm to 8 nm (usually, equal to or less than 5 nm) in depth from a surface can be analyzed by X-ray photoelectron spectroscopy (XPS) using monochromated aluminum Kα radiation as an X-ray source; thus, the concentrations of elements in approximately half the depth of the surface portion 100a can be quantitatively analyzed. The bonding states of the elements can be analyzed by narrow scanning. Note that in many cases, the quantitative accuracy of XPS is approximately ±1 at %, and the lower detection limit is approximately 1 at % but depends on the element.

In the positive electrode active material 100 of one embodiment of the present invention, the concentration of one or more selected from the additive elements A is preferably higher in the surface portion 100a than in the inner portion 100b. This means that the concentration of one or more selected from the additive elements A in the surface portion 100a is preferably higher than the average concentration of the selected element(s) in the entire positive electrode active material 100. For this reason, for example, it is preferable that the concentration of one or more additive elements A selected from the surface portion 100a, which is measured by XPS or the like, be higher than the average concentration of the additive element(s) A in the entire the positive electrode active material 100, which is measured by ICP-MS (inductively coupled plasma-mass spectrometry), GD-MS (glow discharge mass spectrometry), or the like. For example, the concentration of magnesium in at least part of the surface portion 100a, which is measured by XPS or the like, is preferably higher than the concentration of magnesium in the entire positive electrode active material 100. The concentration of nickel in at least part of the surface portion 100a is preferably higher than the concentration of nickel in the entire positive electrode active material 100. The concentration of aluminum in at least part of the surface portion 100a is preferably higher than the concentration of aluminum in the entire positive electrode active material 100. The concentration of fluorine in at least part of the surface portion 100a is preferably higher than the concentration of fluorine in the entire positive electrode active material 100.

Note that the surface and the surface portion 100a of the positive electrode active material 100 of one embodiment of the present invention do not contain a carbonate, a hydroxy group, or the like which is chemically adsorbed after formation of the positive electrode active material 100. Furthermore, an electrolyte solution, a binder, a conductive material, and a compound originating from any of these that are attached to the surface of the positive electrode active material 100 are not contained either. Thus, in quantitative analysis of the elements contained in the positive electrode active material, correction may be performed to exclude carbon, hydrogen, excess oxygen, excess fluorine, and the like that might be detected in surface analysis such as XPS. For example, in XPS, the kinds of bonds can be identified by analysis, and a C—F bond originating from a binder may be excluded by correction.

Furthermore, before any of various kinds of analyses is performed, a sample of a positive electrode active material or a positive electrode active material layer or the like may be washed, for example, to eliminate an electrolyte solution, a binder, a conductive material, and a compound originating from any of these that are attached to the surface of the positive electrode active material. Although lithium might be dissolved into a solvent or the like used in the washing at this time, the additive element A is not easily dissolved even in that case; thus, the atomic ratio of the additive element A is not affected.

The concentration of the additive element A may be compared using the ratio of the additive element A to cobalt. The use of the ratio of the additive element A to cobalt enables comparison while reducing the influence of a carbonate or the like which is chemically adsorbed after formation of the positive electrode active material. For example, in the XPS analysis, the atomic ratio of magnesium to cobalt (Mg/Co) is preferably greater than or equal to 0.4 and less than or equal to 1.5. In the ICP-MS analysis, Mg/Co is preferably greater than or equal to 0.001 and less than or equal to 0.06.

Similarly, to ensure the sufficient path through which lithium is inserted and extracted, the concentrations of lithium and cobalt are preferably higher than those of the additive elements A in the surface portion 100a of the positive electrode active material 100. This means that the concentrations of lithium and cobalt in the surface portion 100a are preferably higher than that of one or more selected from the additive elements A contained in the surface portion 100a, which is measured by XPS or the like. For example, the concentration of cobalt in at least part of the surface portion 100a, which is measured by XPS or the like, is preferably higher than the concentration of magnesium in at least part of the surface portion 100a, which is measured by XPS or the like. Similarly, the concentration of lithium is preferably higher than the concentration of magnesium. In addition, the concentration of cobalt is preferably higher than the concentration of nickel. Similarly, the concentration of lithium is preferably higher than the concentration of nickel. The concentration of cobalt is preferably higher than the concentration of aluminum. Similarly, the concentration of lithium is preferably higher than the concentration of aluminum. The concentration of cobalt is preferably higher than the concentration of fluorine. Similarly, the concentration of lithium s preferably higher the concentration of fluorine.

It is further preferable that the additive element Y such as aluminum be preferably widely distributed in a region that is greater than or equal to 5 nm and less than or equal to 50 nm in depth from the surface, for example. Thus, the additive element Y such as aluminum is detected by analysis on the entire positive electrode active material 100 by ICP-MS. GD-MS, or the like, but the concentration of the additive element Y such as aluminum is preferably lower than or equal to the lower detection limit in XPS or the like.

Furthermore, when XPS analysis is performed on the positive electrode active material 100 of one embodiment of the present invention, the number of magnesium atoms is preferably 0.4 times or more and 1.2 times or less, further preferably 0.65 times or more and 1.0 times or less the number of cobalt atoms. The number of nickel atoms is preferably 0.15 times or less, further preferably 0.03 times or more and 0.13 times or less the number of cobalt atoms. The number of aluminum atoms is preferably 0.12 times or less, further preferably 0.09 times or less the number of cobalt atoms. The number of fluorine atoms is preferably 0.3 times or more and 0.9 times or less, further preferably 0.1 times or more and 1.1 times or less the number of cobalt atoms.

In the XPS analysis, monochromatic aluminum Kα radiation can be used as an X-ray source, for example. An extraction angle is, for example, 45°. For example, the measurement can be performed using the following apparatus and conditions. Measurement device: Quantera II produced by PHI, Inc., X-ray source: monochromatic Al Kα (1486.6 eV), detection area: 100 μm ϕ, detection depth: approximately 4 to 5 nm (extraction angle 45°), measurement spectrum: wide scanning, narrow scanning of each detected element.

In addition, when the positive electrode active material 100 of one embodiment of the present invention is analyzed by XPS, a peak indicating the bonding energy of fluorine with another element is preferably at greater than or equal to 682 eV and less than 685 eV, further preferably approximately 684.3 eV. The above value is different from 685 eV, which is the bonding energy of lithium fluoride, and 686 eV, which is the bonding energy of magnesium fluoride. That is, the positive electrode active material 100 of one embodiment of the present invention containing fluorine is preferably in the bonding state other than lithium fluoride and magnesium fluoride.

Furthermore, when the positive electrode active material 100 of one embodiment of the present invention is analyzed by XPS, a peak indicating the bonding energy of magnesium with another element is preferably at greater than or equal to 1302 eV and less than 1304 eV, further preferably at approximately 1303 eV. The above value is different from 1305 eV, which is the bonding energy of magnesium fluoride, and is close to a value of the bonding energy of magnesium oxide. That is, the positive electrode active material 100 of one embodiment of the present invention containing magnesium is preferably in the bonding state other than magnesium fluoride.

### <EDX>

The one or more selected from the additive elements A contained in the positive electrode active material 100 preferably have a concentration gradient. It is further preferable that the additive elements A contained in the positive electrode active material 100 exhibit concentration peaks at different depths from the surface. The concentration gradient of the additive element A can be evaluated by exposing a cross section of the positive electrode active material 100 using FIB or the like and analyzing the cross section using energy dispersive X-ray spectroscopy (EDX), EPMA (electron probe microanalysis), or the like.

In the EDX measurement, to measure a region while scanning is performed and evaluate the region two-dimensionally is referred to as EDX area analysis. The measurement by line scan, which is performed to evaluate the atomic concentration distribution in a positive electrode active material, is referred to as line analysis. Furthermore, extracting data of a linear region from EDX area analysis is referred to as line analysis in some cases. Measurement of a region without scanning is referred to as point analysis.

By EDX area analysis (e.g., element mapping), the concentrations of the additive element A in the surface portion 100a, the inner portion 100b, the vicinity of the crystal grain boundary, and the like of the positive electrode active material 100 can be quantitatively analyzed. By EDX line analysis, the concentration distribution and the highest concentration of the additive element A can be analyzed. An analysis method in which a thinned sample is used, such as STEM-EDX, is preferred because the method makes it possible to analyze the concentration distribution in the depth direction from the surface toward the center in a specific region of the positive electrode active material regardless of the distribution in the front-back direction.

EDX area analysis or EDX point analysis of the positive electrode active material 100 of one embodiment of the present invention preferably reveals that the concentration of each additive element A, in particular, the additive element X in the surface portion 100a is higher than that in the inner portion 100b.

For example, EDX area analysis or EDX point analysis of the positive electrode active material 100 containing magnesium as the additive element X preferably reveals that the concentration of magnesium in the surface portion 100a is higher than that in the inner portion 100b. Thus, in the EDX line analysis, a peak of the concentration of magnesium in the surface portion 100a is preferably observed in a region extending, toward the center of the positive electrode active material 100, from the surface thereof to a depth of 3 nm, further preferably 1 nm, still further preferably 0.5 nm. In addition, the magnesium concentration preferably attenuates, at a depth of 1 nm from the peak position, to less than or equal to 60% of the peak concentration. In addition, the magnesium concentration preferably attenuates, at a depth of 2 nm from the peak position, to less than or equal to 30% of the peak concentration. Here, a “peak of concentration” refers to the local maximum value of concentration.

When the positive electrode active material 100 contains magnesium and fluorine as the additive elements X, the distribution of fluorine preferably overlaps with the distribution of magnesium. For example, a difference in the depth direction between a peak of the concentration of fluorine and a peak of the concentration of magnesium is preferably within 10 nm, further preferably within 3 nm, still further preferably within 1 nm.

Thus, in the EDX line analysis, a peak of the concentration of fluorine in the surface portion 100a is preferably observed in a region extending, toward the center of the positive electrode active material 100, from the surface thereof to a depth of 3 nm, further preferably 1 nm, still further preferably 0.5 nm. It is further preferable that a peak of the concentration of fluorine be exhibited slightly closer to the surface side than a peak of the concentration of magnesium is, which increases resistance to hydrofluoric acid. For example, it is preferable that a peak of the concentration of fluorine be exhibited slightly closer to the surface side than a peak of the concentration of magnesium is by 0.5 nm or more, further preferably 1.5 nm or more.

When the positive electrode active material 100 containing nickel as the additive element X, a peak of the concentration of nickel in the surface portion 100a is preferably observed in a region extending, toward the center of the positive electrode active material 100, from the surface thereof to a depth of 3 nm, further preferably 1 nm, still further preferably 0.5 nm. When the positive electrode active material 100 contains magnesium and nickel, the distribution of nickel preferably overlaps with the distribution of magnesium. For example, a difference in the depth direction between a peak of the concentration of nickel and a peak of the concentration of magnesium is preferably within 10 nm, further preferably within 3 nm, still further preferably within 1 nm.

In the case where the positive electrode active material 100 contains aluminum as the additive element Y, the peak of the concentration of magnesium, the concentration of nickel, or the concentration of fluorine is preferably closer to the surface than the peak of the concentration of aluminum is in the surface portion 100a in the EDX line analysis. For example, the peak of the concentration of aluminum is preferably exhibited by a region that is greater than or equal to 0.5 nm and less than or equal to 50 nm in depth, further preferably greater than or equal to 5 nm and less than or equal to 50 nm in depth from the surface toward the center of the positive electrode active material 100.

EDX line, area, or point analysis of the positive electrode active material 100 preferably reveals that the atomic ratio of magnesium to cobalt (Mg/Co) at a peak of the concentration of magnesium is preferably greater than or equal to 0.05 and less than or equal to 0.6, further preferably greater than or equal to 0.1 and less than or equal to 0.4. The atomic ratio of aluminum to cobalt (Al/Co) at a peak of the concentration of aluminum is preferably greater than or equal to 0.05 and less than or equal to 0.6, further preferably greater than or equal to 0.1 and less than or equal to 0.45. The atomic ratio of nickel to cobalt (Ni/Co) at a peak of the concentration of nickel is preferably greater than or equal to 0 and less than or equal to 0.2, further preferably greater than or equal to 0.01 and less than or equal to 0.1. The atomic ratio of fluorine to cobalt (F/Co) at a peak of the concentration of fluorine is preferably greater than or equal to 0 and less than or equal to 1.6, further preferably greater than or equal to 0.1 and less than or equal to 1.4.

According to results of the EDX line analysis, where a surface of the positive electrode active material 100 is can be estimated as follows. A point where the detected amount of an element which uniformly exists in the inner portion 100b of the positive electrode active material 100, e.g., oxygen or cobalt, is 1/2 of the detected amount thereof in the inner portion 100b is assumed to be the surface.

Since the positive electrode active material 100 is a composite oxide, the detected amount of oxygen can be used to estimate where the surface is. Specifically, an average value Oₐᵥₑ of the oxygen concentration in a region of the inner portion 100b where the detected amount of oxygen is stable is calculated first. At this time, in the case where oxygen O_{background} which is probably led from chemical adsorption or the background is detected in a region that is obviously outside the surface, O_{background} a can be subtracted from the measurement value to obtain the average value One of the oxygen concentration. The measurement point where the measurement value which is closest to 1/2 of the average value Oₐᵥₑ, i.e., Oₐᵥₑ/2, is obtained can be estimated to be the surface of the positive electrode active material.

The detected amount of cobalt can also be used to estimate where the surface is as in the above description. Alternatively, the sum of the detected amounts of the transition metals can be used for the estimation in a similar manner. The detected amount of the transition metal such as cobalt is less likely to be affected by chemical adsorption and is thus suitable for estimating where the surface is.

When the line analysis or the area analysis is performed on the positive electrode active material 100, the atomic ratio of the additive element A to cobalt Co (A/Co) in the vicinity of the crystal grain boundary is preferably greater than or equal to 0.020 and less than or equal to 0.50. Alternatively, it is preferably greater than or equal to 0.025 and less than or equal to 0.30. Alternatively, it is preferably greater than or equal to 0.030 and less than or equal to 0.20. Alternatively, it is preferably greater than or equal to 0.020 and less than or equal to 0.30. Alternatively, it is preferably greater than or equal to 0.020 and less than or equal to 0.20. Alternatively, it is preferably greater than or equal to 0.025 and less than or equal to 0.50. Alternatively, it is preferably greater than or equal to 0.025 and less than or equal to 0.20. Alternatively, it is preferably greater than or equal to 0.030 and less than or equal to 0.50. Alternatively, it is preferably greater than or equal to 0.030 and less than or equal to 0.30.

When the line analysis or the area analysis is performed on the positive electrode active material 100 containing magnesium as the additive element X, the atomic ratio of magnesium to cobalt (Mg/Co) in the vicinity of the crystal grain boundary is preferably greater than or equal to 0.020 and less than or equal to 0.50. Alternatively, it is preferably greater than or equal to 0.025 and less than or equal to 0.30. Alternatively, it is preferably greater than or equal to 0.030 and less than or equal to 0.20. Alternatively, it is preferably greater than or equal to 0.020 and less than or equal to 0.30. Alternatively, it is preferably greater than or equal to 0.020 and less than or equal to 0.20. Alternatively, it is preferably greater than or equal to 0.025 and less than or equal to 0.50. Alternatively, it is preferably greater than or equal to 0.025 and less than or equal to 0.20. Alternatively, it is preferably greater than or equal to 0.030 and less than or equal to 0.50. Alternatively, it is preferably greater than or equal to 0.030 and less than or equal to 0.30.

<Charge Curve and dQ/dV Vs V Curve>

The positive electrode active material 100 of one embodiment of the present invention sometimes shows a characteristic voltage change along with charge. A voltage change can be read from a dQ/dV vs V curve, which can be obtained by differentiating capacitance (Q) in a charge curve with voltage (V) (dQ/dV). There should be an unbalanced phase change and a significant change in the crystal structure between before and after a peak in the dQ/dV vs V curve. Note that in this specification and the like, an unbalanced phase change refers to a phenomenon that causes a nonlinear change in physical quantity.

The positive electrode active material 100 of one embodiment of the present invention sometimes shows abroad peak at around 4.55 V in a dQ/dV vs V curve. The peak at around 4.55 V reflects a change in voltage at the time of the phase change from the O3 type structure to the O3 type structure. This means that when this peak is broad, a change in the energy necessary for extraction of lithium is smaller or in other words, a change in the crystal structure is smaller, than when the peak is sharp. These changes are preferably small, in which case the influence of a shift in CoO₂ layers and that of a change in volume are little.

Specifically, when the maximum value appearing at greater than or equal to 4.5 V and less than or equal to 4.6 V in a dQ/dV vs V curve of a charge curve is a first peak, the first peak preferably has a full width at half maximum of greater than or equal to 0.10 V to be sufficiently broad. In this specification and the like, the half width of the first peak refers to the difference between HWHM₁ and HWHM₂, where HWHM₁ is an average value of the first peak and a first minimum value, which is the minimum dQ/dV value appearing at greater than or equal to 4.3 V and less than or equal to 4.5 V, and HWHM₂ is an average value of the first peak and a second minimum value, which is the minimum dQ/dV value appearing at greater than or equal to 4.6 V and less than or equal to 4.8 V.

The charge at the time of obtaining a dQ/dV vs V curve can be, for example, constant current charge to 4.9 V at 10 mA/g. In obtaining a dQ/dV value of the initial charge, the above charge is preferably started after discharge to 2.5 V at 100 mA/g before measurement.

Data acquisition at the time of charge can be performed in the following manner, for example: a voltage and a current are acquired at intervals of 1 second or at every 1-mV voltage change. The value obtained by adding the current value and time is charge capacity.

The difference between the n-th data and the n+1-th data of the above charge capacity is the n-th value of a capacity change dQ. Similarly, the difference between the n-th data and the n+1-th data of the above voltage is the n-th value of a voltage change dV.

Note that minute noise has considerable influence when the above data is used: thus, the dQ/dV value may be calculated from the moving average for a certain number of class intervals of the differences in the voltage and the moving average for a certain number of class intervals of the differences in the charge capacity. The number of class intervals can be 500, for example.

Specifically, the average value of the n-th to n+500-th dQ values is calculated and in a similar manner, the average value of the n-th to n+500-th dV values is calculated. The dQ/dV value can be dQ (the average of 500 dQ values)/dV (the average of 500 dV values). In a similar manner, the moving average value of the 500 class intervals can be used for the voltage on the horizontal axis of a dQ/dV vs V curve. In the case where the above-described moving average value of the 500 class intervals is used, the 501^{st} data from the last to the last data are largely influenced by noise and thus are not preferably used for the dQ/dV vs V curve.

In the case where a dQ/dV vs V curve after charge and discharge are performed multiple times is analyzed, the conditions of the charge and discharge performed multiple times may be different from the above-described charge conditions. For example, the charge can be performed in the following manner: constant current charge is performed at 100 mA/g to a freely selected voltage (e.g., 4.6 V, 4.65 V, 4.7 V, 4.75 V, or 4.8 V) and then, constant voltage charge is performed until the current value becomes 10 mA/g. As the discharge, constant current discharge can be performed at 100 mA/g to 2.5 V.

Note that the O3 type structure at the time of the phase change to the O3′ type structure at around 4.55 V has x in LiₓCoO₂ of approximately 0.3. This O3 type structure has the same symmetry as the O3 type structure with x of 1 shown in FIG. 11, but is slightly different in the distance between the CoO₂ layers. In this specification and the like, when O3 type structures with different x are distinguished from each other, the O3 type structure with x of 1 is referred to as O3 (2θ=18.85) and the O3 type structure with x of approximately 0.3 is referred to as O3 (20 =18.57). This is because the position of the peak appearing at 20 of approximately 19° in XRD measurement corresponds to the distance between the CoO₂ layers.

### [Formation Method of Positive Electrode Active Material]

A way of adding the additive element A is important in forming the positive electrode active material 100 having the distribution of the additive element A, the composition, and/or the crystal structure described in the above embodiment. Favorable crystallinity of the inner portion 100b is important as well.

Thus, in the formation process of the positive electrode active material 100, preferably, a composite oxide containing lithium and a transition metal is synthesized first, then the additive element A source is mixed, and heat treatment is performed.

In a method of synthesizing a composite oxide containing the additive element A, lithium, and the transition metal M by mixing the additive element A source concurrently with a transition metal M source and a lithium source, it is difficult to increase the concentration of the additive element A in the surface portion 100a. In addition, after a composite oxide containing lithium and the transition metal M is synthesized, only mixing the additive element A source without performing heating causes the additive element to be just attached to, not dissolved in, the composite oxide containing lithium and the transition metal M. It is difficult to distribute the additive element A favorably without sufficient heating. Thus, it is preferable that the composite oxide be synthesized, and then the additive element A source be mixed and heat treatment be performed. The heat treatment after mixing of the additive element A source may be referred to as annealing.

However, annealing at an excessively high temperature may cause cation mixing, which increases the possibility of entry of the additive element A such as magnesium into the transition metal Al sites. Magnesium that exists at the transition metal M sites does not have an effect of maintaining a layered rock-salt crystal structure belonging to R-3m when x in LiₓCoO₂ is small. Furthermore, heat treatment at an excessively high temperature might have an adverse effect; for example, cobalt might be reduced to have a valence of two or lithium might be evaporated.

Here, a material functioning as a fusing agent is preferably mixed together with the additive element A source. The material can be regarded as functioning as a fusing agent when having a melting point lower than that of the composite oxide containing lithium and the transition metal M. For example, a fluorine compound such as lithium fluoride is preferably used. Adding the fusing agent decreases the melting points of the additive element A source and the composite oxide containing lithium and the transition metal M. The decrease in the melting points makes it easier to favorably distribute the additive element A at a temperature at which the cation mixing is unlikely to occur.

It is further preferable that heat treatment be performed between the synthesis of the composite oxide containing lithium and the transition metal M and the mixing of the additive element A. This heating is referred to as initial heating in some cases.

Owing to influence of lithium extraction from part of the surface portion 100a of the composite oxide containing lithium and the transition metal M by the initial heating, the distribution of the additive element A becomes more favorable.

Specifically, the distributions of the additive elements A can be easily made different from each other by the initial heating in the following mechanism. First, lithium is extracted from part of the surface portion 100a by the initial heating. Next, the additive element A sources such as a nickel source, an aluminum source, and a magnesium source and the composite oxide containing lithium and the transition metal M including the surface portion 100a that is deficient in lithium are mixed and heated. Among the additive elements A, magnesium is a divalent representative element, and nickel is a transition metal but is likely to be a divalent ion. Therefore, in part of the surface portion 100a, a rock-salt phase containing Co²⁺, which is reduced due to lithium deficiency, Mg²⁺, and Ni²⁺ is formed.

Among the additive elements A, nickel is likely to be dissolved and is diffused to the inner portion 100b in the case where the surface portion 100a is the composite oxide that contains lithium and the transition metal M and has a layered rock-salt crystal structure, but nickel is likely to remain in the surface portion 100a in the case where part of the surface portion 100a has a rock-salt crystal structure.

Aluminum is considered to exist at sites other than lithium sites more stably in a layered rock-salt crystal structure than in a rock-salt crystal structure. Thus, in the surface portion 100a, aluminum is more likely to be distributed in a region having a layered rock-salt phase at a larger depth and/or the inner portion 100b than in a region having a rock-salt phase that is close to the surface.

Moreover, the initial heating is expected to increase the crystallinity of the layered rock-salt crystal structure of the inner portion 100b.

However, the initial heating is not necessarily performed. In some cases, by controlling atmosphere, temperature, time, or the like in another heating step, e.g., annealing, the positive electrode active material 100 having the O3′ type structure when x in LiₓCoO₂ is small can be formed.

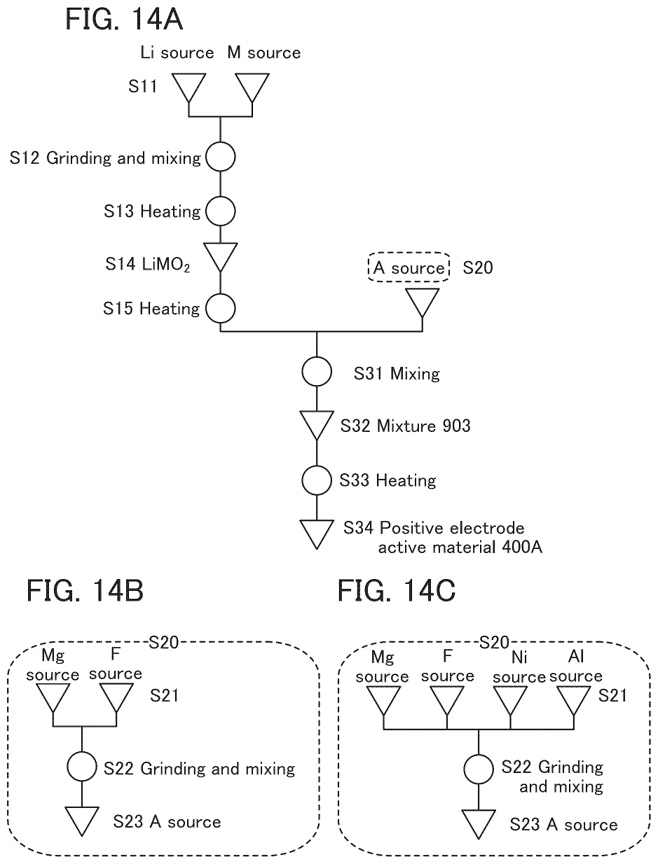

As an example of a method for forming the positive electrode active material 100, an example of a formation flow of a positive electrode active material 400A, in which annealing and the initial heating are performed, is described with reference to FIG. 14A to FIG. 14C.

### <Step S11>

In Step S11 shown in FIG. 14A, a lithium source (Li source) and the transition metal M source (M source) are prepared as materials for lithium and the transition metal M which are starting materials.

As the lithium source, a lithium-containing compound is preferably used and for example, lithium carbonate, lithium hydroxide, lithium nitrate, lithium fluoride, or the like can be used. The lithium source preferably has a high purity and is preferably a material having a purity higher than or equal to 99.99%, for example.

The transition metal M can be selected from the elements belonging to Group 4 to Group 13 of the periodic table and for example, at least one or more of manganese, cobalt, and nickel is used. As the transition metal M, for example, cobalt alone; nickel alone; two metals of cobalt and manganese; two metals of cobalt and nickel; or three metals of cobalt, manganese, and nickel may be used. When cobalt alone is used, the positive electrode active material to be obtained contains lithium cobalt oxide (LCO); when three metals of cobalt, manganese, and nickel are used, the positive electrode active material to be obtained contains lithium nickel cobalt manganese oxide (NCM).

As the transition metal M source, a compound containing the above transition metal M is preferably used and for example, an oxide, a hydroxide, or the like of any of the metals given as examples of the transition metal M can be used. As a cobalt source, cobalt oxide, cobalt hydroxide, cobalt carbonate, or the like can be used. As a manganese source, manganese oxide, manganese hydroxide, or the like can be used. As a nickel source, nickel oxide, nickel hydroxide, or the like can be used.

The transition metal M source preferably has a high purity and is preferably a material having a purity higher than or equal to 3N (99.9%), further preferably higher than or equal to 4N (99.99%), still further preferably higher than or equal to 4N5 (99.995%), yet still further preferably higher than or equal to 5N (99.999%), for example. Impurities of the positive electrode active material can be controlled by using such a high-purity material. As a result, a secondary battery with an increased capacity and/or increased reliability can be obtained.

Furthermore, the transition metal M source preferably has high crystallinity, and preferably includes single crystal particles, for example. To evaluate the crystallinity of the transition metal M source, the crystallinity can be judged by a TEM (transmission electron microscope) image, a STEM (scanning transmission electron microscope) image, a HAADF-STEM (high-angle annular dark field scanning transmission electron microscope) image, an ABF-STEM (annular bright-field scanning transmission electron microscope) image, or the like, or can be judged by X-ray diffraction (XRD), electron diffraction, neutron diffraction, or the like. Note that the above methods for evaluating crystallinity can also be employed to evaluate the crystallinity of other materials in addition to the transition metal M source.

In the case of using two or more transition metal M sources, the two or more transition metal M sources are preferably prepared to have proportions (mixing ratio) such that a layered rock-salt crystal structure would be obtained.

### <Step S12>

Next, in Step S12 shown in FIG. 14A, the lithium source and the transition metal M source are ground and mixed to form a mixed material. The grinding and mixing can be performed by a dry method or a wet method. A wet method is preferable because it can crush a material into a smaller size. When the grinding and mixing are performed by a wet method, a solvent is prepared. As the solvent, ketone such as acetone, alcohol such as ethanol or isopropanol, ether, dioxane, acetonitrile, N-methyl-2-pyrrolidone (NMP), or the like can be used. An aprotic solvent, which is unlikely to react with lithium, is preferably used. In this embodiment, dehydrated acetone with a purity higher than or equal to 99.5% is used. It is preferable that the lithium source and the transition metal M source be mixed into dehydrated acetone whose moisture content is less than or equal to 10 ppm and which has a purity higher than or equal to 99.5% in the crushing and mixing. With the use of dehydrated acetone with the above-described purity, impurities that might be mixed can be reduced.

A ball mill, a bead mill, or the like can be used for the mixing and the like. When a ball mill is used, aluminum oxide balls or zirconium oxide balls are preferably used as a grinding medium. Zirconium oxide balls are preferable because they release fewer impurities. When a ball mill, a bead mill, or the like is used, the peripheral speed is preferably higher than or equal to 100 mm/s and lower than or equal to 2000 mm/s in order to inhibit contamination from the medium. In this embodiment, the peripheral speed is set to 838 mm/s (the rotational frequency is 400 rpm, and the diameter of the ball mill is 40 mm).

### <Step S13>

Next, in Step S13 shown in FIG. 14A, the above mixed material is heated. The heating temperature is preferably higher than or equal to 800° C., and lower than or equal to 1100° C., further preferably higher than or equal to 90° C., and lower than or equal to 100° C., still further preferably approximately 950° C. An excessively low temperature might lead to insufficient decomposition and melting of the lithium source and the transition metal M source. An excessively high temperature might lead to a defect due to evaporation of lithium from the lithium source and/or excessive reduction of the metal used as the transition metal M source, for example. The defect is, for example, an oxygen defect which could be induced by a change of trivalent cobalt into divalent cobalt due to excessive reduction, in the case where cobalt is used as the transition metal M.

When the heating time is too short, LiMO₂ is not synthesized, but when the heating time is too long, the productivity is lowered. For example, the heating time is preferably longer than or equal to 1 hour and shorter than or equal to 100 hours, further preferably longer than or equal to 2 hours and shorter than or equal to 20 hours.

A temperature rising rate is preferably higher than or equal to 80° C./h and lower than or equal to 250° C./h, although depending on the end-point temperature of the heating. For example, in the case of heating at 1000° C. for 10 hours, the temperature rising rate is preferably 200° C./h.

The heating is preferably performed in an atmosphere with little water such as a dry-air atmosphere and for example, the dew point of the atmosphere is preferably lower than or equal to −50° C., further preferably lower than or equal to −80° C. In this embodiment, the heating is performed in an atmosphere with a dew point of −93° C. To reduce impurities that might enter the material, the concentrations of impurities such as CH₄, CO, CO₂, and H₂ in the heating atmosphere are each preferably lower than or equal to 5 ppb (parts per billion).

The heating atmosphere is preferably an oxygen-containing atmosphere. For example, one method, a dry air is continuously introduced into a reaction chamber. The flow rate of a dry air in this case is preferably 10 L/min. Continuously introducing oxygen into a reaction chamber to make oxygen flow therein is referred to as flowing.

In the case where the heating atmosphere is an oxygen-containing atmosphere, flowing is not necessarily performed. For example, the following method may be employed; the pressure in the reaction chamber is reduced, then the reaction chamber is filled with oxygen, and the oxygen is prevented from entering or exiting from the reaction chamber. Such a method is referred to as purging. For example, the pressure in the reaction chamber may be reduced to −970 hPa as measured by a differential pressure gauge, and then, the reaction chamber may be filled with oxygen until the pressure becomes 50 hPa.

Cooling after the heating can be performed by letting the mixed material stand to cool, and the time it takes for the temperature to decrease to room temperature from a predetermined temperature is preferably longer than or equal to 10 hours and shorter than or equal to 50 hours. Note that the temperature does not necessarily need to decrease to room temperature as long as it decreases to a temperature acceptable to the next step.

The heating in this step may be performed with a rotary kiln or a roller hearth kiln. Heating with stirring can be performed in either case of a sequential rotary kiln or a batch-type rotary kiln.

A crucible or a saggar used at the time of the heating is preferably made of alumina (aluminum oxide), mullite cordierite, magnesia, or zirconia, i.e., preferably includes a highly heat-resistant material. Furthermore, since aluminum oxide is a material into which impurities are less likely to enter, the purity of a crucible made of alumina or a saggar is 99% or higher, preferably 99.5% or more. In this embodiment, a crucible made of aluminum oxide with a purity of 99.9% is used. The heating is preferably performed with the crucible or the saggar covered with a lid. Volatilization of the materials can be prevented.

The heated material is ground as needed and may be made to pass through a sieve. Before collection of the heated material, the material may be moved from the crucible to a mortar. As the mortar, a mortar made of aluminum oxide is suitably used. A mortar made of aluminum has a material property that hardly releases impurities. Specifically, a mortar made of aluminum oxide with a purity higher than or equal to 90%, preferably higher than or equal to 99% is used. Note that heating conditions equivalent to those in Step S13 can be employed in a later-described heating step other than Step S13.

### <Step S14>

Through the above steps, a composite oxide including the transition metal M (LiMO₂) can be obtained in Step S14 shown in FIG. 14A. The composite oxide needs to have a crystal structure of a lithium composite oxide represented by LiMO₂, but the composition is not strictly limited to Li:M:O=1:1:2. In the case where cobalt is used as the transition metal M, the composite oxide is referred to as a composite oxide containing cobalt and is represented by LiCoO₂. Note that the composition is not strictly limited to Li:Co:O=1:1:2.

Although the example is described in which the composite oxide is formed by a solid phase method as in Step S11 to Step S14, the composite oxide may be formed by a coprecipitation method. Alternatively, the composite oxide may be formed by a hydrothermal method.

### <Step S15>

Next, in Step S15 shown in FIG. 14A, the above composite oxide is heated. The heating in Step S15 is the first heating performed on the composite oxide and thus, this heating is sometimes referred to as the initial heating. The heating is performed before Step S20 described below and thus is sometimes referred to as preheating or pretreatment.

By the initial heating, lithium is extracted from part of the surface portion 100a of the composite oxide as described above. In addition, an effect of increasing the crystallinity of the inner portion 100b can be expected. The lithium source and/or transition metal M source prepared in Step S11 and the like might contain impurities. The initial heating can reduce impurities in the composite oxide completed in Step 14.

Furthermore, by going through the initial heating, there is an effect that a surface of the composite oxide becomes smooth. A smooth surface of the composite oxide refers to a state of having little unevenness and being rounded as a whole, and its corner portion is rounded. A smooth surface also refers to a surface to which few foreign matters are attached. Foreign matters are deemed to cause unevenness and are preferably not attached to a surface.

For this initial heating, there is no need to prepare a lithium compound source. For the initial heating, there is no need to prepare the additive element A source. Alternatively, there is no need to prepare a material functioning as a fusing agent.

When the heating time in this step is too short, sufficient effect is not obtained, but when the heating time in this step is too long, the productivity is lowered. For example, any of the heating conditions described for Step S13 can be selected. Additionally, the heating temperature in this step is preferably lower than that in Step S13 so that the crystal structure of the composite oxide is maintained. The heating time in this step is preferably shorter than that in Step S13 so that the crystal structure of the composite oxide is maintained. For example, the heating is preferably performed at a temperature higher than or equal to 700° C., and lower than or equal to 1000° C. for longer than or equal to 2 hours and shorter than or equal to 20 hours.

The effect of increasing the crystallinity of the internal portion 100b is, for example, an effect of reducing distortion, a shift, or the like derived from differential shrinkage or the like of the composite oxide formed in Step S13.

The heating in Step S13 might cause a temperature difference between the surface and an inner portion of the above composite oxide. The temperature difference sometimes induces differential shrinkage. It can also be deemed that the temperature difference leads to a fluidity difference between the surface and the inner portion, thereby causing differential shrinkage. The energy involved in differential shrinkage causes a difference in internal stress in the composite oxide. The difference in internal stress is also called distortion, and the above energy is sometimes referred to as distortion energy. The internal stress is eliminated by the initial heating in Step S15 and in other words, the distortion energy is probably equalized by the initial heating in Step S15. When the distortion energy is equalized, the distortion in the composite oxide is relieved. This is probably why the surface of the composite oxide becomes smooth through Step S15. This is also rephrased as modification of the surface. In other words, it is deemed that Step S15 reduces the differential shrinkage caused in the composite oxide to make the surface of the composite oxide smooth.

Such differential shrinkage might cause a micro shift in the composite oxide such as a shift in a crystal. To reduce the shift, this step is preferably performed. Performing this step can distribute a shift uniformly in the composite oxide. When the shift is distributed uniformly, the surface of the composite oxide might become smooth. This is also referred to as alignment of crystal grains. In other words, it is deemed that Step S15 reduces the shift in a crystal or the like which is caused in the composite oxide to make the surface of the composite oxide smooth.

In a secondary battery including a composite oxide with a smooth surface as a positive electrode active material, degradation by charge and discharge is inhibited and a crack in the positive electrode active material can be prevented.

It can be said that when surface unevenness information in one cross section of a composite oxide is quantified with measurement data, a smooth surface of the composite oxide has a surface roughness at least less than or equal to 10 nm. The one cross section is, for example, a cross section obtained in observation using a scanning transmission electron microscope (STEM).

Note that in Step S14, a composite oxide containing lithium, the transition metal M, and oxygen, synthesized in advance may be used. In that case, Step S1 to Step S13 can be omitted. When Step S15 is performed on the pre-synthesized composite oxide, a composite oxide with a smooth surface can be obtained.

The initial heating might reduce lithium in the composite oxide. The additive element A described for Step S20 or the like below might easily enter the composite oxide owing to the reduction in lithium.

### <Step S20>

The additive element A may be added to the composite oxide having a smooth surface as long as a layered rock-salt crystal structure can be obtained. When the additive element A is added to the composite oxide having a smooth surface, the additive element A can be uniformly added. It is thus preferable that the initial heating precede the addition of the additive element A. The step of adding the additive element A is described with reference to FIG. 14B and FIG. 14C.

### <Step S21>

In Step S21 shown in FIG. 14B, an additive element A source (A source) to be added to the composite oxide is prepared. A lithium source may be prepared together with the additive element A sources.

As the additive element A, one or more elements selected from nickel, cobalt, magnesium, calcium, chlorine, fluorine, aluminum, manganese, titanium, zirconium, yttrium, vanadium, iron, chromium, niobium, lanthanum, hafnium, zinc, silicon, sulfur, phosphorus, boron, and arsenic can be used. As the additive element, one or more selected from bromine and beryllium can be used. Note that the additive elements given earlier are more suitable since bromine and beryllium are elements having toxicity to living things.

When magnesium is selected as the additive element A, the additive element A source can be referred to as a magnesium source. As the magnesium source, magnesium fluoride, magnesium oxide, magnesium hydroxide, magnesium carbonate, or the like can be used. Two or more of these magnesium sources may be used.

When fluorine is selected as the additive element A, the additive element A source can be referred to as a fluorine source. As the fluorine source, for example, lithium fluoride, magnesium fluoride, aluminum fluoride, titanium fluoride, cobalt fluoride, nickel fluoride, zirconium fluoride, vanadium fluoride, manganese fluoride, iron fluoride, chromium fluoride, niobium fluoride, zinc fluoride, calcium fluoride, sodium fluoride, potassium fluoride, barium fluoride, cerium fluoride, lanthanum fluoride, sodium aluminum hexafluoride, or the like can be used. In particular, lithium fluoride is preferable because it is easily melted in a heating step described later owing to its relatively low melting point of 848° C.

Magnesium fluoride can be used as both the fluorine source and the magnesium source. Lithium fluoride can be used as the lithium source. Another example of the lithium source that can be used in Step S21 is lithium carbonate.

The fluorine source may be a gas, and fluorine (F₂), carbon fluoride, sulfur fluoride, oxygen fluoride, or the like may be used and mixed in the atmosphere in a heating step described later. Two or more of these fluorine sources may be used.

In this embodiment, lithium fluoride (LiF) is prepared as the fluorine source, and magnesium fluoride (MgF₂) is prepared as the fluorine source and the magnesium source. When lithium fluoride and magnesium fluoride are mixed such that LiF:MgF2 is approximately 65:35 (molar ratio), the effect of lowering the melting point is maximized. Meanwhile, when the proportion of lithium fluoride increases, the cycle performance might be degraded because of an excessive amount of lithium. Therefore, the molar ratio of lithium fluoride to magnesium fluoride is preferably LiF:MgF₂=x:1 (0≤x≤1.9), further preferably LiF:MgF₂=x:1 (0.1≤x≤0.5), still further preferably LiF:MgF2=x:1 (x=0.33 and the neighborhood thereof).

Meanwhile, magnesium is preferably added at greater than 0.1 at % and less than or equal to 3 at %, further preferably greater than or equal to 0.5 at % and less than or equal to 2 at %, still further preferably greater than or equal to 0.5 at % and less than or equal to 1 at %, relative to LiCoO₂. When magnesium is added at less than or equal to 0.1 at %, the initial discharge capacity is high but repeated charge and discharge with a large charge depth rapidly lowers the discharge capacity. In the case where magnesium is added at greater than 0.1 at % and less than or equal to 3 at %, both the initial discharge characteristics and charge and discharge cycle performance are excellent even when charge and discharge with a large charge depth are repeated. By contrast, in the case where magnesium is added at greater than 3 at %, both the initial discharge capacity and the charge and discharge cycle performance tend to deteriorate gradually.

### <Step S22>

Next, in Step S22 shown in FIG. 14B, the magnesium source and the fluorine source are ground and mixed. Any of the conditions for grinding and mixing that are described for Step S12 can be selected to perform this step.

A heating step may be performed after Step S22 as needed. Any of the heating conditions described for Step S13 can be selected to perform the heating step. The heating time is preferably longer than or equal to 2 hours and the heating temperature is preferably higher than or equal to 800° C., and lower than or equal to 1100° C.

### <Step S23>

Next, in Step S23 shown in FIG. 14B, the materials ground and mixed in the above step are collected to give the additive element A source (A source). Note that the additive element A source in Step S23 contains a plurality of starting materials and can be referred to as a mixture.

As for the particle diameter of the mixture, the D50 (median diameter) is preferably greater than or equal to 600 nm and less than or equal to 20 μm, further preferably greater than or equal to 1 μm and less than or equal to 10 μm. Also when one kind of material is used as the additive element A source, the D50 (median diameter) is preferably greater than or equal to 600 nm and less than or equal to 20 μm, further preferably greater than or equal to 1 μm and less than or equal to 10 μm.

Such a pulverized mixture (which may contain only one kind of the additive element A) is easily attached to the surface of a composite oxide particle uniformly in a later step of mixing with the composite oxide. The mixture is preferably attached uniformly to the surface of the composite oxide particle, in which case fluorine and magnesium are easily distributed or dispersed uniformly in a surface portion of the composite oxide after heating. The region where fluorine and magnesium are distributed can be referred to as a surface portion. When there is a region containing neither fluorine nor magnesium in the surface portion, an O3′ type crystal structure, which is described later, might be unlikely to be obtained in a charged state. Note that although fluorine is used in the above description, chlorine may be used instead of fluorine, and a general term “halogen” for these elements can replace “fluorine”.

### <Step S21>

A process different from that in FIG. 14B is described with reference to FIG. 14C. In Step S21 shown in FIG. 14C, four kinds of additive element A sources to be added to the composite oxide are prepared. In other words, FIG. 14C is different from FIG. 14B in the kinds of the additive element A sources. A lithium source may be prepared together with the additive element A sources.

As the four kinds of additive element A sources, a magnesium source (Mg source), a fluorine source (F source), a nickel source (Ni source), and an aluminum source (Al source) are prepared. Note that the magnesium source and the fluorine source can be selected from the compounds and the like described with reference to FIG. 14B. As a nickel source, nickel oxide, nickel hydroxide, or the like can be used. As an aluminum source, aluminum oxide, aluminum hydroxide, or the like can be used.

### <Step S22> and <Step S23>

Next, Step S22 and Step S23 shown in FIG. 14C are similar to the steps described with reference to FIG. 14B.

### <Step S31>

Next, in Step S31 shown in FIG. 14A, the composite oxide and the additive element A source (A source) are mixed. The ratio of the number M of the transition metal atoms in the composite oxide containing lithium, the transition metal M, and oxygen to the number Mg of magnesium atoms contained in the additive element A is preferably M:Mg=100:y (0.1≤y≤6), further preferably M:Mg=100:y (0.3≤y≤3).

The conditions of the mixing in Step S31 are preferably milder than those of the mixing in Step S12 in order not to damage the composite oxide. For example, conditions with a lower rotation frequency or shorter time than those for the mixing in Step S12 are preferable. In addition, it can be said that a dry method has a milder condition than a wet method. For example, a ball mill or a bead mill can be used for the mixing. When a ball mill is used, zirconium oxide balls are preferably used as a medium, for example.

In this embodiment, the mixing is performed with a ball mill using zirconium oxide balls with a diameter of 1 mm by a dry method at 150 rpm for 1 hour. The mixing is performed in a dry room the dew point of which is higher than or equal to −100° C., and lower than or equal to −10° C.

### <Step S32>

Next, in Step S32 in FIG. 14A, the materials mixed in the above step are collected, whereby a mixture 903 is obtained. At the time of the collection, the materials may be crushed as needed and made to pass through a sieve.

Note that in this embodiment, the method is described in which lithium fluoride as the fluorine source and magnesium fluoride as the magnesium source are added afterward to the composite oxide that has been subjected to the initial heating. However, the present invention is not limited to the above method. The magnesium source, the fluorine source, and the like can be added to the lithium source and the transition metal M source in Step S11, i.e., at the stage of the starting materials of the composite oxide. Then, the heating in Step S13 is performed, so that LiMO₂ to which magnesium and fluorine are added can be obtained. In that case, there is no need to separately perform Step S11 to Step S14 and Step S21 to Step S23. This method can be regarded as being simple and highly productive.

Alternatively, the composite oxide to which magnesium and fluorine are added in advance may be used. When a composite oxide to which magnesium and fluorine are added is used, Step S11 to Step S32 and Step S20 can be skipped. This method can be regarded as being simple and highly productive.

Alternatively, to the composite oxide to which magnesium and fluorine are added in advance, a magnesium source and a fluorine source, or a magnesium source, a fluorine source, a nickel source, and an aluminum source may be further added as in Step S20.

### <Step S33>

Then, in Step S33 shown in FIG. 14A, the mixture 903 is heated. Any of the heating conditions described for Step S13 can be selected. The heating time is preferably longer than or equal to 2 hours.

Here, a supplementary explanation of the heating temperature is provided. The lower limit of the heating temperature in Step S33 needs to be higher than or equal to the temperature at which a reaction between the composite oxide (LiMO₂) and the additive element A source proceeds. The temperature at which the reaction proceeds is the temperature at which interdiffusion of the elements included in LiMO₂ and the additive element A source occurs, and may be lower than the melting temperatures of these materials. It is known that in the case of an oxide as an example, solid phase diffusion occurs at the Tamman temperature T_{d} (0.757 times the melting temperature Tₘ). Accordingly, it is only required that the heating temperature in Step S33 be higher than or equal to 500° C.

Needless to say, the reaction more easily proceeds at a temperature higher than or equal to the temperature at which at least part of the mixture 903 is melted. For example, in the case where LiF and MgF₂ are included in the additive element A source, the lower limit of the heating temperature in Step S33 is preferably higher than or equal to 742° C. because the eutectic point of LiF and MgF₂ is around 742° C.

The mixture 903 obtained by mixing such that LiCoO₂:LiF:MgF₂=100:0.33:1 (molar ratio) exhibits an endothermic peak at around 830° C. in differential scanning calorimetry (DSC). Thus, the lower limit of the heating temperature is further preferably higher than or equal to 830° C.

A higher heating temperature is preferable because it facilitates the reaction, shortens the heating time, and enables high productivity.

The upper limit of the heating temperature is lower than the decomposition temperature of LiMO₂ (the decomposition temperature of LiCoO₂ is 1130° C.). At around the decomposition temperature, a slight amount of LiMO₂ might be decomposed. Thus, the upper limit of the heating temperature is preferably lower than or equal to 1000° C., further preferably lower than or equal to 950° C., still further preferably lower than or equal to 900° C.

In view of the above, the heating temperature in Step S33 is preferably higher than or equal to 500° C., and lower than or equal to 1130° C., further preferably higher than or equal to 500° C., and lower than or equal to 1000° C., still further preferably higher than or equal to 500° C. and lower than or equal to 950° C. yet still further preferably higher than or equal to 500° C., and lower than or equal to 900° C. Furthermore, the heating temperature is preferably higher than or equal to 742° C., and lower than or equal to 1130° C. further preferably higher than or equal to 742° C. and lower than or equal to 1000° C., still further preferably higher than or equal to 742° C. and lower than or equal to 950° C., yet still further preferably higher than or equal to 742° C., and lower than or equal to 900° C. Furthermore, the heating temperature is preferably higher than or equal to 800° C., and lower than or equal to 1100° C., further preferably higher than or equal to 830° C. and lower than or equal to 1130° C., still further preferably higher than or equal to 830° C. and lower than or equal to 1000° C. yet still further preferably higher than or equal to 830° C., and lower than or equal to 950° C. yet still further preferably higher than or equal to 830° C., and lower than or equal to 900° C. Note that the heating temperature in Step S33 is preferably higher than that in Step 13.

In addition, at the time of heating the mixture 903, the partial pressure of fluorine or a fluoride originating from the fluorine source or the like is preferably controlled to be within an appropriate range.

In the fabrication method described in this embodiment, some of the materials, e.g., LiF as the fluorine source, function as a flux in some cases. Owing to this function, the heating temperature can be lower than the decomposition temperature of the composite oxide (LiMO₂), e.g., a temperature higher than or equal to 742° C., and lower than or equal to 950° C., which allows distribution of the additive element A such as magnesium in the surface portion and fabrication of the positive electrode active material having favorable characteristics.

However, since LiF in a gas phase has a specific gravity less than that of oxygen, heating might volatilize or sublimate LiF and in that case, LiF in the mixture 903 decreases. As a result, the function of a fusing agent deteriorates. Thus, heating needs to be performed while volatilization of LiF is inhibited. Note that even when LiF is not used as the fluorine source or the like, Li at the surface of LiMO₂ and F of the fluorine source might react to produce LiF, which might be volatilized. Thus, such inhibition of volatilization is needed also when a fluoride having a higher melting point than LiF is used.

In view of this, the mixture 903 is preferably heated in an atmosphere containing LiF, i.e., the mixture 903 is preferably heated in a state where the partial pressure of LiF in the heating furnace is high. Such heating can inhibit volatilization of LiF in the mixture 903.

The heating in this step is preferably performed such that the mixtures 903 are not adhered to each other. Adhesion of the particles of the mixture 903 during the heating might decrease the area of contact with oxygen in the atmosphere and inhibit a path of diffusion of the additive element A (e.g., fluorine), thereby hindering distribution of the additive element A (e.g., magnesium and fluorine) in the surface portion.

It is considered that uniform distribution of the additive element A (e.g., fluorine) in the surface portion leads to a smooth positive electrode active material with little unevenness. Thus, it is preferable that the mixtures 903 not be adhered to each other in order to allow the smooth surface obtained through the heating in Step S15 to be maintained or to be smoother in this step.

In the case of using a rotary kiln for the heating, the heating is preferably performed while the flow rate of an oxygen-containing atmosphere in the kiln is preferably controlled. For example, the flow rate of an oxygen-containing atmosphere is preferably set low, or no flowing of an atmosphere is preferably performed after an atmosphere is purged first and an oxygen atmosphere is introduced into the kiln. Flowing of oxygen is not preferable because it might cause evaporation of the fluorine source, which prevents maintaining the smoothness of the surface.

In the case of using a roller hearth kiln for the heating, the mixture 903 can be heated in an atmosphere containing LiF with the container containing the mixture 903 covered with a lid, for example.

A supplementary explanation of the heating time is provided. The heating time is changed depending on conditions such as the heating temperature and the size and composition of LiMO₂ in Step S14. In the case where the size of LiMO₂ is small, the heating is preferably performed at a lower temperature or for a shorter time than heating in the case where the size is large, in some cases.

In the case where the composite oxide (LiMO₂) in Step S14 in FIG. 14A has a median diameter (D50) of approximately 12 μm, the heating temperature is preferably higher than or equal to 600° C., and lower than or equal to 950° C., for example. The heating time is preferably longer than or equal to 3 hours, further preferably longer than or equal to 10 hours, still further preferably longer than or equal to 60 hours, for example. Note that the temperature decreasing time after the heating is, for example, preferably longer than or equal to 10 hours and shorter than or equal to 50 hours.

In the case where the composite oxide (LiMO₂) in Step S14 has a median diameter (D50) of approximately 5 μm, the heating temperature is preferably higher than or equal to 600° C. and lower than or equal to 950° C., for example. The heating time is preferably longer than or equal to 1 hour and shorter than or equal to 10 hours, further preferably approximately 2 hours, for example. Note that the temperature decreasing time after the heating is, for example, preferably longer than or equal to 10 hours and shorter than or equal to 50 hours.

### <Step S34>

Next, the heated material is collected in Step S34 shown in FIG. 14A, in which crushing is performed as needed; thus, the positive electrode active material 400A is obtained. Here, the collected positive electrode active material 400A is preferably made to pass through a sieve. Through the above steps, the positive electrode active material 400A of one embodiment of the present invention can be fabricated. The positive electrode active material of one embodiment of the present invention has a smooth surface.

### [Negative Electrode]

The negative electrode includes a negative electrode active material layer and a negative electrode current collector. The negative electrode active material layer includes a negative electrode active material, and may further contain a conductive material and a binder. As the structure of the negative electrode active material, the structure described in Embodiment 2 can be used.

### <Electrolyte>

For the electrolyte used in one embodiment of the present invention, a material suitable for a secondary battery having high charge and discharge characteristics and high cycle performance in a middle temperature range can be used. Note that the middle temperature range refers to, for example, higher than or equal to 0° C., and lower than or equal to 45° C., preferably higher than or equal to 0° C., and lower than or equal to 65° C. further preferably higher than or equal to 0° C., and lower than or equal to 85° C. As one mode of the electrolyte, a liquid electrolyte (also referred to as an electrolyte solution) containing a solvent and an electrolyte dissolved in the solvent can be used.

In the case of using a liquid electrolyte for a secondary battery, one of ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate, propyl propionate, methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used, or two or more thereof can be used in an appropriate combination at an appropriate ratio as the electrolyte, for example.

Alternatively, the use of one or more ionic liquids (room temperature molten salts) that are less likely to burn and volatize as the solvent of the electrolyte can prevent a secondary battery from exploding or catching fire even when the secondary battery internally shorts out or the internal temperature increases owing to overcharge or the like. An ionic liquid contains a cation and an anion, specifically, an organic cation and an anion. Examples of the organic cation include aliphatic onium cations such as a quaternary ammonium cation, a tertiary sulfonium cation, and a quaternary phosphonium cation, and aromatic cations such as an imidazolium cation and a pyridinium cation. Examples of the anion include a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, and a perfluoroalkylphosphate anion.

The secondary battery of one embodiment of the present invention includes, as a carrier ion, an alkali metal ion such as a lithium ion, a sodium ion, or a potassium ion or an alkaline earth metal ion such as a calcium ion, a strontium ion, a barium ion, a beryllium ion, or a magnesium ion.

In the case where lithium ions are used as carrier ions, the electrolyte contains lithium salt, for example. As the lithium salt, LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂) (CF₃SO₂), LiN(C₂F₅SO₂)₂, or the like can be used, for example.

In addition, the electrolyte preferably contains fluorine. As the electrolyte containing fluorine, an electrolyte including one kind or two or more kinds of fluorinated cyclic carbonates and lithium ions can be used, for example. The fluorinated cyclic carbonate can improve the nonflammability and improve the safety of the lithium-ion secondary battery.

As the fluorinated cyclic carbonate, an ethylene fluoride carbonate such as monofluoroethylene carbonate (fluoroethylene carbonate, FEC or F1EC), difluoroethylene carbonate (DFEC or F2EC), trifluoroethylene carbonate (F3EC), or tetrafluoroethylene carbonate (F4EC) can be used. Note that DFEC includes an isomer such as cis-4,5 or trans-4,5. For operation at low temperatures, it is important that a lithium ion is solvated by using one kind or two or more kinds of fluorinated cyclic carbonates as the electrolyte and is transported in the electrolyte included in the electrode in charge and discharge. When the fluorinated cyclic carbonate is not used as a small amount of additive but is allowed to contribute to transportation of a lithium ion in charge and discharge, operation can be performed at low temperatures. In the secondary battery, a cluster of approximately several to several tens of lithium ions moves.

The use of the fluorinated cyclic carbonate for the electrolyte can reduce desolvation energy that is necessary for the solvated lithium ion in the electrolyte of the electrode to enter an active material particle. The reduction in the desolvation energy facilitates insertion or extraction of a lithium ion into/from the active material particle even in a low-temperature range. Although a lithium ion sometimes moves remaining in the solvated state, a hopping phenomenon in which coordinated solvent molecules are interchanged occurs in some cases. When desolvation of a lithium ion becomes easy, movement owing to the hopping phenomenon is facilitated and the lithium ion may easily move. A decomposition product of the electrolyte generated by charge and discharge of the secondary battery clings to the surface of the active material, which might cause deterioration of the secondary battery. However, since the electrolyte containing fluorine is smooth, the decomposition product of the electrolyte is less likely to attach to the surface of the active material. Therefore, the deterioration of the secondary battery can be inhibited.

Furthermore, an additive such as vinylene carbonate, propane sultone (PS), tert-butylbenzene (TBB), lithium bis(oxalate)borate (LiBOB), or a dinitrile compound such as succinonitrile or adiponitrile may be added to the electrolyte. The concentration of the additive in the whole electrolyte is, for example, higher than or equal to 0.1 volume % and lower than 5 volume %.

The electrolyte may contain one or more of aprotic organic solvents such as γ-butyrolactone, acetonitrile, dimethoxyethane, and tetrahydrofuran, in addition to the above.

When a gelled high-molecular material is contained in the electrolyte, safety against liquid leakage and the like is improved. Typical examples of the gelled high-molecular material include a silicone gel, an acrylic gel, an acrylonitrile gel, a polyethylene oxide-based gel, a polypropylene oxide-based gel, and a gel of a fluorine-based polymer.

As the high-molecular material, for example, a polymer having a polyalkylene oxide structure, such as polyethylene oxide (PEO): PVDF; polyacrylonitrile; a copolymer containing any of them; and the like can be used. For example, PVDF-HFP, which is a copolymer of PVDF and hexafluoropropylene (HFP), can be used. The formed polymer may be porous.

Although the above structure is an example of a secondary battery using a liquid electrolyte, one embodiment of the present invention is not particularly limited thereto. For example, a semi-solid-state battery or an all-solid-state battery can be fabricated.

In this specification and the like, a layer provided between a positive electrode and a negative electrode is referred to as an electrolyte layer in both the case of a secondary battery using a liquid electrolyte and the case of a semi-solid-state battery. An electrolyte layer of a semi-solid-state battery is a layer formed by deposition, and can be distinguished from a liquid electrolyte layer.

In this specification and the like, a semi-solid-state battery refers to a battery in which at least one of an electrolyte layer, a positive electrode, and a negative electrode includes a semi-solid-state material. The semi-solid-state here does not mean that the proportion of a solid-state material is 50%. The semi-solid-state means having properties of a solid, such as a small volume change, and also having some of properties close to those of a liquid, such as flexibility. A single material or a plurality of materials can be used as long as the above properties are satisfied. For example, a porous solid-state material infiltrated with a liquid material may be used.

In this specification and the like, a polymer electrolyte secondary battery refers to a secondary battery in which an electrolyte layer between a positive electrode and a negative electrode contains a polymer. Polymer electrolyte secondary batteries include a dry (or intrinsic) polymer electrolyte battery and a polymer gel electrolyte battery.

The electrolyte contains a lithium-ion conductive polymer and a lithium salt.

In this specification and the like, the lithium-ion conductive polymer refers to a polymer having conductivity of cations such as lithium. More specifically, the lithium-ion conductive polymer is a high molecular compound containing a polar group to which cations can be coordinated. As the polar group, an ether group, an ester group, a nitrile group, a carbonyl group, siloxane, or the like is preferably included.

As the lithium-ion conductive polymer, for example, polyethylene oxide (PEO), a derivative containing polyethylene oxide as its main chain, polypropylene oxide, polyacrylic acid ester, polymethacrylic acid ester, polysiloxane, polyphosphazene, or the like can be used.

The lithium-ion conductive polymer may have a branched or cross-linking structure.

Alternatively, the lithium-ion conductive polymer may be a copolymer. The molecular weight is preferably greater than or equal to ten thousand, further preferably greater than or equal to hundred thousand, for example.

As a solid electrolyte, a sulfide-based solid electrolyte, an oxide-based solid electrolyte, or a halide-based solid electrolyte can be used, for example.

The sulfide-based solid electrolyte includes a thio-LISICON-based material (e.g., Li₁₀GeP₂S₁₂ or Li_{3.25}Ge_{0.25}P_{0.75}S₄), sulfide glass (e.g., 70Li₂S·30P₂S₅, 30Li₂S·26B₂S₃·44LiI, 63Li₂S·36SiS₂·1Li₃PO₄, 57Li₂S·38SiS₂·5Li₄SiO₄, or 50Li₂S·50GeS₂), or sulfide-based crystallized glass (e.g., Li₇P₃S₁₁ or Li_{3.25}P_{0.95}S₄). The sulfide-based solid electrolyte has advantages such as high conductivity of some materials, low-temperature synthesis, and ease of maintaining a path for electrical conduction after charge and discharge because of its relative softness.

The oxide-based solid electrolyte includes a material with a perovskite crystal structure (e.g., La_{2/3-x}Li₃ₓTiO₃), a material with a NASICON crystal structure (e.g., Li_{1-Y}Al_{Y}Ti_{2-Y}(PO₄)₃), a material with a garnet crystal structure (e.g., Li₇La₃Zr₂O₁₂), a material with a LISICON crystal structure (e.g., Li₁₄ZnGe₄O₁₆), LLZO (Li₇La₃Zr₂O₁₂), oxide glass (e.g., LisPO₄—Li₄SiO₄ or 50Li₄SiO₄·50Li₃BO₃), or oxide-based crystallized glass (e.g., Li_{1.07}Al_{0.69}Ti_{1.46}(PO₄)₃ or Li_{1.5}Al_{0.5}Ge_{1.5}(PO₄)₃). The oxide-based solid electrolyte has an advantage of stability in the air.

Examples of the halide-based solid electrolyte include LiAlCl₄, Li₃InBr₆, LiF, LiCl, LiBr, and Lil. Moreover, a composite material in which pores of porous aluminum oxide or porous silica are filled with such a halide-based solid electrolyte can be used as the solid electrolyte.

Alternatively, different solid electrolytes may be mixed and used.

In particular, Li₁₋ₓ AlₓTi₂₋ₓPO₄)₃(0<x<1) having a NASICON crystal structure (hereinafter, LATP) is preferable because LATP contains aluminum and titanium, each of which is the element the positive electrode active material used in the secondary battery of one embodiment of the present invention is allowed to contain, and thus a synergistic effect of improving the cycle performance is expected. Moreover, higher productivity due to the reduction in the number of steps is expected. Note that in this specification and the like, a NASICON crystal structure refers to a compound that is represented by M₂(XO₄)₃ (M: transition metal, X: S. P, As, Mo, W, or the like) and has a structure in which MO₆ octahedrons and XO₄ tetrahedrons that share common corners are arranged three-dimensionally.

### [Separator]

When the electrolyte includes an electrolyte solution, a separator is placed between the positive electrode and the negative electrode. As a separator structure, the structure described in Embodiment 2 can be used.

### [Exterior Body]

As a structure of the exterior body, the structure described in Embodiment 2 can be used.

The contents of this embodiment can be freely combined with the contents of the other embodiments.

### Embodiment 4

This embodiment describes examples of shapes of several types of secondary batteries including a positive electrode or a negative electrode formed by the formation method described in the above embodiment.

### [Coin-Type Secondary Battery]

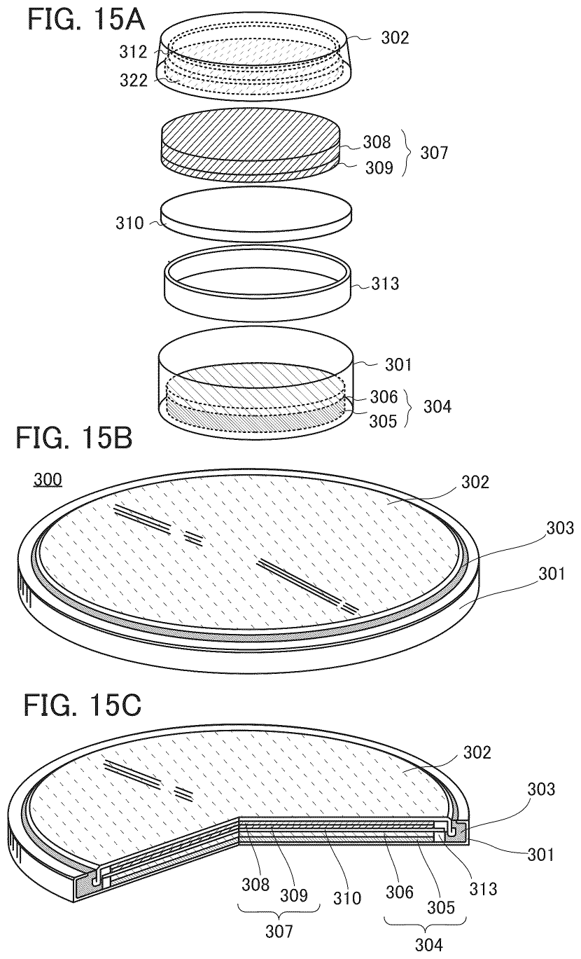

An example of a coin-type secondary battery is described. FIG. 15A is an exploded perspective view of a coin-type (single-layer flat type) secondary battery, FIG. 15B is an external view, and FIG. 15C is a cross-sectional view thereof. Coin-type secondary batteries are mainly used in small electronic devices. In this specification and the like, coin-type batteries include button-type batteries.

For easy understanding, FIG. 15A is a schematic view illustrating overlap (a vertical relation and a positional relation) between components. Thus, FIG. 15A and FIG. 15B do not completely correspond with each other.

In FIG. 15A, a positive electrode 304, a separator 310, a negative electrode 307, a spacer 322, and a washer 312 are overlaid. They are sealed with a negative electrode can 302 and a positive electrode can 301. Note that a gasket for sealing is not illustrated in FIG. 15A. The spacer 322 and the washer 312 are used to protect the inside or fix the position inside the cans at the time when the positive electrode can 301 and the negative electrode can 302 are bonded with pressure. For the spacer 322 and the washer 312, stainless steel or an insulating material is used.

The positive electrode 304 has a stacked-layer structure in which a positive electrode active material layer 306 is formed over a positive electrode current collector 305.

To prevent a short circuit between the positive electrode and the negative electrode, the separator 310 and a ring-shaped insulator 313 are placed to cover the side surface and top surface of the positive electrode 304. The separator 310 has a larger flat surface area than the positive electrode 304.

FIG. 15B is a perspective view of a completed coin-type secondary battery.

In a coin-type secondary battery 300, the positive electrode can 301 doubling as a positive electrode terminal and the negative electrode can 302 doubling as a negative electrode terminal are insulated from each other and sealed by a gasket 303 made of polypropylene or the like. The positive electrode 304 includes the positive electrode current collector 305 and the positive electrode active material layer 306 provided in contact with the positive electrode current collector 305. The negative electrode 307 includes a negative electrode current collector 308 and a negative electrode active material layer 309 provided in contact with the negative electrode current collector 308. The negative electrode 307 is not limited to having a stacked-layer structure, and lithium metal foil or lithium-aluminum alloy foil may be used.

Note that only one surface of the current collector of each of the positive electrode 304 and the negative electrode 307 used for the coin-type secondary battery 300 is provided with an active material layer.

For the positive electrode can 301 and the negative electrode can 302, a metal having corrosion resistance to an electrolyte, such as nickel, aluminum, or titanium, an alloy of such a metal, or an alloy of such a metal and another metal (e.g., stainless steel) can be used. The positive electrode can 301 and the negative electrode can 302 are preferably covered with nickel, aluminum, or the like in order to prevent corrosion due to the electrolyte, for example. The positive electrode can 301 and the negative electrode can 302 are electrically connected to the positive electrode 304 and the negative electrode 307, respectively.

The negative electrode 307, the positive electrode 304, and the separator 310 are immersed in the electrolyte solution. Then, as illustrated in FIG. 15C, the positive electrode 304, the separator 310, the negative electrode 307, and the negative electrode can 302 are stacked in this order with the positive electrode can 301 positioned at the bottom, and the positive electrode can 301 and the negative electrode can 302 are bonded with pressure with the gasket 303 therebetween. In this manner, the coin-type secondary battery 300 is fabricated.

With the above-described structure, the coin-type secondary battery 300 can have high capacity, high charge and discharge capacity, and excellent cycle performance. Note that in the case of a secondary battery including a solid electrolyte layer between the negative electrode 307 and the positive electrode 304, the separator 310 is not necessarily provided.

### [Cylindrical Secondary Battery]

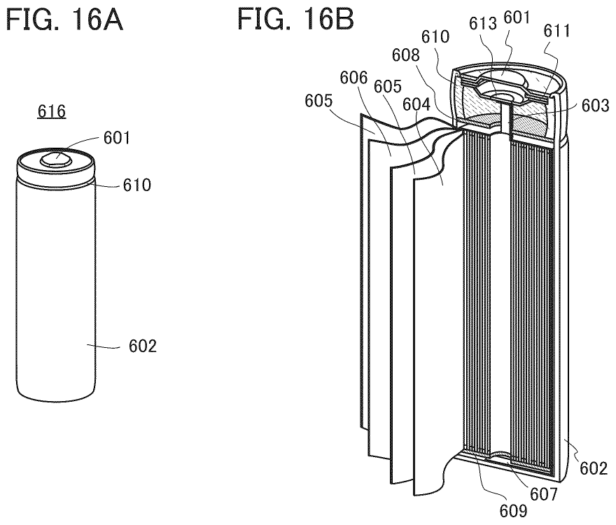

An example of a cylindrical secondary battery is described with reference to FIG. 16A. As illustrated in FIG. 16A, a cylindrical secondary battery 616 includes a positive electrode cap (battery cap) 601 on the top surface and a battery can (outer can) 602 on the side surface and bottom surface. The positive electrode cap 601 and the battery can (outer can) 602 are insulated from each other by a gasket (insulating gasket) 610.

FIG. 16B schematically illustrates a cross section of a cylindrical secondary battery. The cylindrical secondary battery illustrated in FIG. 16B includes the positive electrode cap (battery cap) 601 on the top surface and the battery can (outer can) 602 on the side surface and the bottom surface. The positive electrode cap 601 and the battery can (outer can) 602 are insulated from each other by the gasket (insulating gasket) 610.

Inside the battery can 602 having a hollow cylindrical shape, a battery element in which a belt-like positive electrode 604 and a belt-like negative electrode 606 are wound with a belt-like separator 605 interposed therebetween is provided. Although not illustrated, the battery element is wound around a central axis. One end of the battery can 602 is close and the other end thereof is open. For the battery can 602, a metal having corrosion resistance to an electrolyte solution, such as nickel, aluminum, or titanium, an alloy of such a metal, or an alloy of such a metal and another metal (e.g., stainless steel) can be used. The battery can 602 is preferably covered with nickel, aluminum, or the like in order to prevent corrosion due to the electrolyte solution. Inside the battery can 602, the battery element in which the positive electrode, the negative electrode, and the separator are wound is provided between a pair of insulating plates 608 and 609 that face each other. A nonaqueous electrolyte solution (not illustrated) is injected inside the battery can 602 provided with the battery element. A nonaqueous electrolyte solution similar to that for the coin-type secondary battery can be used.

Since a positive electrode and a negative electrode that are used for a cylindrical secondary battery are wound, active materials are preferably formed on both surfaces of a current collector. Note that although FIG. 16A and FIG. 16B each illustrate the secondary battery 616 in which the height of the cylinder is larger than the diameter of the cylinder, one embodiment of the present invention is not limited thereto. In a secondary battery, the diameter of the cylinder may be larger than the height of the cylinder. Such a structure can reduce the size of a secondary battery, for example.

The positive electrode active material 100 obtained in the above embodiment is used for the positive electrode 604, whereby the cylindrical secondary battery 616 can have high capacity, high charge and discharge capacity, and excellent cycle performance.

A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a PTC (Positive Temperature Coefficient) element 611. The safety valve mechanism 613 cuts off electrical connection between the positive electrode cap 601 and the positive electrode 604 when the increased internal pressure of the battery exceeds a predetermined threshold. The PTC element 611, which is a thermally sensitive resistor whose resistance increases as temperature rises, limits the amount of current by increasing the resistance, in order to prevent abnormal heat generation. Banum titanate (BaTiO₃)-based semiconductor ceramics or the like can be used for the PTC element.

### [Angular Secondary Battery]

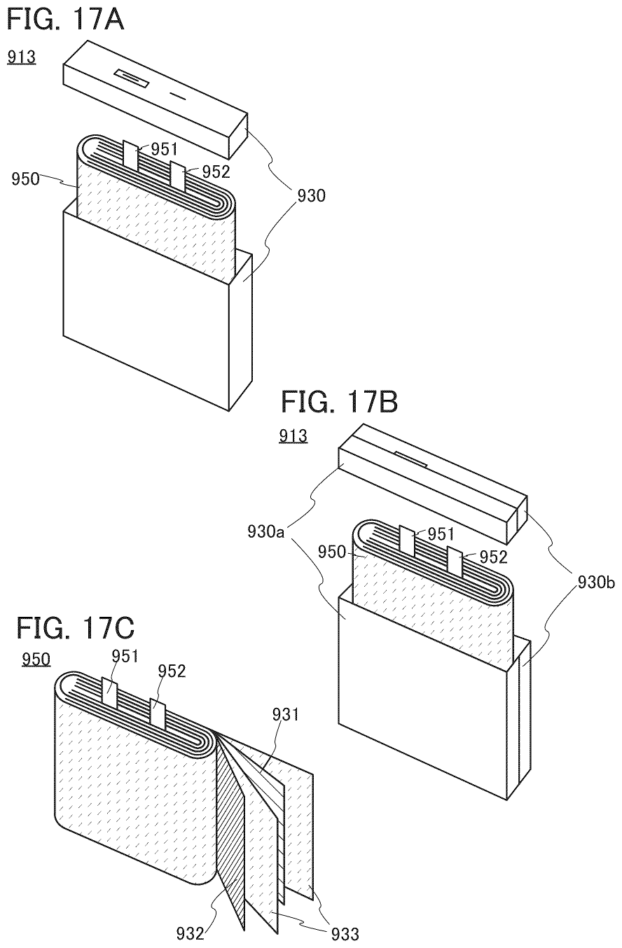

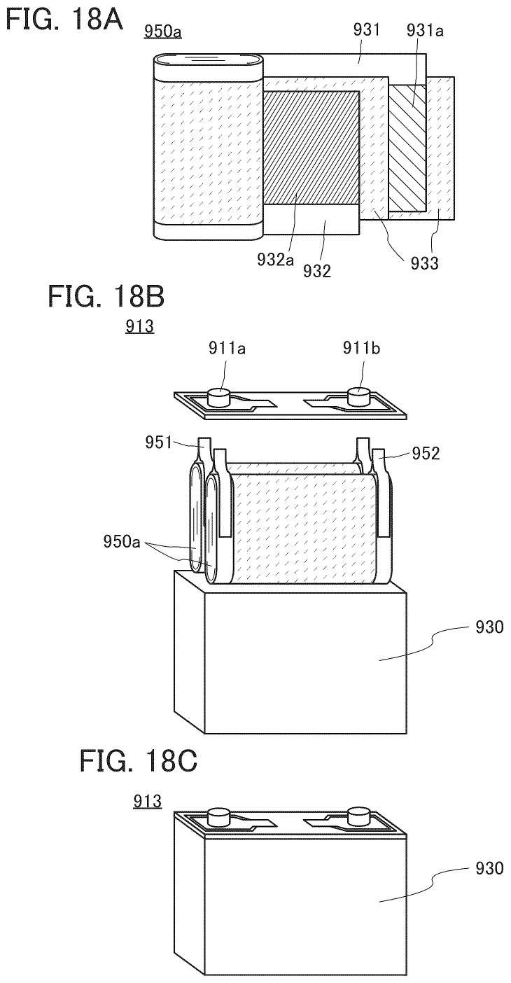

Structure examples of angular secondary batteries are described with reference to FIG. 17 and FIG. 18. An angular secondary battery refers to a secondary battery including an exterior body (housing) having a rectangular solid shape.

The secondary battery 913 illustrated in FIG. 17A includes a wound body 950 provided with the terminal 951 and the terminal 952 inside a housing 930. The wound body 950 is immersed in an electrolyte solution inside the housing 930. The terminal 952 is in contact with the housing 930. The use of an insulator or the like prevents contact between the terminal 951 and the housing 930. Note that in FIG. 17A, the housing 930 divided into pieces is illustrated for convenience; however, in the actual structure, the wound body 950 is covered with the housing 930 and the terminal 951 and the terminal 952 extend to the outside of the housing 930. For the housing 930, a metal material (e.g., aluminum) or a resin material can be used.

Note that as illustrated in FIG. 17B, the housing 930 illustrated in FIG. 17A may be formed using a plurality of materials. For example, in the secondary battery 913 illustrated in FIG. 17B, a housing 930a and a housing 930b are bonded to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field by the secondary battery 913 can be inhibited. When an electric field is not significantly blocked by the housing 930a, an antenna may be provided inside the housing 930a. For the housing 930b, a metal material can be used, for example.

FIG. 17C illustrates the structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with each other with the separator 933 therebetween. Note that a plurality of stacks each including the negative electrode 931, the positive electrode 932, and the separators 933 may be further stacked.

As illustrated in FIG. 18A to FIG. 18C, the secondary battery 913 may include a wound body 950a. The wound body 950a illustrated in FIG. 18A includes the negative electrode 931, the positive electrode 932, and the separators 933. The negative electrode 931 includes a negative electrode active material layer 931a. The positive electrode 932 includes a positive electrode active material layer 932a.

The positive electrode active material 100 obtained in the above embodiment is used for the positive electrode 932, whereby the secondary battery 913 can have high capacity, high charge and discharge capacity, and excellent cycle performance.

The separator 933 has a larger width than the negative electrode active material layer 931a and the positive electrode active material layer 932a, and is wound to overlap with the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high level of safety and high productivity.

As illustrated in FIG. 18B, the negative electrode 931 is electrically connected to the terminal 951. The terminal 951 is electrically connected to a terminal 911a. The positive electrode 932 is electrically connected to the terminal 952. The terminal 952 is electrically connected to a terminal 911b.

As illustrated in FIG. 18C, the wound body 950a and an electrolyte solution are covered with the housing 930, whereby the secondary battery 913 is completed. The housing 930 is preferably provided with a safety valve, an overcurrent protection element, and the like. In order to prevent the battery from exploding, a safety valve is a valve to be released when the internal pressure of the housing 930 reaches a predetermined pressure.

As illustrated in FIG. 18B, the secondary battery 913 may include a plurality of wound bodies 950a. The use of the plurality of wound bodies 950a enables the secondary battery 913 to have higher charge and discharge capacity. The description of the secondary battery 913 illustrated in FIG. 17A to FIG. 17C can be referred to for the other components of the secondary battery 913 illustrated in FIG. 18A and FIG. 18B.

### <Laminated Secondary Battery>

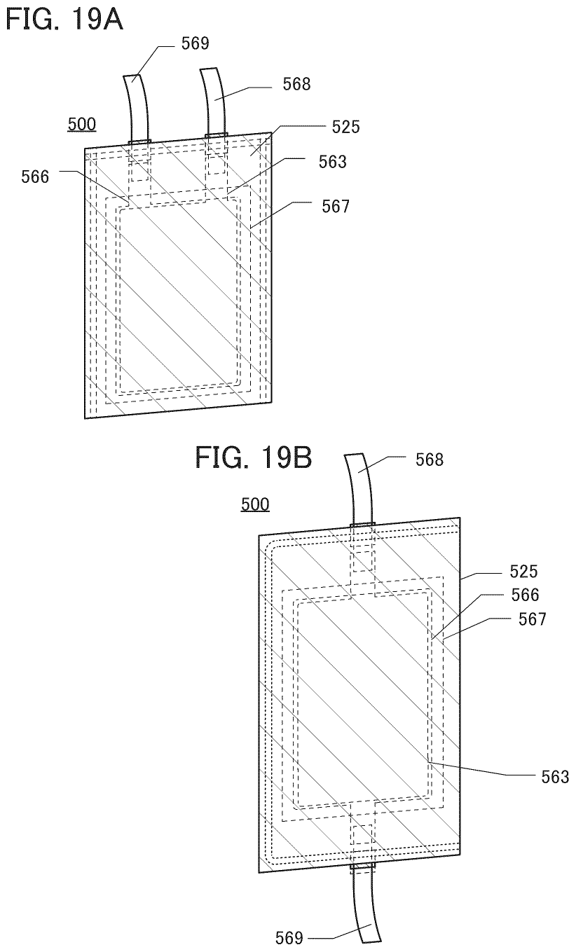

Next, examples of the appearance of a laminated secondary battery are illustrated in FIG. 19A and FIG. 19B. In FIG. 19A and FIG. 19B, a positive electrode 563, a negative electrode 566, a separator 567, an exterior body 525, a positive electrode lead electrode 568, and a negative electrode lead electrode 569 are included.

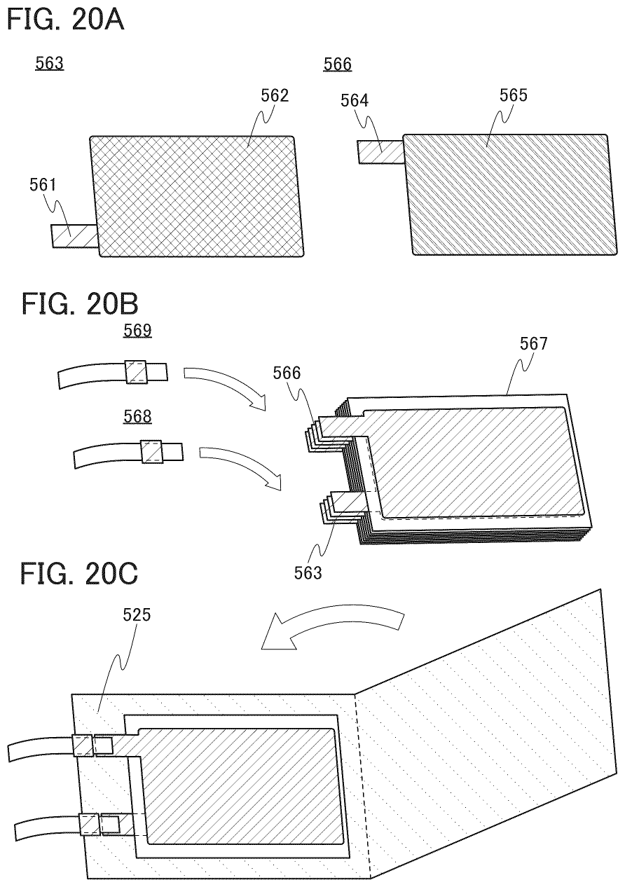

FIG. 20A illustrates external views of the positive electrode 563 and the negative electrode 566. The positive electrode 563 includes a positive electrode current collector 561, and a positive electrode active material layer 562 is formed on a surface of the positive electrode current collector 561. The positive electrode 563 also includes a region where the positive electrode current collector 561 is partly exposed (hereinafter, referred to as a tab region). The negative electrode 566 includes a negative electrode current collector 564, and a negative electrode active material layer 565 is formed on a surface of the negative electrode current collector 564. The negative electrode 566 also includes a region where the negative electrode current collector 564 is partly exposed, that is, a tab region. The areas and the shapes of the tab regions included in the positive electrode and the negative electrode are not limited to the examples illustrated in FIG. 20A.

### <Fabrication Method of Laminated Secondary Battery>

Here, an example of a method for fabricating the laminated secondary battery whose external view is illustrated in FIG. 19A is described with reference to FIG. 20B and FIG. 20C.

First, the negative electrode 566, the separator 567, and the positive electrode 563 are stacked. FIG. 20B illustrates the negative electrode 566, the separator 567, and the positive electrode 563 that are stacked. Here, an example in which five negative electrodes and four positive electrodes are used is shown. The stacked negative electrodes, separators, and positive electrodes can be referred to as a stack. Next, the tab regions of the positive electrodes 563 are bonded to each other, and the positive electrode lead electrode 568 is bonded to the tab region of the positive electrode on the outermost surface. The bonding can be performed by ultrasonic welding, for example. In a similar manner, the tab regions of the negative electrodes 566 are bonded to each other, and the negative electrode lead electrode 569 is bonded to the tab region of the negative electrode on the outermost surface.

After that, the negative electrodes 566, the separators 567, and the positive electrodes 563 are placed over the exterior body 525.

Next, the exterior body 525 is bent along a portion shown by a dashed line, as illustrated in FIG. 20C. Then, the outer edges of the exterior body 525 are bonded to each other. The bonding can be performed by thermocompression, for example. At this time, an unbonded region (hereinafter referred to as an inlet) is provided for part (or one side) of the exterior body 525 so that an electrolyte solution can be introduced later.

Next, the electrolyte solution is introduced into the exterior body 525 from the inlet of the exterior body 525. The electrolyte solution is preferably introduced in a reduced pressure atmosphere or in an inert atmosphere. Lastly, the inlet is sealed by bonding. In this manner, the laminated secondary battery 500 can be fabricated.

The contents of this embodiment can be freely combined with the contents in the other embodiments.

### Embodiment 5

In this embodiment, a structure example of a bendable battery and examples of a fabricating method thereof will be described.

### [Bendable Secondary Battery]

One embodiment of the present invention is a bendable battery. For an exterior body of the battery, a film in the shape of a periodic wave in one direction is used. The use of the wave shape for the exterior body relieves stress when the exterior body is bent because the form of the exterior body changes such that the period and amplitude of the wave are changed, preventing the exterior body from being damaged.

An electrode stack included in a battery of one embodiment of the present invention is characterized in that a portion to which a tab or the like is connected is fixed and the relative positions of electrodes are shifted in the other portion. When the exterior body of the battery is bent, the electrode stack can change its shape with the fixed point used as a support such that the relative positions of the electrodes are shifted.

One embodiment of the present invention further includes a space in an area surrounded by the exterior body and between an end portion of the electrode stack that is not fixed and an inner wall of the exterior body. The space allows the electrode stack to shift when the battery is bent, preventing the portion of the electrode stack and the inner wall of the exterior body from coming in contact with each other. One embodiment of the present invention can prevent the exterior body from being broken by the contact between the electrode stack and the exterior body accompanying the change in the form of the electrode stack, regardless of the thickness of the electrode stack. For example, even in the case where the thickness of the battery is larger than 400 μm, larger than or equal to 500 μm, or larger than or equal to 1 mm, changing the form, such as bending, can be safely repeated. It is needless to say that one embodiment of the present invention can also be used for a very thin battery with a thickness of greater than or equal to 1 μm and less than or equal to 400 μm.

There is no limitation on the thickness of the battery as long as it is determined in accordance with the capacity required for an electronic device into which the battery is incorporated, the shape of the device, or the like so that the thickness is suitable for a use. For example, the thickness is smaller than or equal to 10 mm, preferably smaller than or equal to 5 mm, further preferably smaller than or equal to 4 mm, still further preferably smaller than or equal to 3 mm.

To form a larger space between the inner wall of the exterior body and the electrode stack, the phases of waves of a pair of portions of the exterior body between which the electrode stack is sandwiched are preferably different from each other. Specifically, it is preferred that wave crest lines of one of the pair of portions between which the electrode stack is located not overlap with wave trough lines of the other portion. It is particularly preferred that the phases of the waves of the pair of portions of the exterior body between which the electrode stack is located be different from each other by 180° so that wave crest lines overlap with each other and wave trough lines overlap with each other. In that case, a space that ensures the largest distance between the electrode stack and the exterior body can be formed. In contrast, it is not preferred that the phases of the waves of the pair of portions be coordinate so that wave crest lines of one of the portions overlap with wave trough lines of the other portion. In that case, a space is formed to be distorted and the distance between the electrode stack and the exterior body is the shortest.

One embodiment of the present invention can be fabricated, for example, in such a manner that a film is folded in half in the direction parallel to wave crest lines and wave trough lines with an electrode stack therebetween and bonding is performed by application of pressure and heat such that at least two sides perpendicular to the folded portion become flat. Furthermore, it is preferred that the film be folded in half such that the phases of waves of opposite portions of the film are at least different from each other. It is particularly preferred that the film be folded such that the phases of the waves are different from each other by 180°.

Here, the phases of the waves of the pair of portions of the exterior body between which the electrode stack is sandwiched might be changed after the bonding. Even in that case, at least a region adjacent to the folded portion preferably includes a portion in which the phases of the waves of the pair of portions are different from each other, after the bonding.

The bonding makes the two sides of the film between which the electrode stack is located longer than the natural length before the bonding. This generates tensile force in the direction perpendicular to wave crest lines and wave trough lines in a portion overlapping with the electrode stack. Meanwhile, reaction in the direction opposite to that of the tensile force occurs in the portion overlapping with the electrode stack so that the wave shape is maintained. The reaction decreases as the distance from the folded portion decreases; thus, the exterior body changes its shape such that the wave thereof is stretched as the distance from the folded portion decreases. Specifically, the exterior body changes its shape such that the length of the wave period increases and the wave amplitude decreases as the distance from the folded portion decreases. Through such a mechanism, the bonding is performed such that a bonding portion becomes sufficiently flat, whereby a space can be formed between the folded portion and the electrode stack.

The shape of the wave of the film is important for formation of an enough space between the inner wall of the exterior body and the electrode stack. A larger space can be formed as the length of the wave period of the film decreases and the wave amplitude increases. For example, a film in the wave shape is preferably used for the exterior body, in which the ratio of the length of the film when it is stretched to the natural length thereof is 1.02 or more, preferably 1.05 or more, further preferably 1.1 or more, and 2 or less. Any of a variety of shapes such as a sine-wave shape, a triangular-wave shape, an arc shape, and a rectangular shape can be used as the wave shape as long as the wave shape has at least repeated projections and depressions in one direction. A large wave amplitude might increase the volume of the battery; thus, the length of the wave period is preferably set small so that the ratio of the length of the film when it is stretched to the natural length thereof is high.

Conditions for the bonding are also important for formation of an enough space. Insufficient bonding might result in a wavy shape of the bonding portion instead of a flat shape, failing to form an enough space. Moreover, insufficient bonding might forma gap in the bonding portion when the battery changes its form, because the bonding is performed with the phases of the waves different from each other. However, the use of an optimized bonding method can avoid such problems. Preferred conditions for the bonding depend on a material of the film, a material of an adhesive used for the bonding, or the like; for example, in the case where polypropylene is used for a heat-sealing layer, pressure that enables planarization of an embossed wave shape is applied at a temperature higher than or equal to the melting point of polypropylene. Furthermore, it is preferred that the bonding be performed by applying a high pressure to a portion of the bonding portion in the direction perpendicular to the embossed wave shape (side sealing portion) compared with a portion of the bonding portion in the direction parallel to the embossed wave shape (top sealing portion).

Since one embodiment of the present invention allows the shape of a secondary battery to be freely designed, when a secondary battery having a curved surface is used, for example, the design flexibility of the whole electronic device is increased, and electronic devices having a variety of designs can be provided. Furthermore, when the secondary battery is provided along the inner surface of an electronic device having a curved surface, a space in the electronic device can be effectively used with no waste.

Furthermore, one embodiment of the present invention can increase the capacity of a secondary battery; accordingly, an electronic device can be used for a long time with a low frequency of charge.

Thus, an electronic device having a novel structure can be provided.

More specific structure examples and a fabrication method example will be described below with reference to drawings.

### [Structure Example]

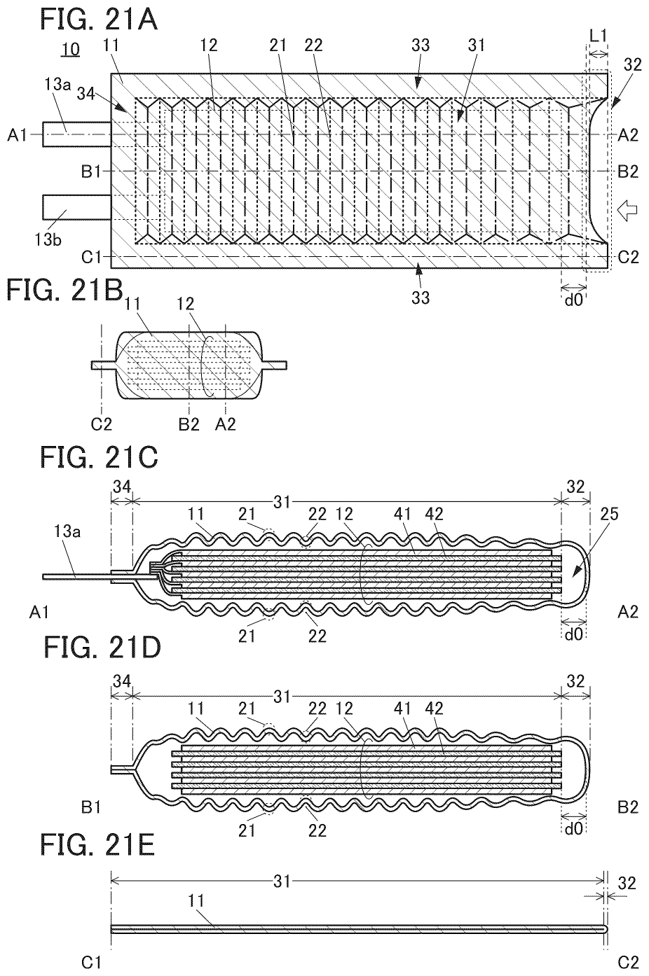

FIG. 21A is a plan view of a battery 10 described below as an example. FIG. 21B is a view of the battery 10 seen from the direction shown by an arrow in FIG. 21A. FIG. 21C, FIG. 21D, and FIG. 21E are schematic cross-sectional views taken along A1-A2, B1-B2, and C1-C2 in FIG. 21A, respectively.

The battery 10 includes an exterior body 11, a stack 12 held in the exterior body 11, and an electrode 13a and an electrode 13b that are electrically connected to the stack 12 and extend to the outside of the exterior body 11. In addition to the stack 12, an electrolyte is enclosed in the exterior body 11.

The exterior body 11 has a film-like shape and is folded in half so as to sandwich the stack 12. The exterior body 11 includes a pair of portions 31 between which the stack is sandwiched, a folded portion 32, a pair of bonding portions 33, and a bonding portion 34. The pair of bonding portions 33 is belt-like portions extending in the direction substantially perpendicular to the folded portion 32 and is provided with a portion 31 therebetween. The bonding portion 34 is a belt-like portion located opposite to the folded portion 32 with the portion 31 therebetween. The portion 31 can also be referred to as a region surrounded by the folded portion 32, the pair of bonding portions 33, and the bonding portion 34. Here, the electrode 13a and the electrode 13b are partly sandwiched by the bonding portion 34 in FIG. 21A and the like.

At least a surface of the portion 31 of the exterior body 11 has a wave shape in which projections and depressions are repeated in the direction in which the pair of bonding portions 33 extends. In other words, the portion 31 has a wave shape in which crest lines 21 and trough lines 22 are alternately repeated. In FIG. 21A and the like, the crest lines 21 connecting top portions of the projections are shown by dashed-dotted lines, and the trough lines 22 connecting bottom portions of the troughs are shown by dashed lines.

In the plan view of the exterior body 11, the length of each bonding portion 33 in the extension direction is longer than the total length of the bonding portion 34, the portion 31, and the folded portion 32 in the direction parallel to the extension direction of the bonding portion 33. As illustrated in FIG. 21A, a portion of the folded portion 32 that is located closest to the bonding portion 34 is closer to the bonding portion 34 by a distance L1 from a line connecting end portions of the pair of bonding portions 33 on the folded portion 32 side.

The stack 12 at least has a structure where positive electrodes and negative electrodes are alternately stacked. The stack 12 can also be called an electrode stack. Furthermore, separators may be provided between the positive electrodes and the negative electrodes. Here, as the number of layers in the stack 12 increases, the capacity of the battery 10 can increase. The details of the stack 12 will be described later.

Here, the thickness of the stack 12 is, for example, larger than or equal to 200 μm and smaller than or equal to 9 mm, preferably larger than or equal to 400 μm and smaller than or equal to 3 mm, further preferably larger than or equal to 500 μm and smaller than or equal to 2 mm, and is typically approximately 1.5 mm.

As illustrated in FIG. 21A, FIG. 21C, and FIG. 21D, in the exterior body 11, a space 25 (also referred to as a gap or a hollow) is provided between an end portion of the stack 12 that is closest to the folded portion 32 and an interior surface of the exterior body 11 that is located in the folded portion 32. Here, the length of the space 25 in the direction parallel to the extending direction of the bonding portions 33 is represented by a distance d0. The distance d0 can also be referred to as the distance between the end portion of the stack 12 that is closest to the folded portion 32 and the interior surface of the exterior body 11 that is located in the folded portion 32.

The stack 12 is bonded to the electrode 13a (and the electrode 13b) extending inside and outside the area surrounded by the exterior body 11 through the bonding portion 34. Thus, it can also be said that the relative positions of the stack 12 and the exterior body 11 are fixed by the bonding portion 34. The electrode 13a is bonded to the plurality of positive electrodes or the plurality of negative electrodes in the stack 12, and the electrode 13b is connected to the plurality of positive electrodes or the plurality of negative electrodes to which the electrode 13a is not bonded.

Furthermore, as illustrated in FIG. 21 A, FIG. 21C, and FIG. 21D, it is preferred that the portion 31 of the exterior body 11 include a region in which the length of the wave period increases and the wave amplitude decreases as the distance from the folded portion 32 decreases. When the battery 10 is fabricated to have such a structure, the space 25 can be formed in the area surrounded by the exterior body 11.

As illustrated in FIG. 21C and FIG. 21D, it is best the pair of portions 31 between which the stack 12 is sandwiched face each other such that the phases of the waves of the portions 31 are different from each other by 180°. In other words, it is preferred that the exterior body 11 be folded with the stack 12 therebetween such that the crest lines 21 overlap with each other and the trough lines 22 overlap with each other. In that case, the space 25 with a favorable shape can be provided.

### [Space]

Next, the bent form of the battery provided with the space 25 will be described.

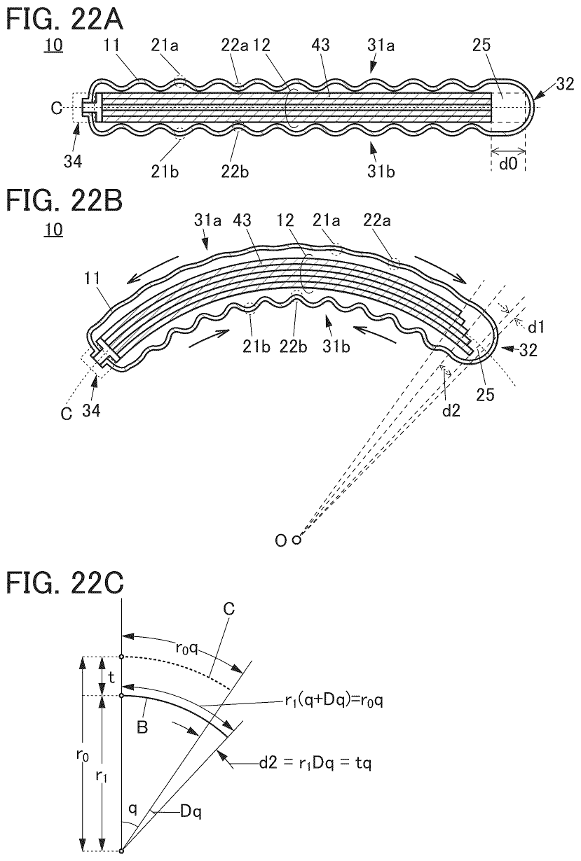

FIG. 22A is a simple schematic cross-sectional view of the structure of the battery 10 that is partly illustrated.

Here, the pair of portions 31 of the exterior body 11 is distinguished from each other and shown as a portion 31a and a portion 31b. Similarly, respective crest lines and respective trough lines of the portion 31a and the portion 31b are shown as a crest line 21a and a crest line 21b, and a trough line 22a and a trough line 22b.

In FIG. 22A, the stack 12 has a structure in which five electrodes 43 are stacked. The electrode 43 corresponds to the electrode 41 or the electrode 42 in FIG. 21A. The relative positions of the plurality of electrodes 43 are fixed at an end portion on the bonding portion 34 side. The relative positions of the stack 12 and the exterior body 11 are fixed by the bonding portion 34.

In the area surrounded by the exterior body 11, the space 25 is provided in the vicinity of the folded portion 32. Here, the distance between the inner wall of the exterior body 11 and the end portion of the electrode 43 on the folded portion 32 side when the exterior body 11 is not bent is assumed to be the distance do.

The neutral plane of the battery 10 is referred to as a neutral plane C. Here, the neutral plane C corresponds to the neutral plane of the electrode 43 that is located in the middle of the five electrodes 43 included in the stack 12.

FIG. 22B is a schematic cross-sectional view of the battery 10 in the state of being bent with a point Oat the center to have an arc shape. Here, the battery 10 is bent such that the portion 31a faces outward and the portion 31b faces inward.

As illustrated in FIG. 22B, the portion 31a that is positioned on the outer side changes its form such that the wave amplitude becomes smaller and the length of the wave period becomes larger. In other words, the distance between the crest lines 21a of the portion 31a that is positioned on the outer side and the distance between the trough lines 22b increase. By contrast, a portion 31b that is positioned on the inner side changes its form such that the wave amplitude becomes larger and the length of the wave period becomes shorter. In other words, the distance between the crest lines 21b and the distance between the trough lines 22b of the portion 31b that is positioned on the inner side and is in the state of being bent decrease. In such a manner, the portion 31a and the portion 31b change their forms, whereby stress applied to the exterior body 11 is relieved, and the battery 10 can be bent without any damage to the exterior body 11.

As illustrated in FIG. 22B, the stack 12 changes its form such that the relative positions of the plurality of electrodes 43 are shifted. This relieves stress applied to the stack 12, allowing the battery 10 to be bent without any damage to the stack 12. It is assumed in FIG. 22B that the electrodes 43 themselves do not stretch due to a bend. When the thickness of the electrode 43 is set sufficiently small with respect to the curvature radius with which the battery 10 is bent, less stress is applied to the electrodes 43 themselves.

The end portions of the electrodes 43 included in the stack 12 that are located outward from the neutral plane C shift to the bonding portion 34 side.

In contrast, the end portions of the electrodes 43 located inward from the neutral plane C shift to the folded portion 32 side. Here, the distance between the inner wall of the exterior body 11 and the end portion of the innermost electrode 43 on the folded portion 32 side decreases from the distance d0 to a distance d1. Here, the amount of relative deviation between the electrode 43 located on the neutral plane C and the innermost electrode 43 is assumed to be a distance d2. The distance d1 corresponds to a value obtained by subtracting the distance d2 from the distance d0.

In the case where the distance d0 before bending is smaller than the distance d2 after bending, the electrodes 43 of the stack 12 that are located inward from the neutral plane C come in contact with the inner wall of the exterior body 11. Thus, a required value of the distance d0 will be described below.

Description will be given below with reference to FIG. 22C. In FIG. 22C, a curve corresponding to the neutral plane C is shown by a dashed line, and a curve corresponding to the innermost surface of the stack 12 is shown as a curve B by a solid line.

A curve C is the arc of a radius r₀, and the curve B is the arc of a radius r₁. The difference between the radius r₀ and the radius r₁ is assumed to be t. Here, t corresponds to half of the thickness of the stack 12. The arc lengths of the curve C and the curve B are equal to each other. The arc angle of the curve C is assumed to be θ, and the arc angle of the curve B is assumed to be θ+Δθ.

The distance d2, which is the amount of difference between the edge of the curve C and that of the curve B, is calculated from the above relation as follows.

$$\begin{matrix}d 2 = {r}_{l} \times Δθ \\ = t \times θ\end{matrix} \qquad [ Formula 1 ]$$

This indicates that the distance d2 can be estimated from the thickness of the stack 12 and the bending angle and does not depend on the length of the stack 12 and the bending curvature radius, for example.

Setting the distance d0 of the space 25 larger than or equal to the distance d2 as described above can prevent the stack 12 and the exterior body 11 from coming in contact with each other when the battery 10 is bent. Thus, in the case where the battery 10 including the stack 12 with a thickness of 2t is used while being bent and the maximum angle at which the battery 10 is bent is θ°, the distance d0 between the stack 12 and the inner wall of the exterior body 11 in the space 25 is set to a value greater than or equal to t×θ.

For example, when the battery is used while being bent at 30°, the distance d0 of the space 25 is set to a value greater than or equal to πt/6. Similarly, when the battery is used while being bent at 60°, the distance d0 is set to a value greater than or equal to πt/3; when the battery is used while being bent at 90°, the distance d0 is set to a value greater than or equal to πt/2; and when the battery is used while being bent at 180°, the distance d0 is set to a value greater than or equal to πt.

For example, in the case where the battery 10 is not used in the state of being wound, the maximum bending angle of the battery 10 is estimated to be 180°. Thus, when the battery 10 is used in such a manner, the distance d0 is set to a value larger than or equal to πt, preferably larger than πt, whereby the battery 10 can be used for all devices. The battery 10 can be incorporated into a variety of electronic devices in which the battery 10 is used in the state of being bent to have a V shape or a U shape, for example, the battery 10 is used in the state of being folded in half.

In the case where the battery 10 is wound so as to circle around a cylindrical object once, the distance d0 of the space 25 is set to a value larger than or equal to 2πt so that the battery 10 can be bent at 360°. In the case where the battery 10 is wound so as to circle around a cylindrical object more than once, the distance d0 of the space 25 is set to an appropriate value accordingly. In the case where the battery 10 is changed in form to have a bellows shape, the distance d0 of the space 25 is set to an appropriate value depending on the direction, the angle, and the number of bending portions of the battery 10.

The above is the description of the space 25.

### [Fabrication Method Example]

An example of a method for fabricating the battery 10 will be described below.

First, a flexible film to be the exterior body 11 is prepared.

For the film, a material with high water resistance and high gas resistance is preferably used. As the film used as the exterior body, a layered film in which a metal film and an insulator film are stacked is preferably used. The metal film can be formed using any of the metals that can have the form of a metallic foil, such as aluminum, stainless steel, nickel steel, gold, silver, copper, titanium, chromium, iron, tin, tantalum, niobium, molybdenum, zirconium, and zinc, or an alloy thereof. As the insulator film, a single-layer film selected from a plastic film made of an organic material, a hybrid material film containing an organic material (e.g., an organic resin or fiber) and an inorganic material (e.g., ceramics), and a carbon-containing inorganic film (e.g., a carbon film or a graphite film), or a layered film including two or more of the above films can be used. A metal film is easily embossed. Forming projections by embossing increases the surface area of the metal film exposed to outside air, achieving efficient heat dissipation.

Then, the flexible film is processed by, for example, embossing to form the exterior body 11 having a wave shape.

The projections and depressions of the film can be formed by pressing (e.g., embossing). In the projections and depressions formed on of the film by embossing, an enclosed space whose inner volume is variable is formed with the film serving as part of a wall of a sealing structure. This enclosed space can be said to be formed because the film has an accordion structure or a bellows structure. The sealing structure using the film can prevent entry of water and dust. Note that embossing, which is a kind of pressing, is not necessarily employed and any method that allows formation of a relief on part of the film may be employed. A combination of methods, for example, embossing and any other pressing, may be performed on one film. Alternatively, embossing may be performed on one film more than once.

The projections of the film can have a hollow semicircular shape, a hollow semi-oval shape, a hollow polygonal shape, or a hollow irregular shape. In the case of a hollow polygonal shape, it is preferable that the polygon have more than three corners, in which case stress concentration at the corners can be reduced.

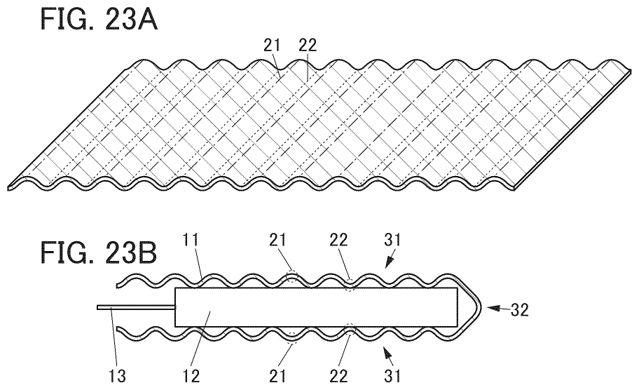

FIG. 23A is an example of a schematic perspective view of the exterior body 11 formed in such a manner. The exterior body 11 has a wave shape in which the plurality of crest lines 21 and the plurality of trough lines 22 are alternately arranged on its surface which is the outer side of the battery 10. Here, the crest lines 21 adjacent to each other and the trough lines 22 adjacent to each other are preferably arranged at regular intervals.

Subsequently, the exterior body 11 is partly folded such that the stack 12 prepared in advance is sandwiched (FIG. 23B). At this time, the length of the exterior body 11 is preferably adjusted such that an electrode 13 (the electrode 13a or the electrode 13b) connected to the stack 12 is exposed to the outside. Furthermore, the width of portions of the exterior body 11 that protrudes beyond the stack 12 is set sufficiently long in consideration of the thickness of the stack 12 because the protruding portions serve as the bonding portion 33 and the bonding portion 34 later.

FIG. 23B illustrates an example of the case where the pair of portions 31 between which the stack 12 is sandwiched are provided such that the phases of the waves of the portions 31 are different from each other by 180°. In other words, FIG. 23B illustrates the case where the exterior body 11 is folded such that the crest lines 21 overlap with each other and the trough lines 22 overlap with each other in the pair of portions 31.

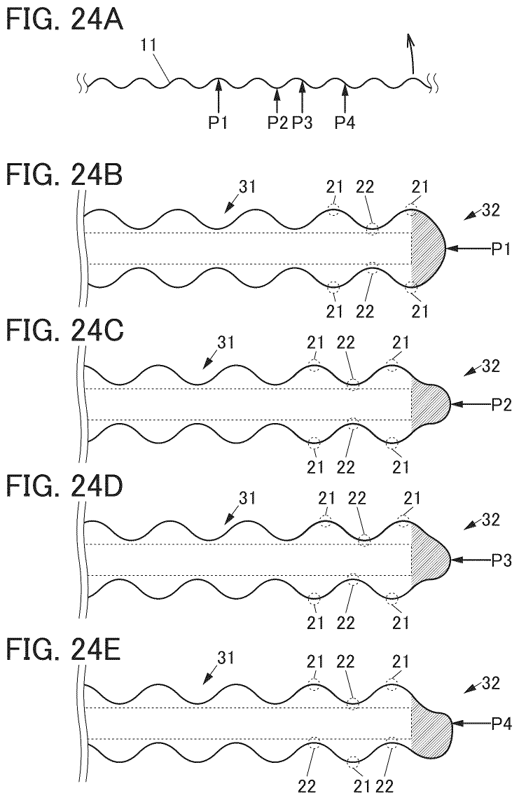

Here, the position and the shape of the folded portion 32 of the exterior body 11 will be described. FIG. 24A is a schematic cross-sectional view of the exterior body 11. FIG. 24B to FIG. 24E each illustrate a cross-sectional shape of the folded portion 32 when the folding position is points P1 to P4 in FIG. 24A. Note that the case where the exterior body 11 is folded in the direction shown by an arrow in FIG. 24A will be described below, and the surface facing downward corresponds to the outer surface of the battery 10. In FIG. 24A, a portion protruding upward is shown as the trough line 22 and a portion protruding downward is shown as the crest line 21.

In FIG. 24B to FIG. 24E, a region surrounded by the folded portion 32 is hatched. Here, a region sandwiched between two positions at which the wave periodicity of the exterior body 11 is lost, as boundaries, is the folded portion 32. Note that in FIG. 24B to FIG. 24E, the shape of the folded portion 32 is exaggerated; thus, its perimeter is not shown correctly in some cases.

The point P1 coincides with the trough line 22. As illustrated in FIG. 24B, the exterior body 11 is folded at the point P1, whereby the folded portion 32 can have a substantially arc shape. In addition, folding the exterior body 11 at the point P1 allows the phases of the opposite waves to be different from each other by 180°.

The point P2 coincides with the crest line 21. As illustrated in FIG. 24C, also when the exterior body 11 is folded at the point P2, the folded portion 32 can have a substantially arc shape. In addition, folding the exterior body 11 at the point P2 allows the phases of the opposite waves to be different from each other by 180°.

The point P3 is a point located between the crest line 21 and the trough line 22 and closer to the crest line 21 than to the midpoint of the crest line 21 and the trough line 22. As illustrated in FIG. 24D, the point P3 coincides with neither the crest line 21 nor the trough line 22, whereby the shape of the folded portion 32 is distorted instead of being vertically symmetrical. In addition, when the exterior body 11 is folded at the point P3, coincidence of the crest lines, the trough lines, and the crest line and the trough line of the opposite waves can be avoided.

The point P4 coincides with the midpoint of the crest line 21 and the trough line 22. As illustrated in FIG. 24E, in the case where the exterior body 11 is folded at the point P4, the shape of the folded portion 32 is significantly distorted. Specifically, the folded portion 32 is more likely to protrude upward or downward. Therefore, it is difficult to ensure a large distance between the stack 12 and the inner wall of the exterior body 11 on the side opposite to the protruding portion.

Here, FIG. 24B, FIG. 24C, and FIG. 24D are the same in that one crest line 21 is located between the folded portion 32 and the trough line 22 of the portion 31 that is closest to the folded portion 32. In particular, FIG. 24B illustrates an example of the case where boundaries of the folded portion 32 coincide with the crest lines 21 of the waves. The exterior body 11 is folded with the crest lines 21 of the two waves or the vicinities thereof regarded as boundaries in this manner, whereby a space that is large in the thickness direction can be ensured on the inner side of the folded portion 32 and the vicinity thereof. As described above, it is important to keep a distance between the inner wall of the exterior body 11 and the outermost electrode of the stack when the battery 10 is folded, and the shape illustrated in FIG. 24B allows the distance to be large.

In contrast, in FIG. 24E, there is no crest line 21 between the folded portion 32 and the trough line 22 of the portion 31 that is closest to the folded portion 32, on the lower surface side. Thus, a space that is large in the thickness direction is unlikely to be formed at the folded portion 32 and the vicinity thereof.

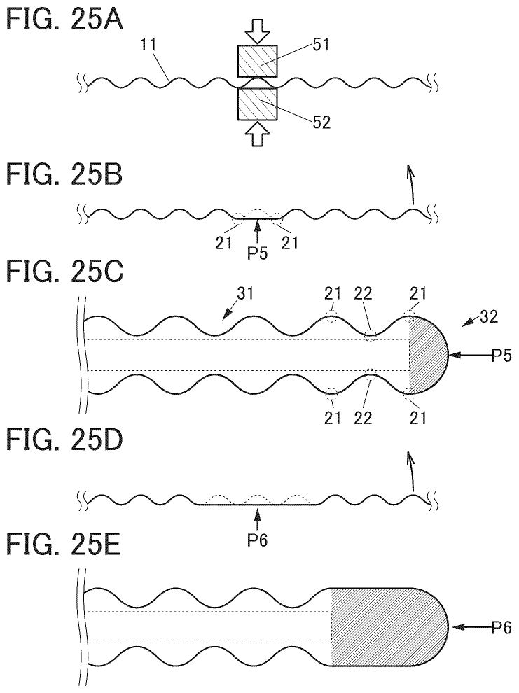

Here, a portion of the exterior body II that is to be the folded portion 32 preferably has a flat shape instead of a wave shape. For example, as illustrated in FIG. 25A, the exterior body 11 is partly planarized by being sandwiched between a mold 51 and a mold 52 each with a flat surface and pressurized or by being pressurized while being heated.

FIG. 25B is a schematic cross-sectional view of the exterior body 11 partly planarized in this manner. Here, the exterior body 11 is partly planarized such that the crest lines 21 are connected.

FIG. 25C is a schematic cross-sectional view of the exterior body 11 folded at a point P5 at the center of the formed flat portion. As illustrated in FIG. 25C, when the planarized exterior body 11 is used for the folded portion 32, a space larger than that in FIG. 24B can be formed.

FIG. 25D and FIG. 25E each illustrate an example of the case where planarization is performed in a region larger than that in FIG. 25C. As in FIG. 25B, the exterior body 11 is partly planarized such that the crest lines 21 are connected. The exterior body 11 is planarized in a region larger than the thickness of the stack 12 in such a manner, whereby a large space that is uniform in the thickness direction can be formed.

The above is the description of the relation between the position and the shape of the folded portion.

The exterior body 11 is folded such that the stack 12 is sandwiched, in the above manner, and then, portions of the exterior body 11 that are to be the bonding portions 33 are bonded by being pressurized while being heated.

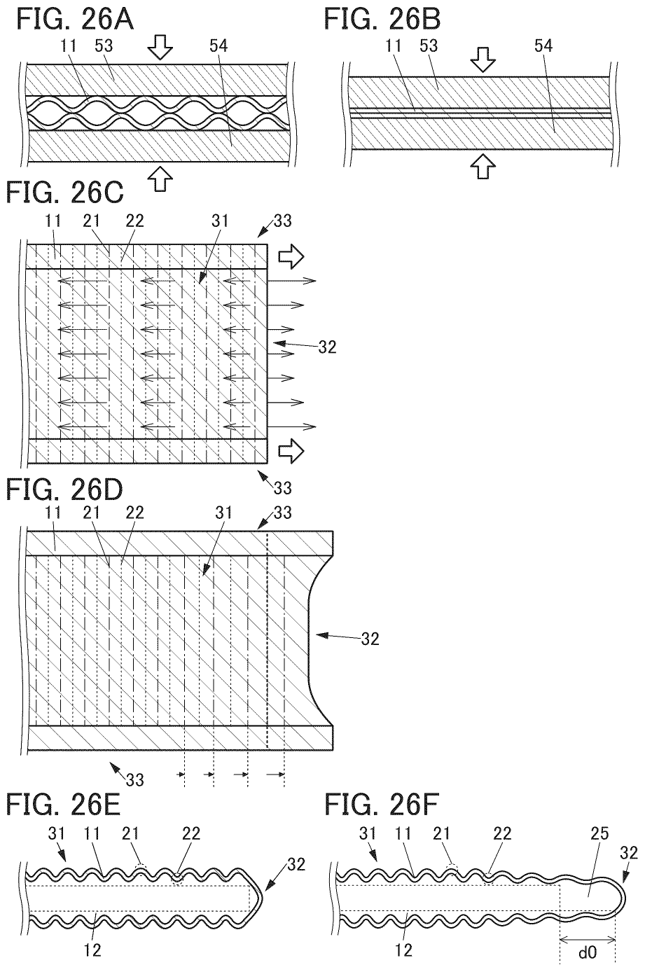

As illustrated in FIG. 26A, pressure bonding can be performed in such a manner that the exterior body 11 is sandwiched between a pair of molds 53 and 54 each with a flat surface. Then, pressure bonding is performed in the direction perpendicular to the surfaces of the mold 53 and the mold 54, whereby the portions of the exterior body 11 that are to be the bonding portions 33 are bonded so as to be flat as illustrated in FIG. 26B. At this time, clearance is preferably provided to keep a certain distance between the mold 53 and the mold 54. In that case, for example, the following problem can be avoided; the thickness of the bonding portion is reduced by more than a certain value, so that a conductive material (e.g., aluminum foil) contained in the film is exposed, leading to loss or a decrease of the insulating property.

Pressure bonding is preferably performed at a pressure higher than that for subsequent formation of the bonding portion 34, for example, so that the bonding portions 33 become sufficiently flat. The pressure depends on a material and the thickness of the exterior body; for example, in the case where a film with a thickness of approximately 110 μm, the pressure for pressure bonding is higher than or equal to 100 kPa/cm² and lower than or equal to 1000 kPa/cm², and can typically be approximately 600 kPa/cm². In addition, any temperature is acceptable as long as it is higher than or equal to the melting point of a material used as a fusing layer; for example, in the case where polypropylene is used, the temperature is preferably approximately 175° C.

Furthermore, the thickness of each of the bonding portions 33 after pressure bonding is preferably smaller than the total thickness of two exterior bodies 11 before pressure bonding. For example, in the case where a layered film including a fusing layer is used as the exterior body, the thickness of the fusing layer of the bonding portion 33 after pressure bonding is preferably 30% or more and 95% or less, further preferably 50% or more and 90% or less, still further preferably 60% or more and 80% or less of the total thickness of two fusing layers of portions of the exterior body 11 that is not subjected to pressure bonding (e.g., the portion 31 or the folded portion 32 of the battery 10).

When the bonding portion 33 is formed under the above conditions, even repeated changes in the form of the battery 10, such as bends, do not break sealing, and leakage of an electrolytic solution and the like enclosed in the exterior body 11 can be prevented. This allows the battery 10 to have extremely high reliability and safety. In particular, the bonding portion 33 can be formed in which a gap is not formed because of a change in the form of the battery 10 even in the case where the phases of the waves of facing portions of the exterior body 11 are different from each other by 180° as illustrated in FIG. 26A.

In FIG. 26C, force applied to each portion of the exterior body 11 in bonding is schematically shown by arrows. Here, greater force is shown by longer arrows.

Part of the exterior body 11 having a wave shape before bonding is stretched in the extending direction (shown by thick arrows) due to its planarization by bonding. The stretch generates tensile force to the folded portion 32 side in the portion 31 of the exterior body 11. This force increases as the distance from the bonding portion 33 decreases, and decreases as the distance from the bonding portion 33 increases.

On the other hand, since the portion 31 has a wave shape, reaction occurs in the direction opposite to that of the force described above. This reaction increases as the distance from the folded portion 32 increases, and decreases as the distance from the folded portion 32 decreases.

Application of the above two kinds of force to the portion 31 and the folded portion 32 stretches the portion 31 such that the wave period gradually increases as the distance from the folded portion 32 decreases, as illustrated in FIG. 26D. The stretch amount increases as the distance from the bonding portion 33 decreases, and decreases as the distance from the bonding portion 33 increases; thus, a center portion of the folded portion 32 is depressed to the portion 31 side.

FIG. 26E and FIG. 26F are schematic cross-sectional views before and after formation of the bonding portions 33. Even in the case where the stack 12 is in contact with the inner wall of the exterior body 11 before bonding as illustrated in FIG. 26E, a stretch of the portion 31 of the exterior body II in formation of the bonding portions 33 enables the space 25 to be formed as illustrated in FIG. 26F.

The bonding portions 33 are formed to be flat in the aforementioned manner, whereby the space 25 can be formed between the folded portion 32 and the stack 12.

Subsequently, an electrolytic solution is introduced from a portion to be the bonding portion 34. In reduced pressure or an inert atmosphere, a desired amount of electrolyte solution is dripped into the exterior body 11 having a bag-like shape.

After that, a portion to be the bonding portion 34 is bonded by a method similar to the above method, so that the bonding portion 34 is formed. In forming the bonding portion 34, an insulating sealing layer may be provided between the exterior body 1I and the electrodes 13a and 13b. The sealing layer melts at the time of pressure bonding, whereby the electrodes 13a and 13b and the film-like exterior body 11 are fixed.

The battery 10 illustrated in FIG. 21A and the like can be fabricated in the aforementioned manner.

The above is the description of the example of the method for fabricating the battery.

### [Battery Shape]

As described above, the space 25 can be formed due to a stretch of part of the exterior body 11 in formation of the bonding portions 33. That is to say, the distance d0 between the stack 12 and the exterior body 11 in the space 25 changes in accordance with the stretch amount of the exterior body 11 in the bonding portion 33. To increase the distance d, a film with the above ratio of the length of the film with a wave form that is stretched to the natural length of the film is preferably used as the exterior body 11.

Furthermore, in the portion 31, as the distance from the bonding portion 33 increases, the stretch amount decreases, and thus, the distance d decreases. In contrast, as the stretch amount of the bonding portion 33 increases, tensile force of the portion 31 increases; accordingly, the distance d can be increased even in the position apart from the bonding portion 33. Here, in the case where the same film is used, the stretch amount of the bonding portion 33 increases in proportion to the length of the bonding portion 33 in the extending direction.

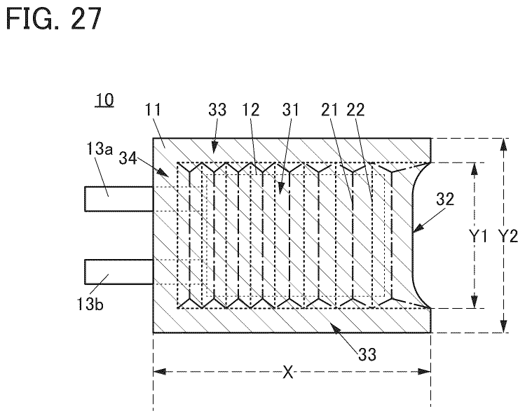

FIG. 27 is a schematic top view of the battery 10 with an aspect ratio different from that in FIG. 21. The battery 10 is preferably designed such that the ratio of X to Y1 is higher than or equal to 1, where the length of the bonding portion 33 in the extending direction is X and the distance between the pair of bonding portions 33 (that is, the width of the portion 31) is Y1. For example, the ratio of X to Y1 is higher than or equal to 1.2, higher than or equal to 1.5, higher than or equal to 1.7, higher than or equal to 2, or higher than or equal to 3. Although there is no upper limit on the ratio of X to Y1, the ratio is preferably, for example, lower than 100 or lower than 50 in consideration of productivity.

The ratio of X to Y2 is preferably, for example, 4/3 or 16/9 assuming that the width of the battery 10 including the bonding portions 33 is Y2, in which case an electronic device into which the battery 10 is incorporated can be easily designed and the battery 10 is more widely used. In the case where the battery 10 is incorporated into a narrow object such as a watch band, the ratio of X to Y2 can be, for example, higher than or equal to 1.5, higher than or equal to 2, or higher than or equal to 3.

### |Film Processing Method]

Next, a film processing method that can be used for the exterior body 1I will be described.

First, a sheet made of a flexible material is prepared. As the sheet, a stack in which a heat-seal layer is provided on one or both surfaces of a metal film is used. As the heat-seal layer, a heat-seal resin film containing polypropylene, polyethylene, or the like is used. In this embodiment, a metal sheet in which the surface of aluminum foil is provided with a nylon resin and the back surface of the aluminum foil is provided with a stack of an acid-proof polypropylene film and a polypropylene film is used as the sheet. The sheet is cut to obtain a film with a desired size.

Then, the film is embossed. As a result, the film with unevenness can be formed. The film includes a plurality of uneven portions, thereby having a wave pattern that can be visually recognized. Although an example in which the sheet is cut and then embossing is performed is described here, there is no particular limitation on the order; embossing may be performed before cutting the sheet and then the sheet may be cut. Alternatively, the sheet may be cut after thermocompression bonding is performed with the sheet folded.

Embossing, which is a kind of pressing, will be described below.

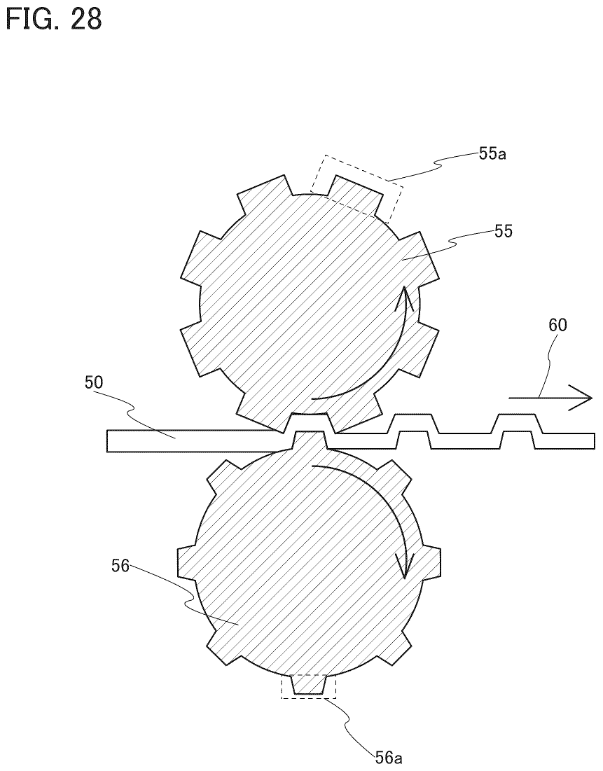

FIG. 28 is a cross-sectional view illustrating an example of embossing. Note that embossing, which is a kind of pressing, refers to processing for forming projections and depressions corresponding to projections and depressions of an embossing roll on a film by bringing the embossing roll whose surface has projections and depressions into contact with the film with pressure. Note that the embossing roll is a roll whose surface is patterned.

FIG. 28 illustrates an example where both surfaces of a film are embossed. FIG. 28 illustrates a method for forming a film having projections whose top portions are on one surface.

FIG. 28 illustrates the state where the film 50 is sandwiched between an embossing roll 55 in contact with one surface of the film and an embossing roll 56 in contact with the other surface and the film 50 is being transferred in the direction of movement 60. The surface of the film is patterned by pressure or heat. The surface of the film may be patterned by pressure and heat.

The embossing rolls can be formed of metal rolls, ceramic rolls, plastic rolls, rubber rolls, organic resin rolls, lumber rolls, or the like, as appropriate.

In FIG. 28, embossing is performed using the male embossing roll 56 and the female embossing roll 55. The male embossing roll 56 has a plurality of projections 56a. The projections correspond to projections formed on a film to be processed. The female embossing roll 55 has a plurality of projections 55a. Between adjacent projections 55a, a depression is positioned into which a projection formed on the film by the projection 56a of the male embossing roll 56 fits.

Successive embossing by which the film 50 partly stands out and debossing by which the film 50 is partly indented can form a projection and a flat portion successively. In this manner, a pattern can be formed on the film 50.

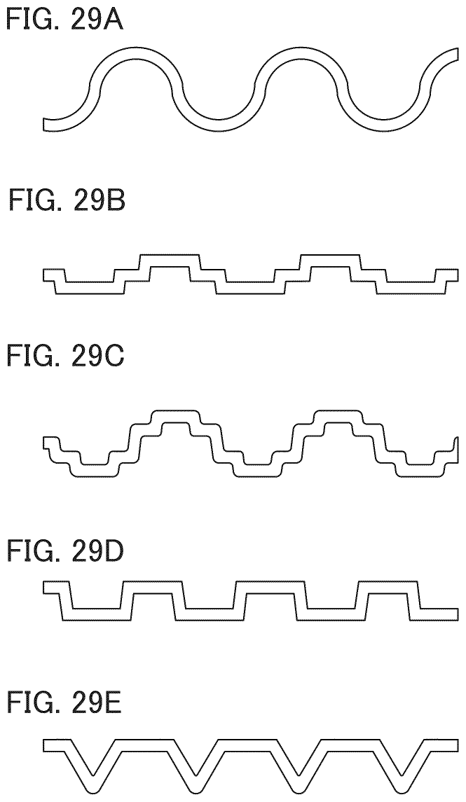

Next, a film having a plurality of projections with a shape different from that in FIG. 28 is described with reference to FIG. 29A to FIG. 29E. The shape of projections of the embossing roll 55 and the embossing roll 56 in FIG. 28 are changed to a shape different from that in FIG. 28, whereby embossing with various cross-sectional shapes illustrated in FIG. 29A to FIG. 29E can be performed.

FIG. 29A is a schematic cross-sectional view of an embossment having a wave shape illustrated in FIG. 23A and the like, and FIG. 29B to FIG. 29E are modification examples of FIG. 29A. FIG. 29B and FIG. 29C are diagrams illustrating examples of forming a stepwise wave shape, FIG. 29D is a diagram illustrating an example of forming a rectangular wave shape, and FIG. 29E is a diagram illustrating an example of forming a wave shape with acute troughs and trapezoidal crests.

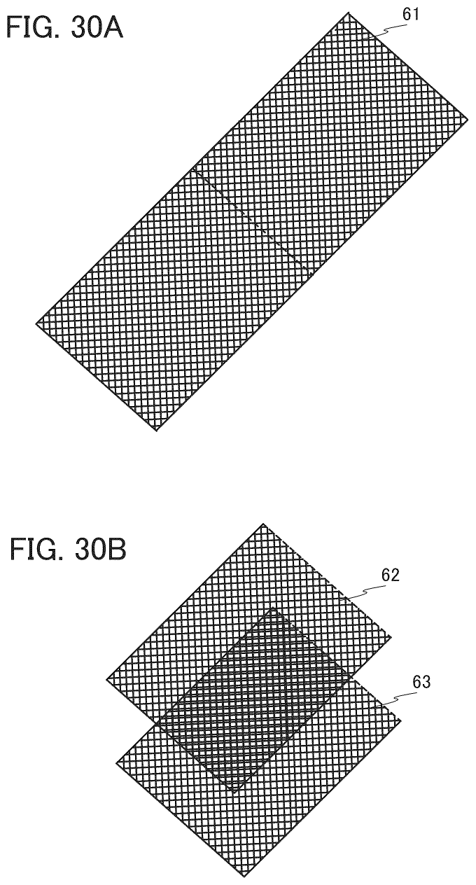

FIG. 30A and FIG. 30B are bird's eye views illustrating the completed shapes obtained by performing the embossing illustrated in FIG. 28 to FIG. 29E twice with different orientations of the film 50. Specifically, embossing is performed on the film 50 in the first direction, and then embossing is performed on the film 50 in the second direction that is rotated 90° with respect to the first direction, whereby a film 61 having an embossed shape (that can be referred to as an alternating wave shape) illustrated in FIG. 30A and FIG. 30B can be obtained. Note that when a secondary battery is fabricated using one film 61, the film 61 having an alternating wave shape has an external shape illustrated in FIG. 30A and can be used by being folded in two along a dashed line portion. When a secondary battery is fabricated using two films (a film 62 and a film 63), the plurality of films (the film 62 and the film 63) each having an alternating wave shape have an external shape illustrated in FIG. 30B, and the film 62 and the film 63 overlap with each other to be used.

Since processing is performed using the embossing rolls in the aforementioned manner, an apparatus can be small. Furthermore, a film before being cut can be processed, achieving excellent productivity. Note that a film processing method is not limited to processing using embossing rolls; a film may be processed by pressing a pair of embossing plates having a surface with unevenness against the film. In that case, one of the embossing plates may be flat and the film may be processed in a plurality of steps.

In the above-described structure example of the secondary battery, the example is described in which the exterior body on one surface of the secondary battery and the exterior body on the other surface thereof have the same embossed shape, however, the structure of the secondary battery of one embodiment of the present invention is not limited thereto. For example, a secondary battery one surface of which is provided with an exterior body having an embossed shape and the other surface of which is provided with an exterior body not having an embossed shape can be used. Alternatively, the exterior body on one surface of the secondary battery and the exterior body on the other surface thereof may have different embossed shapes.

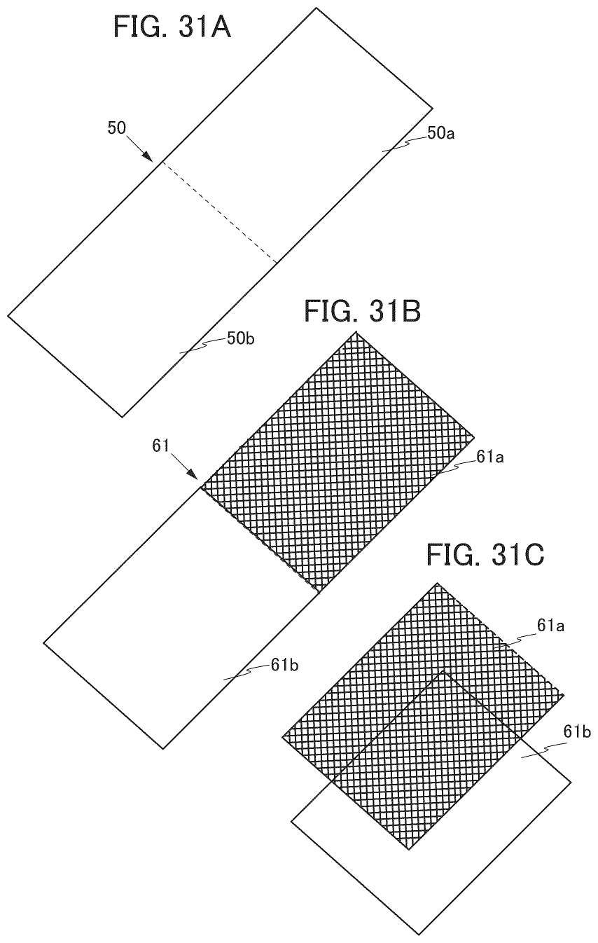

A secondary battery one surface of which is provided with an exterior body having an embossed shape and the other surface of which is provided with an exterior body not having an embossed shape will be described with reference to FIG. 31 to FIG. 33.

First, a sheet made of a flexible material is prepared. As the sheet, a stack in which an adhesive layer (also referred to as a heat-seal layer) is provided on one or both surfaces of a metal film is used. As the adhesive layer, a heat-seal resin film containing polypropylene, polyethylene, or the like is used. In this embodiment, a metal sheet in which the surface of aluminum foil is provided with a nylon resin and the back surface of the aluminum foil is provided with a stack of an acid-proof polypropylene film and a polypropylene film is used as the sheet. This sheet is cut to prepare the film 50 illustrated in FIG. 31A.

Then, part of the film 50 (a film 50a) is embossed and a film 50b is not embossed. As a result, the film 61 illustrated in FIG. 31B is formed. As illustrated in FIG. 31B, projections and depressions are formed to provide a film 61a a surface of which is provided with a visually recognizable pattern and a film 61b a surface of which is not provided with projections and depressions. There is a boundary between the film 61a provided with projections and depressions and the film 61b not provided with projections and depressions. In FIG. 31B, the film 61a is an embossed portion of the film 61, and the film 61b is a non-embossed portion. Note that embossing for the film 61a may be performed to provide the same projections and depressions on the entire surface, or may be performed to provide two or more types of different projections and depressions depending on the portions of the film 61a. In the case of providing two or more types of different projections and depressions, a boundary is formed between any two different types of projections and depressions.

Alternatively, the entire film 50 in FIG. 31A may be embossed to form the film 61 as illustrated in FIG. 4A. Note that embossing for the film 61 may be performed to provide the same projections and depressions on the entire surface, or may be performed to provide two or more types of different projections and depressions depending on the portions of the film 61. In the case of providing two or more types of different projections and depressions, a boundary is formed between any two different types of projections and depressions. Alternatively, as illustrated in FIG. 31C, the film 61a whose surface has projections and depressions and the film 61b whose surface does not have projections and depressions may be prepared.

Although an example in which the sheet is cut and then embossing is performed is described here, there is no particular limitation on the order; embossing may be performed before cutting the sheet and then the sheet is cut so as to be in the state illustrated in FIG. 31B. Alternatively, the sheet may be cut after thermocompression bonding is performed with the sheet folded.

In this embodiment, projections and depressions are provided on part of the film 50 (the film 50a) so that the film 61 having patterns and illustrated in FIG. 31B is formed, and the film 61 is folded at the center such that two end portions overlap with each other, and is sealed on three sides with an adhesive layer. Here, the film 61 is referred to as the exterior body 11.

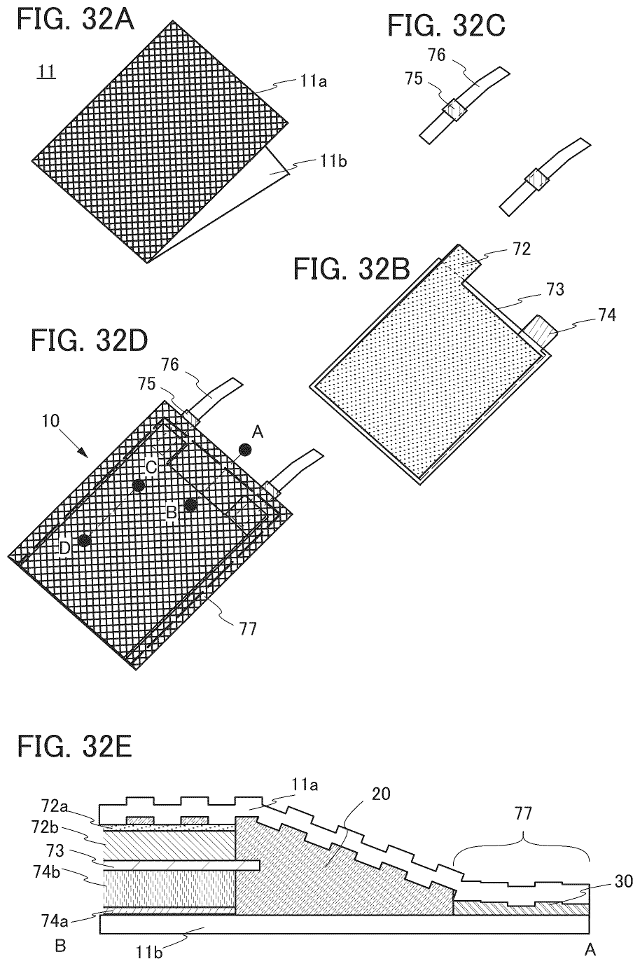

First, the exterior body 11 is folded such that a first portion 11a of the exterior body 11 and a second portion 11b of the exterior body 11 that have the same size overlap with each other as illustrated in FIG. 32A. Note that the first portion 11a has unevenness formed by embossing, and the second portion 11b does not have unevenness.

As illustrated in FIG. 32B, a positive electrode 72, a separator 73, and a negative electrode 74 that are stacked is prepared. Here, for simple description, an example is described in which one positive electrode 72, one separator 73, and one negative electrode 74 are held in the exterior body; however, to increase the capacity of the secondary battery, a plurality of positive electrodes 72, a plurality of separators 73, and a plurality of negative electrodes 74 may be stacked and held in the exterior body.

In addition, two lead electrodes 76 including sealing layers 75 illustrated in FIG. 32C are prepared. The lead electrodes 76 are each also referred to as a lead terminal and provided to lead a positive electrode or a negative electrode of a secondary battery to the outside of an exterior film. Aluminum and nickel-plated copper are used for a positive electrode lead and a negative electrode lead, respectively.

Then, the positive electrode lead is electrically connected to a protruding portion of a positive electrode current collector of the positive electrode 72 by ultrasonic welding or the like. The negative electrode lead is electrically connected to a protruding portion of a negative electrode current collector of the negative electrode 74 by ultrasonic welding or the like.

Then, two sides of the exterior body 11 are sealed by thermocompression bonding, and one side is left open for introduction of an electrolyte solution (hereinafter, the shape of a film in this state also referred to as a bag-like shape). In thermocompression bonding, the sealing layers 75 provided over the lead electrodes are also melted, thereby fixing the lead electrodes and the exterior body 11 to each other. After that, in reduced pressure or an inert atmosphere, a desired amount of electrolyte solution is dripped into the exterior body II having a bag-like shape. Lastly, the outer edge of the exterior body 11 that has not been subjected to thermocompression bonding and is left open is sealed by thermocompression bonding.

In this manner, the secondary battery 10 illustrated in FIG. 32D can be fabricated.

In the obtained secondary battery 40, the surface of the film 50 serving as an exterior body has a pattern of projections and depressions. A region between a dotted line and an edge in FIG. 32D is a thermocompression-bonded region 77, and its surface also has a pattern of projections and depressions. Although the projections and depressions in the thermocompression-bonded region 77 are smaller than those in a center portion, they can relieve stress applied when the secondary battery is bent.

FIG. 32E illustrates an example of a cross section taken along the dashed-dotted line A-B in FIG. 32D.

As illustrated in FIG. 32E, projections and depressions of the exterior body 11a are different between a region overlapping with the positive electrode current collector 72a and the thermocompression-bonded region 77. As illustrated in FIG. 32E, a stack including the positive electrode current collector 72a, the positive electrode active material layer 72b, the separator 75, the negative electrode active material layer 74b, and the negative electrode current collector 74a in this order is sandwiched between the facing portions of the folded exterior body 11, an end portion is sealed with an adhesive layer 30, and the other space inside the folded exterior body 11 includes an electrolyte solution 20.

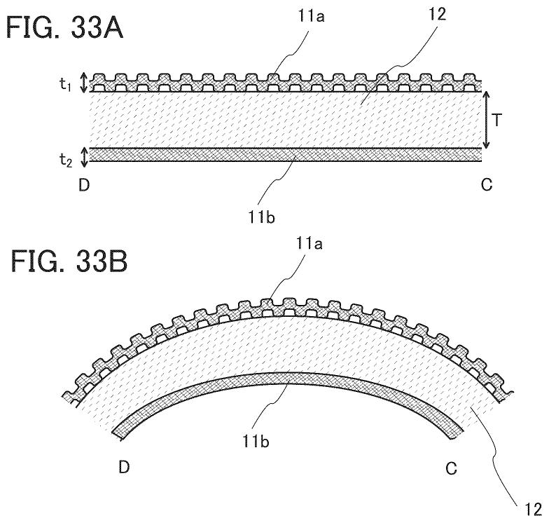

The proportion of the volume of the battery portion to the total volume of the secondary battery is preferably greater than or equal to 50%. FIG. 33A and FIG. 33B show cross-sectional views of the secondary battery in FIG. 32D taken along the line C-D. FIG. 33A illustrates the stack 12 in the battery, the first portion 11a of the exterior body 11 that covers the top surface of the battery and is embossed, and the second portion 11b of the exterior body 11 that covers the bottom surface of the battery and is not embossed. For simplification of the drawings, the electrolyte solution and the stacked-layer structure of the positive electrode current collector provided with the positive electrode active material layer, the separator, the negative electrode current collector provided with the negative electrode active material layer, and the like are collectively illustrated as the stack 12 in the battery. In addition, T represents the thickness of the stack 12 in the battery, ti represents the total of the depth of the embossment and the thickness of the first portion 11a that covers the top surface of the battery and is embossed, 12 represents the thickness of the second portion 11b that covers the bottom surface of the battery and is not embossed. At this time, the total thickness of the secondary battery is T+t₁+t₂. Thus, T>t₁ +t₂ needs to be satisfied to make the proportion of the volume of the stack 12 portion in the battery to the total volume of the secondary battery greater than or equal to 50%.

The adhesive layer 30, which is only partly illustrated in FIG. 32E, is formed in the following manner: a layer made of polypropylene is provided on the surface of the layer on the side where the film is attached, and only a thermocompression-bonded portion becomes the adhesive layer 30.

FIG. 32E illustrates an example in which the bottom side of the exterior body 11 is fixed and pressure bonding is performed. In this case, the top side is greatly bent and a step is formed; thus, when a plurality of the above-described stacks. e.g., eight or more stacks, are provided between the facing portions of the folded exterior body 11, the step is large and stress might be excessively applied to the top side of the first portion 11a of the exterior body 11. Furthermore, the edge of the top side of the film might be greatly misaligned with the edge of the bottom side of the film. In that case, to prevent misalignment of the edges, a step may be provided on the bottom side of the film and pressure bonding may be performed at the center so that stress is equalized.

In the case where the misalignment is large, there is a region where part of the edge of one film does not overlap with the other film. To correct the misalignment of the edges of the top and bottom sides of the film, such a region may be cut off.

### [Example of Method for Fabricating Secondary Battery]

An example of a fabrication method particularly when a secondary battery is used as a battery 10 will be described below. Note that points similar to those described above are not described in some cases.

Here, a method in which the film-like exterior body 11 having a wave shape is folded in half so that two end portions overlap with each other and three sides are sealed using an adhesive layer is employed.

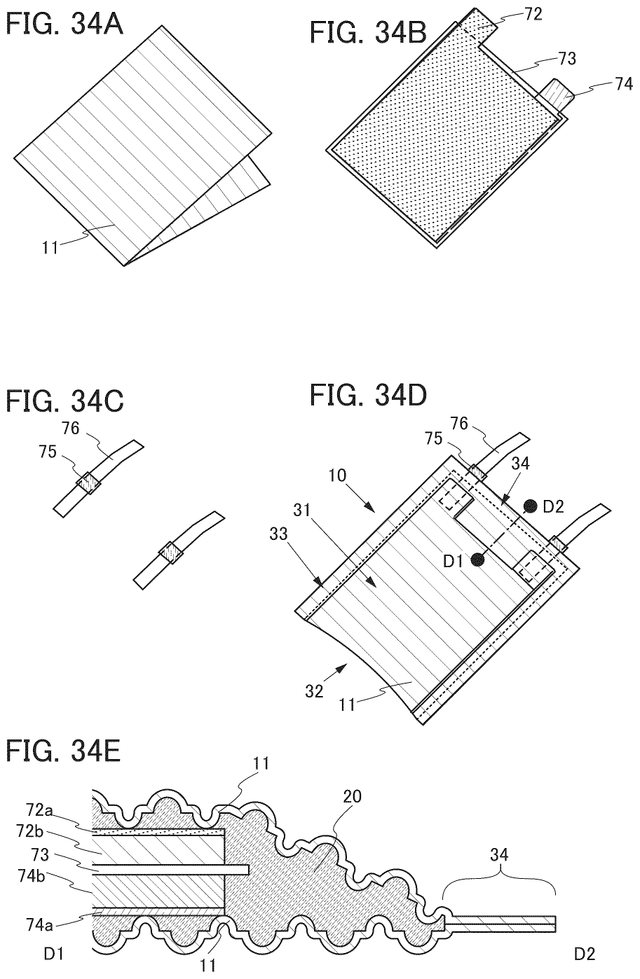

The exterior body 1I including a film processed to have a wave shape is bent to be in the state illustrated in FIG. 34A.

As illustrated in FIG. 34B, a stack including the positive electrode 72, the separator 73, and the negative electrode 74 included in a secondary battery is prepared. Here, for simple description, an example is described in which one positive electrode 72, one separator 73, and one negative electrode 74 are held in the exterior body; however, to increase the capacity of the secondary battery, a plurality of positive electrodes 72, a plurality of separators 73, and a plurality of negative electrodes 74 may be stacked and held in the exterior body.

In addition, two lead electrodes 76 including sealing layers 75 illustrated in FIG. 34C are prepared. The lead electrodes 76 are each also referred to as a lead terminal or a tab and provided to lead a positive electrode or a negative electrode of a secondary battery to the outside of an exterior film. Aluminum and nickel-plated copper are used for a positive electrode lead and a negative electrode lead, respectively, of the lead electrodes 76.

Then, the positive electrode lead is electrically connected to a protruding portion of the positive electrode current collector of the positive electrode 72 by ultrasonic welding or the like. The negative electrode lead is electrically connected to a protruding portion of the negative electrode current collector of the negative electrode 74 by ultrasonic welding or the like.

Then, two sides of the film-like exterior body 11 are subjected to thermocompression bonding by the above-described method and one side is left open for introduction of an electrolyte solution, whereby a bonding portion 33 is formed. After that, in reduced pressure or an inert atmosphere, a desired amount of electrolyte solution is dripped into the film-like exterior body 11 having a bag-like shape. Lastly, the outer edge of the film that has not been subjected to thermocompression bonding and is left open is subjected to thermocompression bonding, whereby the bonding portion 34 is formed. In thermocompression bonding, the sealing layers 75 provided over the lead electrodes are also melted, thereby fixing the lead electrodes and the film-like exterior body 11 to each other.

In this manner, the battery 10 illustrated in FIG. 34D, which is a secondary battery, can be fabricated.

The film-like exterior body 11 of the battery 10, which is the obtained secondary battery, has a pattern of waves. A region between a dotted line and the edge in FIG. 34D is the bonding portion 33 or the bonding portion 34, and the region is processed to be flat.

FIG. 34E illustrates an example of a cross section taken along the dashed-dotted line D1-D2 in FIG. 34D.

As illustrated in FIG. 34E, a stack in which the positive electrode current collector 72a, a positive electrode active material layer 72b, the separator 73, a negative electrode active material layer 74b, and the negative electrode current collector 74a are stacked in this order is sandwiched between the facing portions of the folded film-like exterior body 11, the folded film-like exterior body 11 is sealed by the bonding portion 34 at its end portions, and the other space is provided with the electrolyte solution 20. That is, the space inside the film-like exterior body 11 is filled with the electrolyte solution 20. As the positive electrode current collector 72a, the positive electrode active material layer 72b, the separator 73, the negative electrode active material layer 74b, the negative electrode current collector 74a, and the electrolyte solution 20, the positive electrode current collector, the positive electrode active material layer, the separator, the negative electrode active material layer, the negative electrode current collector, and the electrolyte solution described in Embodiment 2 can be respectively used.

Note that the adhesive layer is formed in the following manner: a layer made of polypropylene is provided on the surface of the film on the side where the film is attached, and only a thermocompression-bonded portion becomes the adhesive layer.

FIG. 34E illustrates an example in which the bottom side of the film-like exterior body 11 is fixed and pressure bonding is performed. In this case, the top side is greatly bent and a step is formed; thus, when a plurality of the above-described stacks, e.g., eight or more stacks, are provided between the facing portions of the folded film-like exterior body 11, the step is large and stress might be excessively applied to the top side of the film-like exterior body 11. Furthermore, the edge of the top side of the film might be greatly misaligned with the edge of the bottom side of the film. In that case, to prevent misalignment of the edges, a step may be provided on the bottom side of the film and pressure bonding may be performed at the center so that stress is equalized.

In the case where the misalignment is large, there is a region where part of the edge of one film does not overlap with the other film. To correct the misalignment of the edges of the top and bottom sides of the film, such a region may be cut off

### [Example of Electrode Stack]

A structure example of a stack including a plurality of electrodes will be described below.

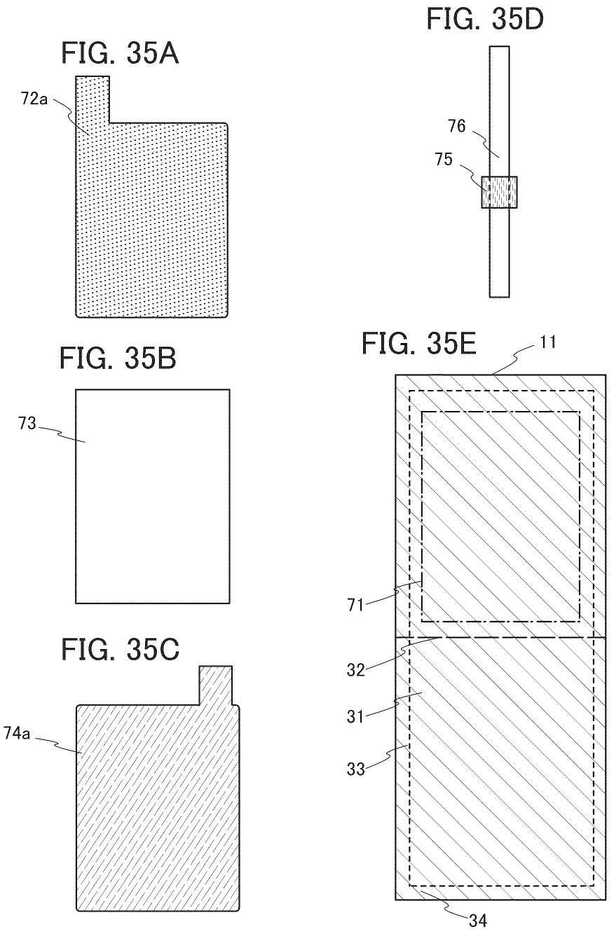

FIG. 35A shows a top view of the positive electrode current collector 72a, FIG. 35B shows a top view of the separator 73, FIG. 35C shows a top view of the negative electrode current collector 74a, FIG. 35D shows a top view of the sealing layer 75 and the lead electrode 76, and FIG. 35E shows a top view of the film-like exterior body 11.

The dimensions in the drawings of FIG. 35 are substantially the same, and a region 71 surrounded by a dashed-dotted line in FIG. 35E has substantially the same dimensions as the separator in FIG. 35B. A region between a dashed line and the edge in FIG. 35E becomes the bonding portion 33 and the bonding portion 34.

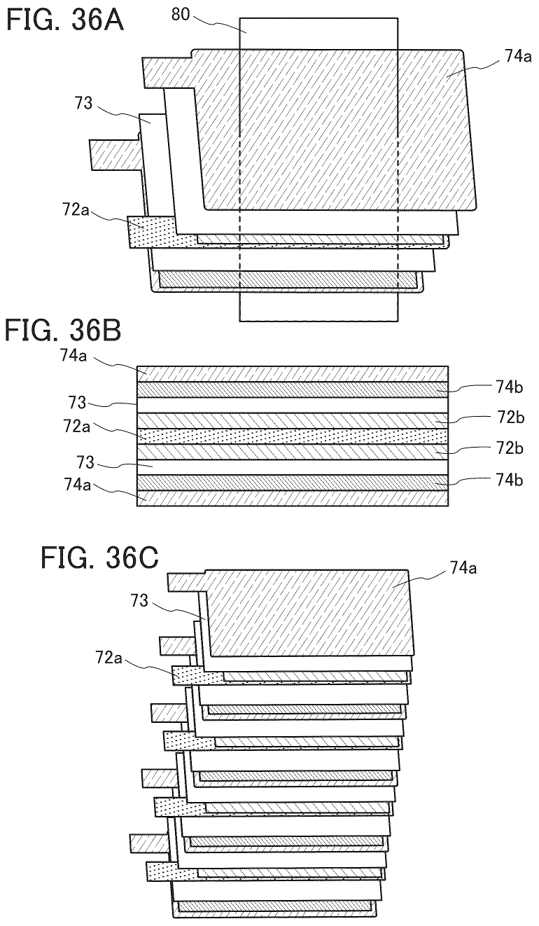

FIG. 36A is an example in which the positive electrode active material layer 72b is provided on both surfaces of the positive electrode current collector 72a. Specifically, the negative electrode current collector 74a, the negative electrode active material layer 74b, the separator 73, the positive electrode active material layer 72b, the positive electrode current collector 72a, the positive electrode active material layer 72b, the separator 73, the negative electrode active material layer 74b, and the negative electrode current collector 74a are stacked in this order. FIG. 36B shows a cross-sectional view of the stacked-layer structure taken along a plane 80.

Although FIG. 36A illustrates an example in which two separators are used, a structure may be employed in which one separator is folded and both ends are sealed to form a bag-like shape, and the positive electrode current collector 72a is held therein. The positive electrode active material layer 72b is formed on both surfaces of the positive electrode current collector 72a held in the separator having a bag-like shape.

The negative electrode active material layer 74b can be provided on both surfaces of the negative electrode current collector 74a. FIG. 36C illustrates an example of a secondary battery in which three negative electrode current collectors 74a each provided with the negative electrode active material layers 74b on both surfaces, four positive electrode current collectors 72a each provided with the positive electrode active material layers 72b on both surfaces, and eight separators 73 are sandwiched between two negative electrode current collectors 74a each provided with the negative electrode active material layer 74b on one surface. In this case, four separators each having a bag-like shape may be used instead of eight separators.

The capacity of the secondary battery can be increased by increasing the number of stacks. In addition, when the positive electrode active material layers 72b are provided on both surfaces of the positive electrode current collector 72a and the negative electrode active material layers 74b are provided on both surfaces of the negative electrode current collector 74a, the thickness of the secondary battery can be made small.

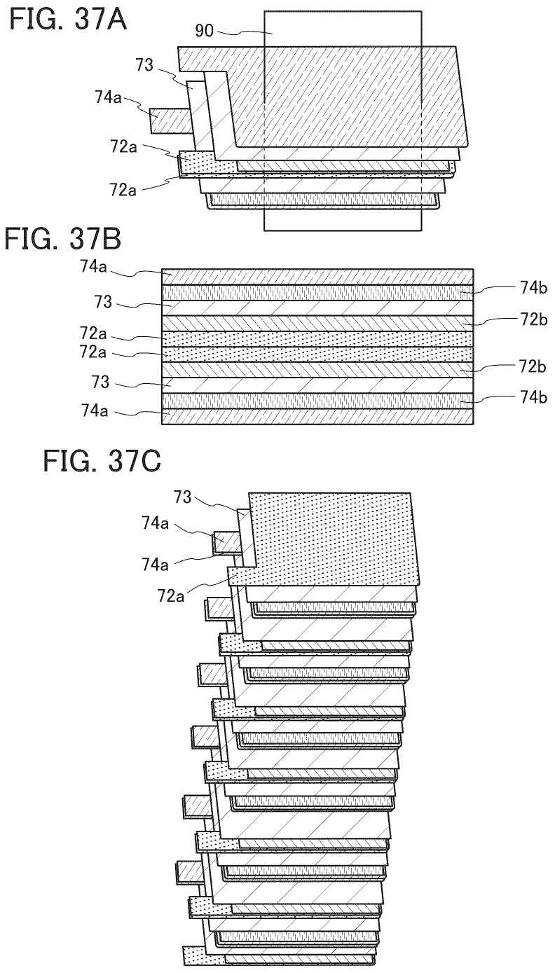

FIG. 37A shows a diagram of a secondary battery in which the positive electrode active material layer 72b is provided on one surface of the positive electrode current collector 72a and the negative electrode active material layer 74b is provided on one surface of the negative electrode current collector 74a. Specifically, the negative electrode active material layer 74b is provided on one surface of the negative electrode current collector 74a and the separator 73 is stacked in contact with the negative electrode active material layer 74b. The positive electrode active material layer 72b provided on one surface of the positive electrode current collector 72a is in contact with the surface of the separator 73 that is not in contact with the negative electrode active material layer 74b. Another positive electrode current collector 72a whose one surface is provided with the positive electrode active material layer 72b is in contact with the surface of the positive electrode current collector 72a. In that case, the positive electrode current collectors 72a are provided such that the surfaces not provided with the positive electrode active material layers 72b face each other. Then, another separator 73 is formed, and the negative electrode active material layer 74b provided on one surface of the negative electrode current collector 74a is stacked in contact with the separator. FIG. 37B shows a cross-sectional view of the stacked-layer structure in FIG. 37A taken along a plane 90.

Although two separators are used in FIG. 37A, a structure may be employed in which one separator is folded and both ends are sealed to form a bag-like shape, and two positive electrode current collectors 72a each provided with the positive electrode active material layer 72b on one surface are provided between the facing portions of the separator.

In FIG. 37C, a plurality of the stacked-layer structures each of which is illustrated in FIG. 37A are stacked. In FIG. 37C, the negative electrode current collectors 74a are provided such that the surfaces not provided with the negative electrode active material layers 74b face each other. FIG. 37C illustrates a state where twelve positive electrode current collectors 72a, twelve negative electrode current collectors 74a, and twelve separators 73 are stacked.

A secondary battery with a structure in which the positive electrode active material layer 72b is provided on one surface of the positive electrode current collector 72a and the negative electrode active material layer 74b is provided on one surface of the negative electrode current collector 74a has a larger thickness than a secondary battery with a structure in which the positive electrode active material layers 72b are provided on both surfaces of the positive electrode current collector 72a and the negative electrode active material layers 74b are provided on both surfaces of the negative electrode current collector 74a. However, the surface of the positive electrode current collector 72a on which the positive electrode active material layer 72b is not provided faces the surface of another positive electrode current collector 72a on which the positive electrode active material layer 72b is not provided, as a result, metals are in contact with each other. Similarly, the surface of the negative electrode current collector 74a on which the negative electrode active material layer 74b is not provided faces the surface of another negative electrode current collector 74a on which the negative electrode active material layer 74b is not provided; as a result, metals are in contact with each other. Since the metals are in contact with each other, surfaces where the metals are in contact with each other easily slide on each other owing to the low friction. The metals in the secondary battery slide on each other at the time of bending the secondary battery; thus, the secondary battery is easily bent.

The protruding portion of the positive electrode current collector 72a and the protruding portion of the negative electrode current collector 74a are also referred to as tab portions. The tab portions of the positive electrode current collector 72a and the negative electrode current collector 74a are easily cut when the secondary battery is bent. This is because the tab portions have long and narrow shapes and the stress is likely to be applied to the roots of the tab portions.

The structure in which the positive electrode active material layer 72b is provided on one surface of the positive electrode current collector 72a and the negative electrode active material layer 74b is provided on one surface of the negative electrode current collector 74a has a surface where the positive electrode current collectors 72a are in contact with each other and a surface where the negative electrode current collectors 74a are in contact with each other. The surface where the current collectors are in contact with each other has low friction resistance and thus easily reduces the stress due to the difference in curvature radius that occurs when the battery is changed in shape. Furthermore, the total thickness of each tab portion is large in the structure in which the positive electrode active material layer 72b is provided on one surface of the positive electrode current collector 72a and the negative electrode active material laver 74b is provided on one surface of the negative electrode current collector 74a; thus, the stress is distributed as compared with the structure in which the positive electrode active material layers 72b are provided on both surfaces of the positive electrode current collector 72a and the negative electrode active material layers 74b are provided on both surfaces of the negative electrode current collector 74a; as a result, the tab portion is less likely to be cut.

In the case of thus stacking layers, ultrasonic welding is performed to fix and electrically connect all the positive electrode current collectors 72a at a time. Furthermore, when ultrasonic welding is performed with the positive electrode current collectors 72a overlapping with a lead electrode, they can be electrically connected to each other efficiently.

Ultrasonic welding can be performed in the following manner: ultrasonic waves are applied to the tab portion placed to overlap with a tab portion of another positive electrode current collector while pressure is applied thereto.

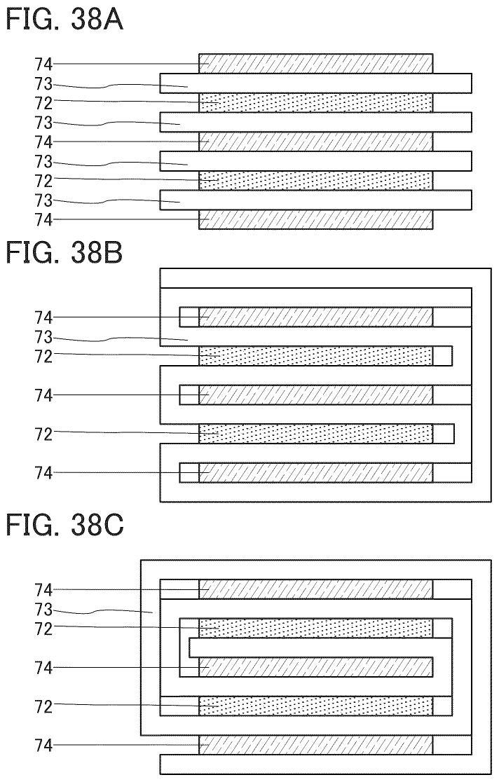

The separators 73 preferably have a shape that helps prevent an electrical short circuit between the positive electrode 72 and the negative electrode 74. For example, the width of each of the separators 73 is preferably larger than those of the positive electrode 72 and the negative electrode 74 as illustrated in FIG. 38A, in which case the positive electrode 72 and the negative electrode 74 are less likely to come in contact with each other even when the relative positions thereof are shined because of a change in shape such as bending. As illustrated in FIG. 38B, one separator 73 is preferably folded into an accordion-like shape, or as illustrated in FIG. 38C, one separator 73 is preferably wrapped around the positive electrodes 72 and the negative electrodes 74 alternately, in which case the positive electrode 72 and the negative electrode 74 do not come in contact with each other even when the relative positions thereof are shifted. FIG. 38B and FIG. 38C each illustrate an example in which the separator 73 is provided to partly cover the side surface of a stacked-layer structure of the positive electrodes 72 and the negative electrodes 74.

Note that although the positive electrode current collector and the positive electrode active material layer included in the positive electrode 72 and the negative electrode current collector and the negative electrode active material layer included in the negative electrode 74 are not illustrated in each drawing in FIG. 38, the above description can be referred to for formation methods thereof.

In this embodiment, one rectangle film is folded in half and two end portions are made to overlap with each other for sealing; however, the shape of the film is not limited to a rectangle. A polygon such as a triangle, a square, or a pentagon or any symmetric shape other than a rectangle, such as a circle or a star, may be employed.

The contents of this embodiment can be freely combined with the contents in the other embodiments. In particular, the contents of this embodiment are preferably combined with the structure of the secondary battery capable of being charged and discharged even at low temperatures, which is described in Embodiment 2. Accordingly, the structure of the power storage device 400 described with reference to FIG. 2C to FIG. 4C in Embodiment 1 can be achieved.

### Embodiment 6

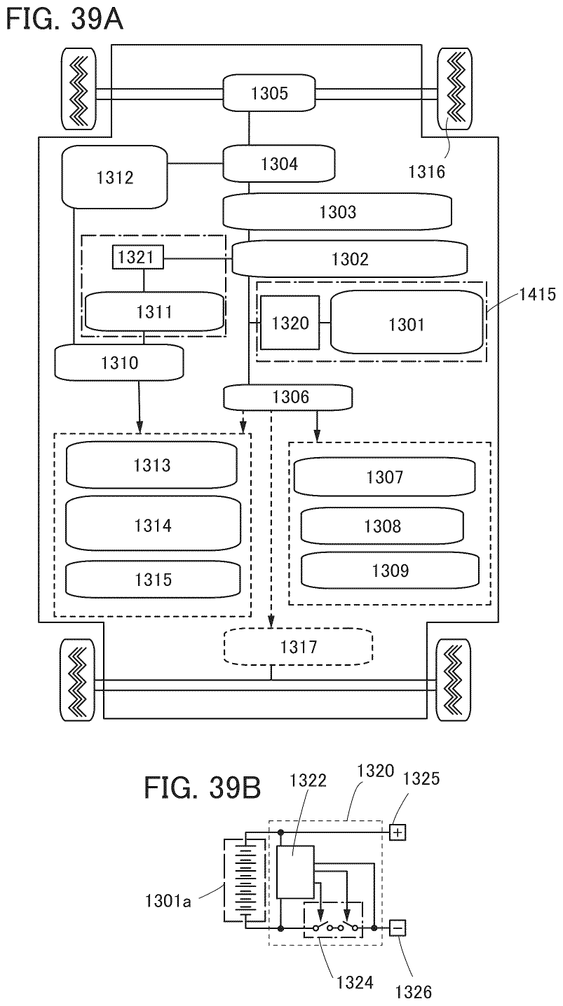

In this embodiment, examples of vehicles, electronic devices, and buildings each including a power storage device of one embodiment of the present invention are described with reference to FIG. 39A to FIG. 43B.

Examples of the electronic device to which the power storage device is applied include television sets (also referred to as televisions or television receivers), monitors of computers or the like, digital cameras, dashboard cameras, portable navigation devices, digital video cameras, digital photo frames, mobile phones (also referred to as cellular phones or mobile phone devices), portable game machines, portable information terminals, audio reproducing devices, and large game machines such as pachinko machines.

The power storage device can also be used in moving vehicles, typically automobiles.

Examples of the automobiles include next-generation clean energy vehicles such as hybrid vehicles (HVs), electric vehicles (EVs), and plug-in hybrid vehicles (PHEVs or PHVs), and the secondary battery can be used as one of the power sources provided for the automobiles. The moving vehicle is not limited to an automobile. Examples of moving vehicles include a train, a monorail train, a ship, a submarine (a deep-submergence vehicle and an unmanned submarine), a flying object (a helicopter, an unmanned aircraft (a drone), an airplane, a rocket, and artificial satellite), an electric bicycle, and an electric motorcycle, and the secondary battery of one embodiment of the present invention can be used for the moving vehicles.

The power storage device of this embodiment may be used in a ground-based power storage device provided for a house or a charge station provided in a commerce facility.

First, FIG. 39A illustrates an example in which the power storage device 400 described in Embodiment 1 is used in an electric vehicle (EV).

In the electric vehicle, a power storage device 1301 as a power storage device for main driving and a second battery 1311 which supplies electric power to an inverter 1312 starting a motor 1304 are provided. The second battery 1311 is also referred to as a cranking battery or a starter battery. The second battery 1311 specifically needs high output and does not necessarily require high capacity, and the capacity of the second battery 1311 is lower than that of the power storage device 1301. The power storage device 400 described in Embodiment 1 is preferably used as the power storage device 1301.

For the secondary batteries included in the power storage device 1301, Embodiment 1 can be referred to.

Although this embodiment describes an example in which one power storage device 1301 is provided, a plurality of power storage devices 1301 may be connected in parallel. When the plurality of power storage devices 1301 are included, large electric power can be extracted. The plurality of power storage devices 1301 may be connected in parallel, connected in series, or connected in series after being connected in parallel.

In order to cut off electric power from the plurality of secondary batteries, the secondary batteries in the vehicle include a service plug or a circuit breaker that can cut off high voltage without the use of equipment. The power storage device 1301 is provided with such a service plug or a circuit breaker.

Electric power from the power storage device 1301 is mainly used to rotate the motor 1304 and is supplied to in-vehicle parts for 42 V (such as an electric power steering 1307, a heater 1308, and a defogger 1309) through a DCDC circuit 1306. Even in the case where there is a rear motor 1317 for rear wheels, the power storage device 1301 is used to rotate the rear motor 1317.

The second battery 1311 supplies electric power to in-vehicle parts for 14 V (such as a stereo 1313, a power window 1314, and lamps 1315) through a DCDC circuit 1310.

The power storage device 1301 is electrically connected to a control circuit portion 1320.

The control circuit portion 1320 may include a memory circuit including a transistor using an oxide semiconductor. A charge control circuit or a battery control system that includes a memory circuit including a transistor using an oxide semiconductor is referred to as a BTOS (Battery operating system or Battery oxide semiconductor) in some cases.

A metal oxide functioning as an oxide semiconductor is preferably used. For example, as the metal oxide, a metal oxide such as an In-M-Zn oxide (the element M is one or more kinds selected from aluminum, gallium, yttrium, copper, vanadium, beryllium, boron, titanium, iron, nickel, germanium, zirconium, molybdenum, lanthanum, cerium, neodymium, hafnium, tantalum, tungsten, magnesium, and the like) is used. In particular, the In-M-Zn oxide that can be used as the metal oxide is preferably a CAAC-OS (C-Axis Aligned Crystalline Oxide Semiconductor) or a CAC-OS (Cloud-Aligned Composite Oxide Semiconductor). An In—Ga oxide or an In—Zn oxide may be used as the metal oxide. The CAAC-OS is an oxide semiconductor that has a plurality of crystal regions each of which has c-axis alignment in a particular direction. Note that the particular direction refers to the film thickness direction of a CAAC-OS film, the normal direction of the surface where the CAAC-OS film is formed, or the normal direction of the surface of the CAAC-OS film. The crystal region refers to a region having a periodic atomic arrangement. Note that when an atomic arrangement is regarded as a lattice arrangement, the crystal region also refers to a region with a uniform lattice arrangement. The CAAC-OS has a region where a plurality of crystal regions are connected in the a-b plane direction, and the region has distortion in some cases. Note that distortion refers to a portion where the orientation of a lattice arrangement changes between a region with a uniform lattice arrangement and another region with a uniform lattice arrangement in a region where a plurality of crystal regions are connected. That is, the CAAC-OS is an oxide semiconductor having c-axis alignment and having no clear alignment in the a-b plane direction. The CAC-OS refers to one composition of a material in which elements constituting a metal oxide are unevenly distributed with a size greater than or equal to 0.5 nm and less than or equal to 10 nm, preferably greater than or equal to 1 nm and less than or equal to 3 nm, or a similar size, for example. Note that a state where one or more metal elements are unevenly distributed and regions including the metal element(s) are mixed with a size greater than or equal to 0.5 nm and less than or equal to 10 nm, preferably greater than or equal to 1 nm and less than or equal to 3 nm, or a similar size in a metal oxide is hereinafter referred to as a mosaic pattern or a patch-like pattern.

In addition, the CAC-OS has a composition in which materials are separated into a first region and a second region to form a mosaic pattern, and the first regions are distributed in the film (this composition is hereinafter also referred to as a cloud-like composition). That is, the CAC-OS is a composite metal oxide having a composition in which the first regions and the second regions are mixed.

Here, the atomic proportions of In, Ga, and Zn in the metal elements contained in the CAC-OS in an In—Ga—Zn oxide are denoted by [In], [Ga], and [Zn], respectively. For example, the first region in the CAC-OS in the In—Ga—Zn oxide is a region having [In] higher than [In] in the composition of the CAC-OS film. Moreover, the second region is a region having [Ga] higher than [Ga] in the composition of the CAC-OS film. For example, the first region is a region having [In] higher than [In] in the second region and [Ga] lower than [Ga] in the second region. Moreover, the second region is a region having [Ga] higher than [Ga] in the first region and [In] lower than [In] in the first region.

Specifically, the first region is a region containing an indium oxide, an indium zinc oxide, or the like as its main component. The second region is a region containing a gallium oxide, a gallium zinc oxide, or the like as its main component. That is, the first region can be rephrased as a region containing In as its main component. The second region can be rephrased as a region containing Ga as its main component.

Note that a clear boundary between the first region and the second region cannot be observed in some cases.

For example, according to EDX mapping obtained by EDX, the CAC-OS in the In—Ga—Zn oxide has a composition in which the region containing In as its main component (the first region) and the region containing Ga as its main component (the second region) are unevenly distributed and mixed.

In the case where the CAC-OS is used for a transistor, a switching function (On/Off switching function) can be given to the CAC-OS owing to the complementary action of the conductivity derived from the first region and the insulating property derived from the second region. That is, the CAC-OS has a conducting function in part of the material and has an insulating function in another part of the material: as a whole, the CAC-OS has a function of a semiconductor. Separation of the conducting function and the insulating function can maximize each function. Accordingly, when the CAC-OS is used for a transistor, high on-state current (In), high field-effect mobility (p), and excellent switching operation can be achieved.

An oxide semiconductor has various structures with different properties. Two or more kinds among an amorphous oxide semiconductor, a polycrystalline oxide semiconductor, an a-like OS, a CAC-OS, an nc-OS, and a CAAC-OS may be included in an oxide semiconductor of one embodiment of the present invention.

The control circuit portion 1320 preferably includes a transistor using an oxide semiconductor because it can be used in a high-temperature environment. For the process simplicity, the control circuit portion 1320 may be formed using transistors of the same conductivity type. A transistor using an oxide semiconductor in its semiconductor layer has an operating ambient temperature range of −40° C. to 150° C. inclusive, which is wider than that of a single crystal Si transistor, and thus shows a smaller change in characteristics than the single crystal Si transistor when the secondary battery is overheated. The off-state current of the transistor using an oxide semiconductor is lower than or equal to the lower measurement limit even at 150° C. independently of the temperature; meanwhile, the off-state current characteristics of the single crystal Si transistor largely depend on the temperature. For example, at 150° C., the off-state current of the single crystal Si transistor increases, and a sufficiently high current on/off ratio cannot be obtained. The control circuit portion 1320 can contribute to elimination of accidents due to secondary batteries, such as fires.

The control circuit portion 1320 that includes a memory circuit including a transistor using an oxide semiconductor can also function as an automatic control device for the secondary battery to resolve causes of instability, such as a micro-short circuit. Examples of functions of resolving the causes of instability of the secondary battery include prevention of overcharge, prevention of overcurrent, control of overheating during charging, holding of cell balance of an assembled battery, prevention of overdischarge, a battery indicator, automatic control of charge voltage and current amount according to temperature, control of the amount of charge current according to the degree of deterioration, abnormal behavior detection for a micro-short circuit, and anomaly prediction regarding a micro-short circuit; the control circuit portion 1320 has at least one of these functions. Furthermore, the automatic control device for the secondary battery can be extremely small in size.

A micro-short circuit refers to a minute short circuit caused in a secondary battery and refers not to a state where the positive electrode and the negative electrode of a secondary battery are short-circuited so that charge and discharge are impossible, but to a phenomenon in which a slight short-circuit current flows through a minute short-circuit portion. Since a large voltage change is caused even when a micro-short circuit occurs in a relatively short time in a minute area, the abnormal voltage value might adversely affect later estimation of discharge state and the like of the secondary battery.

One of the supposed causes of a micro-short circuit is as follows. Uneven distribution of a positive electrode active material due to charge and discharge performed multiple times causes local current concentration at part of the positive electrode and part of the negative electrode; thus, insulation between the positive electrode and the negative electrode is partly broken. Another supposed cause is generation of a by-product due to a side reaction.

It can be said that the control circuit portion 1320 not only detects a micro-short circuit but also senses terminal voltage of the secondary battery and controls the charge and discharge state of the secondary battery. For example, to prevent overcharge, an output transistor of a charge circuit and an interruption switch can be turned off substantially at the same time.

FIG. 39B is an example of a block diagram of the control circuit portion 1320.

The control circuit portion 1320 includes a switch portion 1324 that includes at least a switch for preventing overcharge and a switch for preventing overdischarge, a control circuit 1322 for controlling the switch portion 1324, and a portion for measuring the voltage of the first battery 1301a. The control circuit portion 1320 is set to have the upper limit voltage and the lower limit voltage of the secondary battery used, and controls the upper limit of current from the outside, the upper limit of output current to the outside, or the like. The range from the lower limit voltage to the upper limit voltage of the secondary battery falls within the recommended voltage range; when a voltage falls outside the range, the switch portion 1324 operates and functions as a protection circuit. The control circuit portion 1320 can also be referred to as a protection circuit because it controls the switch portion 1324 to prevent overdischarge and overcharge. For example, when the control circuit 1322 detects a voltage that is likely to cause overcharge, current is interrupted by turning off the switch in the switch portion 1324. Furthermore, a function of interrupting current in accordance with a temperature rise may be set by providing a PTC element in the charge and discharge path. The control circuit portion 1320 includes an external terminal 1325 (+IN) and an external terminal 1326 (−IN).

The switch portion 1324 can be formed by a combination of an n-channel transistor and a p-channel transistor. The switch portion 1324 is not limited to a switch including a Si transistor using single crystal silicon; the switch portion 1324 may be formed using, for example, a power transistor containing Ge (germanium), SiGe (silicon germanium), GaAs (gallium arsenide), GaAlAs (gallium aluminum arsenide), InP (indium phosphide), SiC (silicon carbide), ZnSe (zinc selenide), GaN (gallium nitride), GaOx (gallium oxide, where x is a real number greater than 0), or the like. A memory element using an OS transistor can be freely placed by being stacked over a circuit using a Si transistor, for example; hence, integration can be easy. Furthermore, an OS transistor can be fabricated with a manufacturing apparatus similar to that for a Si transistor and thus can be fabricated at low cost. That is, the control circuit portion 1320 using an OS transistor can be stacked over the switch portion 1324 so that they can be integrated into one chip. Since the volume occupied by the control circuit portion 1320 can be reduced, a reduction in size is possible.

The first batteries 1301a and 1301b mainly supply electric power to in-vehicle devices for 42 V (for a high-voltage system), and the second battery 1311 supplies electric power to in-vehicle devices for 14 V (for a low-voltage system). Lead storage batteries are usually used for the second battery 1311 due to cost advantage.

In this embodiment, an example in which a lithium-ion secondary battery is used as both the first battery 1301a and the second battery 1311 is described. As the second battery 1311, a lead storage battery, an inorganic all-solid-state battery, and/or an electric double layer capacitor may alternatively be used.

Regenerative energy generated by rolling of tires 1316 is transmitted to the motor 1304 through a gear 1305, and is stored in the second battery 1311 from a motor controller 1303 and/or a battery controller 1302 through a control circuit portion 1321. Alternatively, the regenerative energy is stored in the first battery 1301a from the battery controller 1302 through the control circuit portion 1320. Alternatively, the regenerative energy is stored in the first battery 1301b from the battery controller 1302 through the control circuit portion 1320. For efficient charge with regenerative energy, the first batteries 1301a and 1301b are desirably capable of fast charging.

The battery controller 1302 can set the charge voltage, charge current, and the like of the first batteries 1301a and 1301b. The battery controller 1302 can set charge conditions in accordance with charge characteristics of a secondary battery used, so that fast charge can be performed.

Although not illustrated, in the case of connection to an external charger, a plug of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharge, the first batteries 1301a and 1301b are preferably charged through the control circuit portion 1320. In addition, the plug of the charger or the connection cable of the charger is sometimes provided with a control circuit. The control circuit portion 1320 is also referred to as an ECU (Electronic Control Unit). The ECU is connected to a CAN (Controller Area Network) provided in the electric vehicle. The CAN is a type of a serial communication standard used as an in-vehicle LAN. The ECU includes a microcomputer. Moreover, the ECU uses a CPU or a GPU.

External chargers installed at charge stations and the like have a 100 V outlet, a 200 V outlet, and a three-phase 200 V outlet with 50 kW, for example. Furthermore, charge can be performed with electric power supplied from external charge equipment by a contactless power feeding method or the like.

For fast charge, secondary batteries that can withstand high-voltage charge have been desired to perform charge in a short time.

The above power storage device described in this embodiment includes a secondary battery that operates at low temperatures and a secondary battery that operates in a middle temperature range. Thus, the power storage device can have stable output at low temperatures. Therefore, a vehicle using the power storage device can run safely even in cold climates.

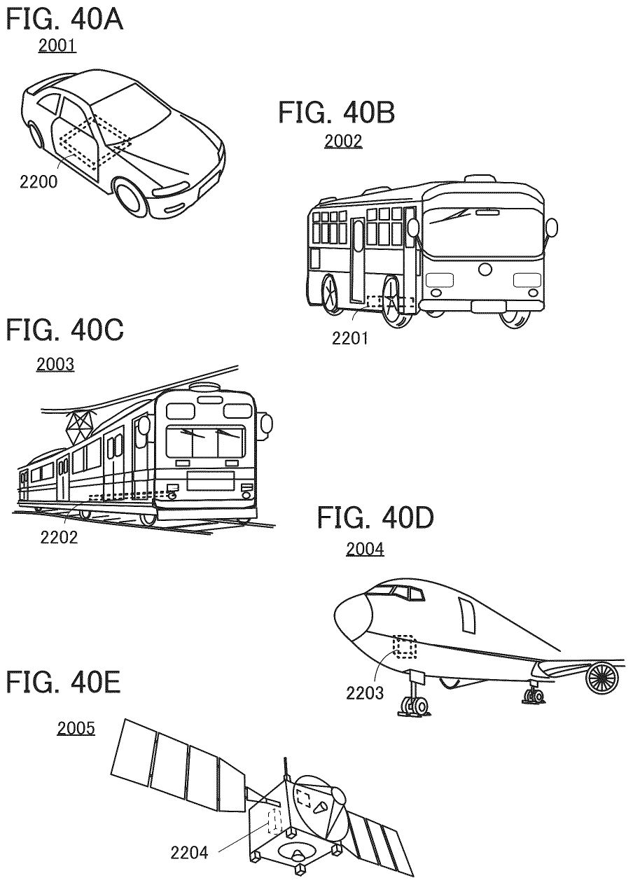

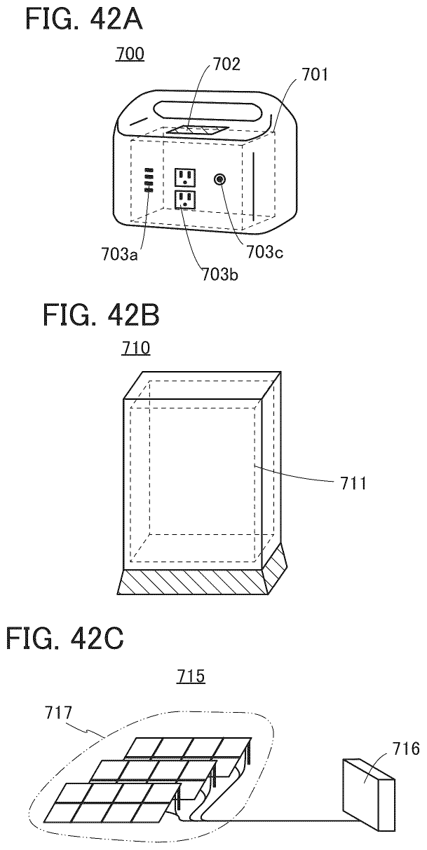

FIG. 40A, FIG. 40B, FIG. 40C, FIG. 40D, FIG. 40E, and FIG. 42A illustrate examples of moving vehicles each including one embodiment of the present invention. An automobile 2001 illustrated in FIG. 40A is an electric vehicle that runs using an electric motor as a driving power source. Alternatively, the automobile 2001 is a hybrid vehicle that can appropriately select an electric motor or an engine as a driving power source. In the case where a secondary battery is provided in a vehicle, the secondary battery for low-temperature use, the temperature sensor, and the heater that are described in Embodiment 1 are provided. In addition, using the secondary battery described in Embodiment 5 can create synergy on safety. The automobile 2001 illustrated in FIG. 40A includes the power storage device 1301 described in the above embodiment. In addition, a temperature control system for the power storage device 1301, which is electrically connected to the power storage device 1301, is preferably included.

The automobile 2001 can be charged when the secondary battery included in the automobile 2001 is supplied with electric power from external charge equipment by a plug-in system, a contactless power feeding system, or the like. In charging, a given method such as CHAdeMO (registered trademark) or Combined Charging System may be employed as a charge method, the standard of a connector, and the like as appropriate. A power storage device may be a charge station provided in a commerce facility or a household power supply. For example, with use of the plug-in system, the secondary battery for low-temperature use and the secondary battery mounted on the automobile 2001 can be charged by being supplied with electric power from the outside. Charge can be performed by converting AC power into DC power through a converter such as an ACDC converter.

Although not illustrated, the vehicle can include a power receiving device so as to be charged by being supplied with electric power from an above-ground power transmitting device in a contactless manner. For the contactless power feeding system, by fitting a power transmitting device in a road or an exterior wall, charge can be performed not only when the vehicle is stopped but also when driven. In addition, the contactless power feeding system may be utilized to perform transmission and reception of electric power between two vehicles. Furthermore, a solar cell may be provided in the exterior of the vehicle to charge the secondary battery when the vehicle stops or moves. To supply electric power in such a contactless manner, an electromagnetic induction method or a magnetic resonance method can be used.

FIG. 40B illustrates a large transporter 2002 having a motor controlled by electricity, as an example of a transport vehicle. A power storage device 2201 of the transporter 2002 includes the power storage device described in the above embodiment. Since the power storage device includes a secondary battery that operates at low temperatures and a secondary battery that operates in a middle temperature range, the transporter 2002 using the power storage device can run safely even in cold climates.

FIG. 40C illustrates a large transport vehicle 2003 having a motor controlled by electricity as an example. A secondary battery module of the transport vehicle 2003 has 100 or more secondary batteries with higher than or equal to 3.5 V and lower than or equal to 4.7 V which are connected in series, and the maximum voltage is 600 V, for example. Thus, the secondary batteries are required to have a small variation in the characteristics. A power storage device 2202 includes the power storage device described in the above embodiment. Since the power storage device includes a secondary battery that operates at low temperatures and a secondary battery that operates in a middle temperature range, the transport vehicle 2003 using the power storage device can run safely even in cold climates.

FIG. 40D illustrates an aircraft 2004 having a combustion engine as an example. The aircraft 2004 illustrated in FIG. 40D can be regarded as a kind of transport vehicles since it is provided with wheels for takeoff and landing. The aircraft 2004 includes a power storage device 2203 including the power storage device described in the above embodiment.

The power storage device of the aircraft 2004 has a maximum voltage of 32 V, for example. With the use of the power storage device of one embodiment of the present invention, the power storage device that is less likely to be affected by the ambient temperature can be included in the aircraft 2004.

FIG. 40E illustrates an example of an artificial satellite using the power storage device of one embodiment of the present invention. An artificial satellite 2005 illustrated in FIG. 40E includes a power storage device 2204. Because the artificial satellite 2005 is used in an ultra-low-temperature cosmic space, the power storage device 2204 is desirably covered with a heat-retaining member to be mounted inside the artificial satellite 2005.

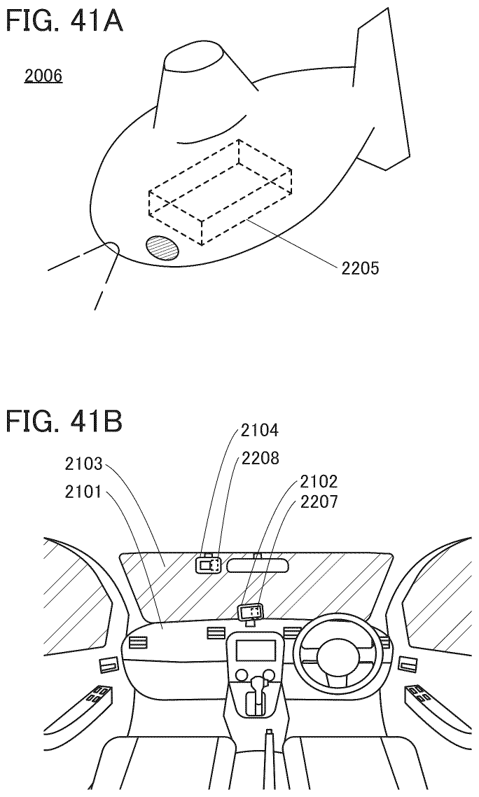

FIG. 41A illustrates an example of a submarine using the power storage device of one embodiment of the present invention. A submarine 2006 illustrated in FIG. 41A includes a power storage device 2205. The power storage device of one embodiment of the present invention is suitable for the power storage device 2205 because the submarine 2006 is sometimes used in water, which is a low-temperature environment.

FIG. 41B is a diagram illustrating the inside of the automobile 2001 in FIG. 40A. An electronic device may be provided in the automobile 2001. As an example of an electronic device, FIG. 41B illustrates a state where a portable navigation device 2102 is provided in a dashboard 2101 and a dashboard camera 2104 is provided in a windshield 2103. The portable navigation device 2102 includes a power storage device 2207, and the dashboard camera 2104 includes a power storage device 2208. The temperature of the periphery of a windshield and a dashboard of an automobile is largely changed, and might be a low temperature or a middle temperature; thus, the power storage device of one embodiment of the present invention is suitable for the power storage device 2207 and the power storage device 2208.

FIG. 42A illustrates an example in which the power storage device described in the above embodiment is used for a portable battery. A portable battery 700 includes a power storage device 701, a display portion 702, a terminal 703a, a terminal 703b, and a terminal 703c. With the use of the power storage device described in the above embodiment, the portable battery 700 can be used even in cold climates.

FIG. 42B illustrates an example in which the power storage device described in the above embodiment is used for a stationary power storage system. A stationary power storage system 710 includes a power storage device 711. The stationary power storage system 710 is preferably electrically connected to a commercial power source through a distribution board. With the use of the power storage device described in the above embodiment, the stationary power storage system 710 can be used even in cold climates.

FIG. 42C illustrates an example in which the power storage device described in the above embodiment is used for a solar power generation system. A solar power generation system 715 includes a power storage device 716 and solar power generation panels 717. Electric power obtained by the solar power generation panels can be stored in the power storage device 716. With the use of the power storage device described in the above embodiment, the solar power generation system 715 can be used even in cold climates.

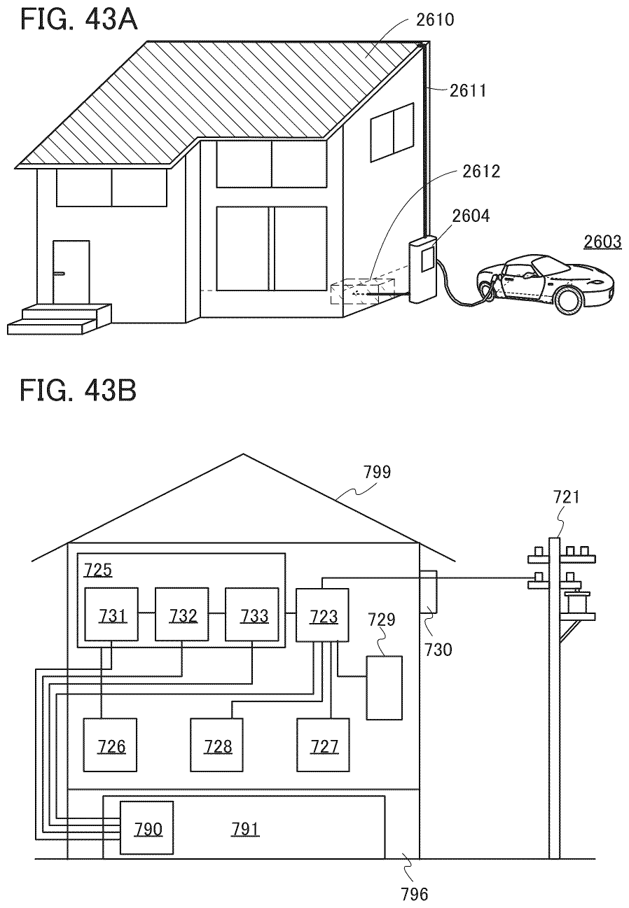

Next, examples in which a building is provided with the power storage device of one embodiment of the present invention will be described with reference to FIG. 43A and FIG. 43B.

A house illustrated in FIG. 43A includes a power storage device 2612 including the secondary battery of one embodiment of the present invention and a solar power generation panel 2610. The power storage device 2612 is electrically connected to the solar power generation panel 2610 through a wiring 2611 or the like. The power storage device 2612 may be electrically connected to ground-based charge apparatus 2604. The power storage device 2612 can be charged with electric power generated by the solar power generation panel 2610. A secondary battery included in a vehicle 2603 can be charged with the electric power stored in the power storage device 2612 through the charge apparatus 2604. The power storage device 2612 is preferably provided in an underfloor space. The power storage device 2612 is provided in the underfloor space, in which case the space on the floor can be effectively used. Alternatively, the power storage device 2612 may be provided on the floor.

The electric power stored in the power storage device 2612 can also be supplied to other electronic devices in the house. Thus, with the use of the power storage device 2612 of one embodiment of the present invention as an uninterruptible power source, electronic devices can be used even when electric power cannot be supplied from a commercial power source due to power failure or the like. With the use of the power storage device described in the above embodiment, the power storage device 2612 can supply electric power stably even in cold climates.

FIG. 43B illustrates an example of a power storage device of one embodiment of the present invention. As illustrated in FIG. 43B, a power storage device 791 of one embodiment of the present invention is provided in an underfloor space 796 of a building 799.

The power storage device 791 is provided with a control device 790, and the control device 790 is electrically connected to a distribution board 723, a power storage controller 725 (also referred to as control device), an indicator 726, and a router 729 through wirings.

Electric power is transmitted from a commercial power source 721 to the distribution board 723 through a service wire mounting portion 730. Moreover, electric power is transmitted to the distribution board 723 from the power storage device 791 and the commercial power source 721, and the distribution board 723 supplies the transmitted electric power to a general load 727 and a power storage load 728 through outlets (not illustrated).

The general load 727 is, for example, an electrical device such as a TV or a personal computer. The power storage load 728 is, for example, an electrical device such as a microwave, a refrigerator, or an air conditioner.

The power storage controller 725 includes a measuring portion 731, a predicting portion 732, and a planning portion 733. The measuring portion 731 has a function of measuring the amount of electric power consumed by the general load 727 and the power storage load 728 during a day (for 24 hours from 12 o'clock at night, for example). The measuring portion 731 may also have a function of measuring the amount of electric power of the power storage device 791 and the amount of electric power supplied from the commercial power source 721. The predicting portion 732 has a function of predicting, on the basis of the amount of electric power consumed by the general load 727 and the power storage load 728 during a given day, the demand for electric power consumed by the general load 727 and the power storage load 728 during the next day.

The planning portion 733 has a function of making a charge and discharge plan of the power storage device 791 on the basis of the demand for electric power predicted by the predicting portion 732.

An indicator 726 can show the amount of electric power consumed by the general load 727 and the power storage load 728 that is measured by the measuring portion 731. An electrical device such as a TV or a personal computer can also show it through the router 729. Furthermore, a portable electronic terminal such as a smartphone or a tablet can also show it through the router 729. The indicator 726, the electrical device, and the portable electronic terminal can also show, for example, the demand for electric power depending on a time period (or per hour) that is predicted by the predicting portion 732.

This embodiment can be used in combination with the other embodiments.

### REFERENCE NUMERALS

10: battery, 11a: portion, 11b: portion, 11: exterior body, 12: stack, 13a: electrode, 13b: electrode, 13: electrode, 20: electrolyte solution, 21a: crest line, 21b: crest line, 21: crest line, 22a: trough line. 22b: trough line. 22: trough line, 25: space, 30: adhesive layer, 31a: portion, 31b: portion. 31: portion, 32: folded portion, 33: bonding portion, 34: bonding portion, 41: electrode, 42: electrode, 43: electrode, 50a: film, 50b: film, 50: film, 51: mold, 52: mold, 53: mold. 54: mold, 55a: projection, 55: embossing roll, 56a: projection, 56: embossing roll, 60: direction of movement. 61a: film, 61b: film, 61: film, 62: film, 63: film. 64: positive electrode current collector, 65: separator, 66: negative electrode current collector, 71: region, 72: positive electrode, 72a: positive electrode current collector, 72b: positive electrode active material layer, 73: separator, 74: negative electrode, 74a: negative electrode current collector, 74b: negative electrode active material layer, 75: sealing layer, 76: lead electrode, 77; thermocompression-bonded region, 80: plane. 90: plane, 400: power storage device, 401: secondary battery, 402: secondary battery, 403a: positive electrode terminal, 403b: negative electrode terminal, 411: parallel connection wiring, 412: parallel connection wiring, 413: series connection wiring, 1301 a: first battery, 1301b: first battery, 1301: power storage device, 1302: battery controller, 1303: motor controller, 1304: motor, 1305: gear, 1306: DCDC circuit, 1307: electric power steering, 1308: heater, 1309: defogger, 1310: DCDC circuit, 1311: second battery, 1312: inverter, 1313: audio, 1314: power window, 1315: lamp, 1316: tire, 1317: rear motor, 1320: control circuit portion, 1321: control circuit portion, 1322: control circuit, 1324: switch portion, 2001: automobile, 2002: transporter, 2003: transport vehicle, 2004: aircraft, 2005: artificial satellite, 2006: submarine, 2102: portable navigation device, 2104: dashboard camera, 2201: power storage device, 2202: power storage device, 2203: power storage device, 2204: power storage device, 2205: power storage device, 2207: power storage device, 2603: vehicle, 2604: charge apparatus, 2610: solar power generation panel, 2611: wiring, 2612: power storage device

1. A power storage device comprising a first secondary battery and a second secondary battery,
wherein the first secondary battery is used in a first temperature range,
wherein the second secondary battery is used in a second temperature range,
wherein a lower limit of the first temperature range is lower than a lower limit of the second temperature range,
wherein an upper limit of the first temperature range is higher than the lower limit of the second temperature range,
wherein an upper limit of the second temperature range is higher than the upper limit of the first temperature range,
wherein the first temperature range and the second temperature range each comprise 25° C., and
wherein a value of discharge capacity when the first secondary battery is discharged at the lower limit of the first temperature range is higher than or equal to 50% of a value of discharge capacity when the first secondary battery is discharged at 25° C.

2. The power storage device according to claim 1,
wherein the power storage device further comprises a temperature sensor and a control circuit,
wherein the temperature sensor is configured to detect a temperature of the second secondary battery, and
wherein the control circuit is configured to set the temperature of the second secondary battery within the second temperature range by heat generated by the first secondary battery in a case where a temperature detected by the temperature sensor is lower than the second temperature range.

3. The power storage device according to claim 2,
wherein the second secondary battery is configured to be preheated by the first secondary battery, and
wherein the second secondary battery is configured to start discharge to an outside after the temperature of the second secondary battery is set within the second temperature range.

4. The power storage device according to claim 3,
wherein the lower limit of the first temperature range is lower than or equal to −20° C.

5. The power storage device according to claim 3,
wherein the first secondary battery has flexibility.

6. The power storage device according to claim 5,
wherein the first secondary battery comprises a stack and an exterior body,
wherein the exterior body has a film-like shape and is folded in half so as to sandwich the stack, and
wherein the exterior body comprises a plane in contact with the stack and a plane in contact with the second secondary battery.

7. The power storage device according to claim 5,
wherein the second secondary battery is a cylindrical secondary battery or an angular secondary battery.

8. The power storage device according to claim 5,
wherein the power storage device comprises a plurality of first secondary batteries and a plurality of second secondary batteries, and
wherein a number of the plurality of the first secondary batteries is smaller than a number of the plurality of the second secondary batteries.

9. The power storage device according to claim 5, comprising a thermal conductive material between the first secondary battery and the second secondary battery.

10. A vehicle comprising the power storage device according to claim 1.

11. A power storage device comprising a first secondary battery and a plurality of second secondary batteries,
wherein the first secondary battery is configured to be bent and in contact with side surfaces of the plurality of the second secondary batteries,
wherein the first secondary battery is used in a first temperature range,
wherein each of the plurality of the second secondary batteries is used in a second temperature range,
wherein a lower limit of the first temperature range is lower than a lower limit of the second temperature range,
wherein an upper limit of the first temperature range is higher than the lower limit of the second temperature range,
wherein an upper limit of the second temperature range is higher than the upper limit of the first temperature range,
wherein the first temperature range and the second temperature range each comprise 25° C., and
wherein a value of discharge capacity when the first secondary battery is discharged at the lower limit of the first temperature range is higher than or equal to 50% of a value of discharge capacity when the first secondary battery is discharged at 25° C.

12. The power storage device according to claim 11,
wherein the power storage device further comprises a temperature sensor and a control circuit,
wherein the temperature sensor is configured to detect a temperature of each of the plurality of the second secondary batteries, and
wherein the control circuit is configured to set the temperature of each of the plurality of the second secondary batteries within the second temperature range by heat generated by the first secondary battery in a case where a temperature detected by the temperature sensor is lower than the second temperature range.

13. The power storage device according to claim 12,
wherein each of the plurality of the second secondary batteries is configured to be preheated by the first secondary battery, and
wherein each of the plurality of the second secondary batteries is configured to start discharge to an outside after the temperature of each of the plurality of the second secondary batteries is set within the second temperature range.

14. The power storage device according to claim 13,
wherein the lower limit of the first temperature range is lower than or equal to −20° C.

15. The power storage device according to claim 13,
wherein the first secondary battery has flexibility.

16. The power storage device according to claim 15,
wherein the first secondary battery comprises a stack and an exterior body,
wherein the exterior body has a film-like shape and is folded in half so as to sandwich the stack, and
wherein the exterior body comprises a plane in contact with the stack and a plane in contact with each of the plurality of the second secondary batteries.

17. The power storage device according to claim 15,
wherein each of the plurality of the second secondary batteries is a cylindrical secondary battery or an angular secondary battery.
